(19) United States
(12) Patent Application Publication
(10) Pub. No.: US 2022/0378652 A1
(43) Pub. Date: Dec. 1, 2022

(54) HUMAN BODY STIMULATION DEVICE AND HUMAN BODY STIMULATION METHOD USING HUMAN BODY STIMULATION DEVICE

(71) Applicant: HUTECH INDUSTRY CO., LTD., Cheonan-si (KR)

(72) Inventors: Hwa Don JU, Gimpo-si (KR); Sung Don KWON, Gimpo-si (KR)

(21) Appl. No.: 17/877,356

(22) Filed: Jul. 29, 2022

Related U.S. Application Data
(63) Continuation of application No. PCT/KR2022/001221, filed on Jan. 24, 2022.

(30) Foreign Application Priority Data
Feb. 2, 2021 (KR) 10-2021-0014995

(51) Int. Cl. A61H 23/02; A61H 7/00; A61H 23/00

(52) U.S. Cl. CPC A61H 23/0236; A61H 7/007; A61H 23/006; A61H 2201/5005; A61H 2201/5007; A61H 2201/0149

(57) ABSTRACT

A human body stimulation device and a human body stimulation method using the human body stimulation device. A human body stimulation device provides a multimodal massage to a user by performing a mechanical massage operation and a sonic vibration massage operation. The human body stimulation device includes a massage member in contact with a body part of the user, a first massage module which includes a motor operatively connected to the massage member to repeatedly move the massage member according to a massage pattern, a second massage module which includes a sonic vibration module to output sonic vibration corresponding to an audible frequency band and operatively connected to the massage member, and a controller which applies a first control signal for driving the motor to the motor and a second control signal for driving the sonic vibration module to the sonic vibration module.

### CROSS-REFERENCE TO RELATED APPLICATIONS

This is a bypass continuation application of International PCT Application No. PCT/KR2022/001221 filed on Jan. 24, 2022, which claims priority to Republic of Korea Patent Application No. 10-2021-0014995, filed on Feb. 2, 2021, which are incorporated by reference herein in their entirety.

### TECHNICAL FIELD

The present invention relates to a human body stimulation device and a human body stimulation method using the human body stimulation device, and more particularly, to a human body stimulation device providing sonic vibration stimulation, and a human body stimulation method using the human body stimulation device.

### BACKGROUND ART

As the quality of life is improved, an interest in human body stimulation methods that assist in relieving fatigue and stress and, in particular, an interest in massages is increasing. Recently, among the massages, due to a soft massage feeling, a demand for a sonic vibration massage, in which sonic vibrations are transmitted to a body part to carefully massage the body part, is increasing.

Thus, there is a massage device to which the conventional device for generating sonic vibration is applied, but such a massage device simply transmits sonic vibration to a body part of a user and does not provide sonic vibration optimized for each body part of the user, and thus there is a problem in that an effective massage is not performed.

Therefore, there is a need to develop a technology for providing a sonic vibration massage optimized for each body part of a user.

### SUMMARY

The present invention is directed to providing a human body stimulation device for simultaneously performing a motion massage and a sonic vibration massage, and a human body stimulation method using the human body stimulation device.

The present invention is also directed to providing a human body stimulation device for providing general massages such as a tapping massage and a kneading massage along with a sonic vibration massage to a body part of a user, and a human body stimulation method using the body stimulation device.

The present invention is also directed to providing a human body stimulation device for simultaneously performing a motion massage and a sonic vibration massage using a sonic vibration module, and a human body stimulation method using the human body stimulation device.

Technical solutions of the present application may not be limited to the above, and other technical solutions which are not described herein should be clearly understood by those skilled in the art, to which the present invention belongs, from the present specification and the accompanying drawings.

According to one embodiment of the present invention, a human body stimulation device, which provides a multimodal massage to a user by performing a mechanical massage operation and a sonic vibration massage operation, includes a massage member provided in contact with a body part of the user, a first massage module which includes a motor operatively connected to the massage member to repeatedly move the massage member according to a massage pattern and performs the mechanical massage operation according to the massage pattern using the massage member, a second massage module which includes a sonic vibration module configured to output sonic vibration corresponding to an audible frequency band and operatively connected to the massage member and performs the sonic vibration massage operation by applying the sonic vibration to the body part, and a controller which applies a first control signal for driving the motor to the motor and a second control signal for driving the sonic vibration module to the sonic vibration module, wherein the second control signal may include a sound source waveform based on a synchronization pattern related to the movement of the massage member and a vibration pattern according to a frequency included in a range of the audible frequency band.

The objects of the present invention are not limited to the above-described objects, and other objects which are not described herein should be clearly understood by those skilled in the art, to which the present invention belongs, from the following detailed description and the accompanying drawings.

According to one embodiment of the present application, a sonic vibration massage synchronized with a motion massage is performed, thereby reducing a user's sense of difference due to the motion massage and the sonic vibration massage being simultaneously provided.

In addition, according to one embodiment of the present application, general massages such as a tapping massage and a kneading massage are provided along with a sonic vibration massage to a body part of a user, thereby providing various massages to the user.

In addition, according to one embodiment of the present application, a motion massage and a sonic vibration massage are performed at the same time using only a sonic vibration module, thereby increasing user's satisfaction.

Effects of the present application may not be limited to the above, and other effects which are not described herein should be clearly understood by those skilled in the art, to which the present invention belongs, from the present specification and the accompanying drawings.

### BRIEF DESCRIPTION OF DRAWINGS

FIG. 1 is a view illustrating a massage device according to one embodiment.

FIG. 2 is a block diagram illustrating a massage unit according to one embodiment.

FIG. 3 is a front view of a massage unit according to one embodiment.

FIG. 4 is a side view of the massage unit according to one embodiment.

FIG. 5 is a view illustrating a massage unit according to one embodiment.

FIG. 6 is a view illustrating a sonic vibration module according to one embodiment.

FIG. 7 is a view illustrating a head and a sonic vibration generator of the sonic vibration module according to one embodiment.

FIG. 8 is an exploded perspective view illustrating the head and the sonic vibration generator according to one embodiment.

FIG. 9 is a cross-sectional view illustrating the head and the sonic vibration generator according to one embodiment.

FIG. 10 shows views for describing a tapping massage according to one embodiment.

FIG. 11 shows views for describing a kneading massage according to one embodiment.

FIG. 12 shows graphs for describing a motion massage according to one embodiment.

FIG. 13 is an operation flowchart of a method of providing a massage according to one embodiment.

FIG. 14 is a block diagram illustrating a massage unit according to one embodiment.

FIG. 15 is an operation flowchart illustrating a control method of a controller according to one embodiment.

FIG. 16 shows graphs showing examples of a sound source waveform according to one embodiment.

FIG. 17 shows graphs showing examples of a sound source waveform according to another embodiment.

FIG. 18 shows graphs for describing a change in intensity of a sonic vibration massage according to changes in frequency and amplitude of a sound source signal according to one embodiment.

FIG. 19 shows graphs for describing an example of a synchronization waveform according to one embodiment.

FIG. 20 shows graphs for describing an example of a vibration waveform according to one embodiment.

FIG. 21 shows graphs showing an example of a sound source waveform according to one embodiment.

FIG. 22 shows graphs illustrating a relationship between a movement cycle of a sonic vibration module and a synchronization waveform according to one embodiment.

FIGS. 23 and 24 show graphs for describing a cycle of a sound source waveform according to a vibration frequency of a vibration waveform according to one embodiment.

FIG. 25 shows graphs for describing a cycle of a sound source waveform according to a vibration frequency of a vibration waveform according to another embodiment.

FIG. 26 shows graphs for describing a relationship between a synchronization waveform and a sound source waveform according to one embodiment.

FIG. 27 shows graphs for describing a relationship between a movement speed of a sonic vibration module and a sound source signal according to one embodiment.

FIG. 28 shows graphs illustrating a relationship between a stimulation intensity of a sonic vibration module and a sonic vibration massage according to one embodiment.

FIGS. 29 and 30 are operation flowcharts of a control method of a massage device for performing a multimodal massage according to one embodiment.

FIG. 31 shows graphs for describing a sound source signal corresponding to a tapping massage according to one embodiment.

FIG. 32 shows diagrams for describing a sound source signal according to a tapping massage according to another embodiment.

FIG. 33 shows graphs for describing a sound source signal according to a tapping massage according to still another embodiment.

FIG. 34 shows graphs for describing a sound source signal corresponding to an acupressure massage according to one embodiment.

FIG. 35 shows graphs for describing a sound source signal corresponding to an acupressure massage according to another embodiment.

FIG. 36 shows graphs for describing a sound source signal corresponding to a continuous hitting massage according to one embodiment.

FIG. 37 shows graphs for describing a sound source signal corresponding to a continuous hitting massage according to another embodiment.

FIG. 38 shows graphs for describing a sound source signal corresponding to a sweeping massage according to one embodiment.

FIG. 39 shows graphs for describing a sound source signal corresponding to a kneading massage according to one embodiment.

FIG. 40 shows diagrams for describing a sound source signal corresponding to a kneading massage according to another embodiment.

FIG. 41 shows graphs for describing a sound source signal according to a kneading according to still another embodiment.

FIG. 42 shows graphs for describing a movement route of a motion massage member when a kneading massage is provided according to one embodiment.

FIG. 43 is an operation flowchart for describing a control method of a massage device according to one embodiment.

FIG. 44 is an operation flowchart for describing a control method of a massage device according to one embodiment.

### DETAILED DESCRIPTION

Embodiments described in the present specification are made to clearly explain the scope of the present invention to those having ordinary skill in the art and are not intended to limit the present invention. It should be interpreted that the present invention may include substitutions and modifications within the technical scope of the present invention.

The terms used in the present specification are selected from general terms, which are widely used currently, based on functions of components according to the embodiment of the present invention, and may have meanings varying according to the intentions of those skilled in the art, the custom in the field of art or advent of new technology. If a specific term is used with a specific meaning, the meaning of the term will be described specifically. Accordingly, the terms used in the present specification should not be defined as simple names of the components but should be defined based on the actual meaning of the terms and the whole context throughout the present specification.

The accompanying drawings are to facilitate the description of the present invention and the shape in the drawings may be exaggerated for the purpose of convenience of explanation, so the present invention should not be limited to the drawings.

In the present specification, when it is determined that a detailed description of a known configuration or function related to the present invention may obscure the gist of the present invention, a detailed description thereof will be omitted if necessary.

A human body stimulation device, which provides a multimodal massage to a user by performing a mechanical massage operation and a sonic vibration massage operation according to one embodiment, includes a massage member provided in contact with a body part of the user, a first massage module which includes a motor operatively connected to the massage member to repeatedly move the massage member according to a massage pattern and performs the mechanical massage operation according to the massage pattern using the massage member, a second massage module which includes a sonic vibration module configured to output sonic vibration corresponding to an audible frequency band and operatively connected to the massage member and performs the sonic vibration massage operation by applying the sonic vibration to the body part, and a controller which applies a first control signal for driving the motor to the motor and a second control signal for driving the sonic vibration module to the sonic vibration module, wherein the second control signal may include a sound source waveform based on a synchronization pattern related to the movement of the massage member and a vibration pattern according to a frequency included in a range of the audible frequency band.

Positions of the massage member and the sonic vibration module may be moved by the motor such that a position movement of the massage member is synchronized with a position movement of the sonic vibration module.

The human body stimulation device according to one embodiment may further include a connection part configured to connect the massage member and the sonic vibration module, wherein, as the connection part may be moved by the motor, the positions of the massage member and the sonic vibration module move.

The controller may apply the first signal to the motor such that the massage member moves according to the massage pattern, and the synchronization pattern may be synchronized with the massage pattern.

The synchronization pattern may be synchronized with at least one of a movement pattern of the massage member along an x-axis, a movement pattern thereof along a y-axis, and a movement pattern thereof along a z-axis with respect to an initial position of the massage member.

The massage pattern may include a plurality of detailed massage patterns according to a first cycle, the synchronization pattern may include a plurality of detailed synchronization patterns according to a second cycle, and at least one of start times or end times of the plurality of detailed massage patterns may match at least one of start times or end times of the plurality of detailed synchronization patterns.

The massage pattern may include a plurality of detailed massage patterns according to a first cycle, the synchronization pattern may include a plurality of detailed synchronization patterns according to a second cycle, and at least one of start times or end times of the plurality of detailed massage patterns and at least one of start times or end times of the plurality of detailed synchronization patterns may be included in a certain time period.

The first cycle may be n times or 1/n times the second cycle, and n may be a natural number.

The sound source waveform may represent a waveform in which the synchronization pattern and the vibration pattern are combined or multiplied.

The second cycle representing a cycle of the synchronization pattern may be n times or 1/n times a third cycle representing a cycle of the vibration pattern, and n may be a natural number.

The controller may adjust at least one of the second cycle representing the cycle of the synchronization pattern and the third cycle representing the cycle of the vibration pattern such that a difference value between the second cycle and a lowest common multiple of the second cycle and the third cycle is a certain value or less.

When a position movement speed of the massage member is increased, in response to the position movement speed of the massage member, a frequency of the synchronization pattern may be increased, and a frequency of the vibration pattern may be maintained.

When an intensity of a mechanical massage is increased such that an intensity of a sonic vibration massage is adjusted in response to the intensity of the mechanical massage, the controller may increase an amplitude of the sound source waveform or may decrease a frequency of the sound source waveform such that the intensity of the sonic vibration massage is increased.

When a contact intensity of the massage member with respect to the body part of the user is high, the controller may control the position movements of the massage member and the sonic vibration module using the connection part such that the contact intensity of the sonic vibration module with respect to the body part of the user is decreased, and when an intensity of a mechanical massage is increased such that an intensity of a sonic vibration massage is adjusted in response to the contact intensity of the massage member with respect to the body part of the user, the controller may decrease an amplitude of the sound source waveform such that the intensity of the sonic vibration massage is decreased.

The mechanical massage operation may include a first mechanical massage operation and a second mechanical massage operation, when the first massage module performs the first mechanical massage operation, a composite signal may be generated based on a first synchronization pattern synchronized with the first mechanical massage operation, when the first massage module performs the second mechanical massage operation, the composite signal may be generated based on a second synchronization pattern synchronized with the second mechanical massage operation, and the first synchronization pattern and the second synchronization pattern may be different.

The mechanical massage operation may include a first mechanical massage operation and a second mechanical massage operation, when the first massage module performs the first mechanical massage operation, a composite signal may be generated based on a first vibration pattern, when the first massage module performs the second mechanical massage operation, the composite signal may be generated based on a second vibration pattern, and a difference between a frequency of the first vibration pattern and a frequency of the second vibration pattern may be a certain frequency or lower.

A control method of a human body stimulation device, which provides a multimodal massage to a user by performing a mechanical massage operation and a sonic vibration massage operation, includes moving a position of a massage member provided in contact with a body part of the user, moving a position of a sonic vibration module operatively connected to the massage member, and applying a sound source signal to the sonic vibration module to control sonic vibration output from the sonic vibration module, wherein the sound source signal may include a sound source waveform based on a synchronization pattern related to the movement of the massage member and a vibration pattern according to a frequency included in a range of an audible frequency band.

A human body stimulation device, which provides a multimodal massage to a user by performing a tapping massage operation and a sonic vibration massage operation according to one embodiment, includes a massage member provided in contact with a body part of the user, a first massage module which includes a motor operatively connected to the massage member such that the massage member performs a forward movement from a rearward position to a forward position and a backward movement from the forward position to the rearward position and performs the tapping massage operation by allowing the massage member to perform the forward movement and the backward movement according to a tapping massage pattern using the motor, a second massage module which includes a sonic vibration module configured to output sonic vibration corresponding to an audible frequency band and operatively connected to the massage member and performs the sonic vibration massage operation by applying the sonic vibration to the body part, and a controller which controls the first massage module and the second massage module and controls the sonic vibration output from the sonic vibration module based on a sound source signal, wherein the sound source signal may include a first pattern and a second pattern, and when the massage member performs the forward movement during a first time period and performs the backward movement during a second time period, the controller may control the sonic vibration module to output the sonic vibration based on the first pattern during the first time period and output the sonic vibration based on the second pattern during the second time period such that the sonic vibration massage operation is synchronized with the tapping massage operation.

Positions of the massage member and the sonic vibration module may be moved by the motor such that a position movement of the massage member is synchronized with a position movement of the sonic vibration module.

The human body stimulation device according to one embodiment may further include a connection part configured to connect the massage member and the sonic vibration module, wherein, as the connection part may be moved by the motor, the positions of the massage member and the sonic vibration module move.

As the massage member performs the forward movement and the backward movement, a contact intensity between the massage member and the body part of the user in the first time period may be higher than a contact intensity between the massage member and the body part of the user in the second time period, and in order to make an intensity of the sonic vibration massage correspond to the contact intensity between the massage member and the body part of the user, the controller may control the sonic vibration module such that the intensity of the sonic vibration massage in the first time period is high and the intensity of the sonic vibration massage in the second time period is low.

The controller may set a representative amplitude of the first pattern to be higher than a representative amplitude of the second pattern.

The controller may set a representative frequency of the first pattern and a representative frequency of the second pattern to be substantially the same.

The controller may control the position movements of the massage member and the sonic vibration module using the connection part such that the sonic vibration module performs the backward movement when the massage member performs the forward movement, and the sonic vibration module performs the forward movement when the massage member performs the backward movement.

As the sonic vibration module performs the backward movement and the forward movement when the massage member performs the forward movement and the backward movement by the connection part, the contact intensity between the massage member and the body part of the user in the first time period may be lower than the contact intensity between the massage member and the body part of the user in the second time period, and in order to make the intensity of the sonic vibration massage correspond to the contact intensity between the massage member and the body part of the user, the controller may control the sonic vibration module such that the intensity of the sonic vibration massage in the first time period is low and the intensity of the sonic vibration massage in the second time period is high.

The controller may set the representative amplitude of the first pattern to be lower than the representative amplitude of the second pattern.

The controller may set the representative frequency of the first pattern and the representative frequency of the second pattern to be substantially the same.

A length of the first pattern may correspond to a length of the first time period, and a length of the second pattern may correspond to the length of the first time period.

When a position movement speed of the massage member increases as a speed of the tapping massage increases, the lengths of the first pattern and the second pattern may be decreased in response to decreases in lengths of the first time period and the second time period, and amplitudes and frequencies of the first pattern and the second pattern may be maintained.

When the length of the first time period is longer than the length of the second time period, the length of the first pattern may be longer than the length of the second pattern, and the amplitudes and frequencies of the first pattern and the second pattern may be maintained.

A control method of a human body stimulation device, which provides a multimodal massage to a user by performing a tapping massage operation and a sonic vibration massage operation according to one embodiment, includes allowing a massage member provided in contact with a body part of the user to perform a forward movement from a rearward position to a forward position and a backward movement from the forward position to the rearward position and performing the tapping massage operation, moving a position of a sonic vibration module operatively connected to the massage member, and controlling sonic vibration output from the sonic vibration module based on a sound source signal and performing the sonic vibration massage operation, wherein the sound source signal may include a first pattern and a second pattern, and when the massage member performs the forward movement during a first time period and performs the backward movement during a second time period, the sonic vibration module may be controlled to output the sonic vibration based on the first pattern during the first time period and output the sonic vibration based on the second pattern during the second time period such that the sonic vibration massage operation is synchronized with the tapping massage operation.

A human body stimulation device, which provides a multimodal massage to a user by performing a kneading massage operation and a sonic vibration massage operation according to one embodiment, includes a massage member provided in contact with a body part of the user, a first massage module which includes a motor operatively connected to the massage member such that the massage member performs a first movement from a first position to a second position and a second movement from the second position to the first position and performs the kneading massage operation by allowing the massage member to perform the first movement and the second movement according to a kneading massage pattern using the motor, wherein a body part of the user with which the massage member is in contact at the first position is different from a body part of the user with which the massage member is in contact at the second position, a second massage module which includes a sonic vibration module configured to output sonic vibration corresponding to an audible frequency band and operatively connected to the massage member and performs the sonic vibration massage operation by applying the sonic vibration to the body part, and a controller which controls the first massage module and the second massage module and controls the sonic vibration output from the sonic vibration module based on a sound source signal, wherein the sound source signal may include a sound source waveform based on a first detailed pattern and a second detailed pattern, and when the massage member performs the first movement during a first time period and performs the second movement during a second time period, the controller may control the sonic vibration module to output the sonic vibration based on the first detailed pattern during the first time period and output the sonic vibration based on the second detailed pattern during the second time period such that the sonic vibration massage operation is synchronized with the kneading massage operation.

Positions of the massage member and the sonic vibration module may be moved by the motor such that a position movement of the massage member is synchronized with a position movement of the sonic vibration module.

The human body stimulation device according to one embodiment may further include a connection part configured to connect the massage member and the sonic vibration module, wherein, as the connection part may be moved by the motor, the positions of the massage member and the sonic vibration module move.

As the massage member performs the first movement and the second movement, a contact intensity between the massage member and the body part of the user in the first time period may be increased, a contact intensity between the massage member and the body part of the user in the second time period may be decreased, and in order to make an intensity of the sonic vibration massage correspond to the contact intensity between the massage member and the body part of the user, the controller may control the sonic vibration module such that the intensity of the sonic vibration massage in the first time period is high and the intensity of the sonic vibration massage in the second time period is low.

The controller may set an amplitude at an end time of the first detailed pattern to be higher than an amplitude at a start time of the first detailed pattern and may set an amplitude at an end time of the second detailed pattern to be lower than an amplitude at a start time of the second detailed pattern.

The controller may set a representative frequency of the first detailed pattern and a representative frequency of the second detailed pattern to be substantially the same.

A length of the first detailed pattern may correspond to a length of the first time period, and a length of the second detailed pattern may correspond to a length of the second time period.

The controller may control the first massage module to perform one operation of a first detailed kneading massage operation, a second detailed kneading massage operation, and a third detailed kneading massage operation, in the first detailed kneading massage operation, when the second movement is performed, the massage member may move from the second position to the first position according to a route rather than a route of the first movement, in the second detailed kneading massage operation, when the second movement is performed, the massage member may move from the second position to the first position according to the route of the first movement, and a distance between the first position and the second position in the third detailed massage operation may be shorter than a distance between the first position and the second position in the first and second detailed massage operation.

When the first detailed kneading massage operation is performed in the first massage module, the controller may apply a first sound source signal having a first sound source waveform to the sonic vibration module, when the third detailed kneading massage operation is performed in the first massage module, the controller may apply a second sound source signal having a second sound source waveform to the sonic vibration module, and the first sound source waveform and the second sound source waveform may be different.

When a position movement speed of the massage member increases as a speed of the kneading massage increases, the lengths of the first detailed pattern and the second detailed pattern may be decreased in response to decreases in lengths of the first time period and the second time period, and amplitudes and frequencies of the first detailed pattern and the second detailed pattern may be maintained.

The sound source waveform may be based on a synchronization pattern related to the position movement of the massage member and a vibration pattern having a frequency included in a range of the audible frequency band.

The synchronization pattern may include a first detailed synchronization pattern and a second detailed synchronization pattern, the first detailed pattern may be formed based on the first detailed synchronization pattern and the vibration pattern, and the second detailed pattern may be formed based on the second detailed synchronization pattern and the vibration pattern.

A control method of a human body stimulation device, which provides a multimodal massage to a user by performing a kneading massage operation and a sonic vibration massage operation according to one embodiment, includes allowing a massage member provided in contact with a body part of the user to perform a first movement from a first position to a second position and a second movement from the second position to the first position and performing the kneading massage operation, moving a position of a sonic vibration module operatively connected to the massage member, and controlling sonic vibration output from the sonic vibration module based on a sound source signal and performing the sonic vibration massage operation, wherein the sound source signal may include a sound source waveform based on a first detailed pattern and a second detailed pattern, and when the massage member performs the first movement during a first time period and performs the second movement during a second time period, the sonic vibration module may be controlled to output the sonic vibration based on the first detailed pattern during the first time period and output the sonic vibration based on the second detailed pattern during the second time period such that the sonic vibration massage operation is synchronized with the kneading massage operation.

A human body stimulation device, which provides a sonic vibration massage to a user using sonic vibration according to one embodiment, includes a sonic vibration module configured to output sonic vibration corresponding to an audible frequency band and perform a sonic vibration massage operation by applying the sonic vibration to a body part of the user, a massage module configured to move a position of the sonic vibration module; and a controller configured to control the sonic vibration module and the massage module, wherein the controller may control the sonic vibration output from the sonic vibration module based on a sound source signal, and the sound source signal may include a sound source waveform based on a synchronization pattern related to a position movement of the sonic vibration module and a vibration pattern having a frequency included in a range of the audible frequency band.

The massage module may include a driving unit including at least one motor for moving the position of the sonic vibration module, and the controller may move the position of the sonic vibration module by applying a control signal to the driving unit.

The sonic vibration module may perform a mechanical massage through movement of the sonic vibration module and contact between the sonic vibration module and the body part of the user.

The controller may control the sonic vibration module to move according to a certain movement pattern, and the synchronization pattern may be synchronized with the certain movement pattern.

The synchronization pattern may be synchronized with at least one of a movement pattern of the sonic vibration module along an x-axis, a movement pattern thereof along a y-axis, and a movement pattern thereof along a z-axis with respect to an initial position of the sonic vibration module.

The certain movement pattern may include a plurality of detailed movement patterns according to a first cycle, the synchronization pattern may include a plurality of detailed synchronization patterns according to a second cycle, and at least one of start times or end times of the plurality of detailed movement patterns may match at least one of start times or end times of the plurality of detailed synchronization patterns.

The certain movement pattern may include a plurality of detailed movement patterns according to a first cycle representing a cycle of the certain movement pattern, the synchronization pattern may include a plurality of detailed synchronization patterns according to a second cycle representing a cycle of the synchronization pattern, and at least one of start times or end times of the plurality of detailed movement patterns and at least one of start times and end times of the plurality of detailed synchronization patterns may be included in a certain time period.

The first cycle may be n times or 1/n times the second cycle and n may be a natural number.

The sound source waveform may represent a waveform in which the synchronization pattern and the vibration pattern are combined or multiplied.

The second cycle representing a cycle of the synchronization pattern may be n times or 1/n times a third cycle representing a cycle of the vibration pattern, and n may be a natural number.

The controller may adjust at least one of the second cycle representing the cycle of the synchronization pattern and the third cycle representing the cycle of the vibration pattern such that a difference value between the second cycle and a lowest common multiple of the second cycle and the third cycle is a certain value or less.

When a position movement speed of the sonic vibration module is increased, in response to the position movement speed of the sonic vibration module, a frequency of the synchronization pattern may be increased, and a frequency of the vibration pattern may be maintained.

When an intensity of the mechanical massage is increased such that an intensity of the sonic vibration massage is adjusted in response to the intensity of the mechanical massage, the controller may increase an amplitude of the sound source waveform.

A type of the synchronization pattern may be set to correspond to a route of a certain movement pattern of the sonic vibration module.

The controller may obtain a sound source from an external device of the massage device and may generate the sound source signal based on the obtained sound source.

A control method of a human body stimulation device, which provides a sonic vibration massage to a user using sonic vibration according to one embodiment, includes moving a position of a sonic vibration module according to a certain movement pattern, and controlling sonic vibration output from the sonic vibration module based on a sound source signal corresponding to an audible frequency band in the sonic vibration module, wherein the sound source signal may include a sound source waveform based on a synchronization pattern related to a position movement of the sonic vibration module and a vibration pattern having a frequency included in the audible frequency band.

1. Human Body Stimulation Device and Massage Device

In the present specification, a human body stimulation device may be one of various types of devices for providing a function of providing stimulation to a user. There may be various purposes of providing stimulation to the user. For example, the human body stimulation device may provide stimulation to the user for various purposes such as a massage purpose, a medical purpose, a pain relief purpose, a fatigue recovery purpose, a rehabilitation purpose, a health improvement purpose, and a weight training purpose. In addition, according to the purpose, the human body stimulation device may include various devices such as a massage device, a medical device, a pain relief device, a fatigue recovery device, a rehabilitation device, a health improvement device, and a weight training device.

In the present specification, for convenience of description, the present invention and various embodiments will be described based on the massage device among the various human body stimulation devices. However, the present invention is not limited to the massage device, and of course, descriptions of the present invention may be applied to the various human body stimulation devices other than the massage device.

In the present specification, the massage device may be one of various types of devices for providing a massage function to the user. The massage device may have various shapes and functions and may provide a massage to various parts to be massaged. For example, the massage device may be formed as any type such as a chair type, a bed type, or a sofa type. In addition, the massage device may provide a motion massage function of providing a massage of various motions to the user using a rotational force of an electric motor and may provide a sonic vibration massage function of providing sonic vibration to the user. In addition, the massage device may provide a massage to various parts to be massaged, such as a user's eye, feet, calf, shoulder, back, head, and arm. Of course, the present invention is not limited thereto, and the massage device may have various shapes and functions and may provide a massage to various parts to be massaged.

1.1. Massage Chair

1.1.1. Structure of Massage Chair

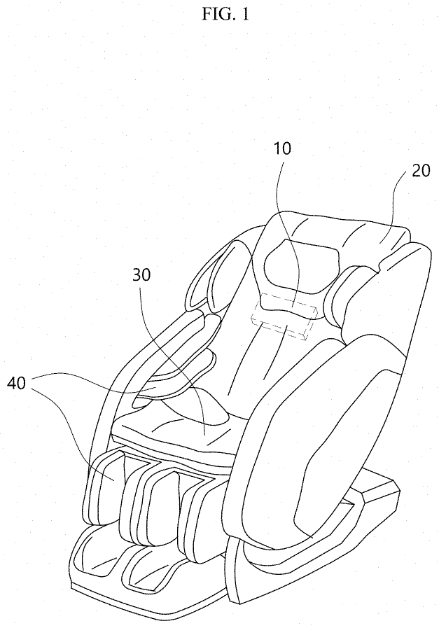

FIG. 1 is a view illustrating a massage device according to one embodiment. Referring to FIG. 1, a massage device 1 according to one embodiment may be implemented as a chair-type massage device. For example, the massage device 1 may be a massage chair including a backrest 20, a seat 30, and an arm/leg unit 40. However, the present invention is not limited thereto, and the massage device 1 may be implemented as another type such as a bed type, a sofa type, or a vehicle seat type other than a chair type. For example, the massage device 1 according to one embodiment may be a bed-type device in which a massage unit 10 is provided in a mattress. Hereinafter, although the present invention will be described based on a chair-type massage device 1 for convenience of description, of course, the present invention is not limited to the chair-type massage device 1, and the configurations of the present invention to be described below may be applied to various types of massage device 1.

The massage device 1 according to one embodiment may include massage members for massaging a body of a user. For example, the massage device 1 may include massage members such as air cells, rollers, and acupressure protrusions in the backrest 20, the seat 30, and/or the arm/leg unit 40.

The massage device 1 according to one embodiment may massage the body of the user through the massage unit 10. For example, the massage device 1 may massage the body of the user through the massage unit 10 installed inside the backrest 20. For example, the massage unit 10 may provide various stimuli for a body massage to a body, such as tapping, kneading, and pressing the body.

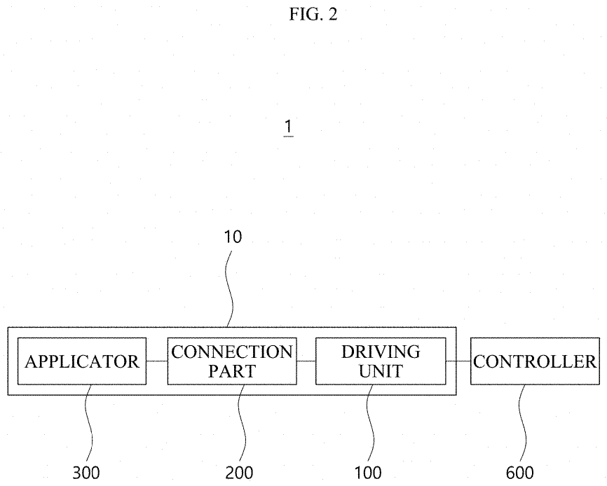

Specifically, the massage unit 10 may drive a connection part 100 (see FIG. 2) through a driving unit 100 (see FIG. 2) to physically massage a body through an applicator 300 (see FIG. 2) disposed at one end portion of the connection part 200 (see FIG. 2).

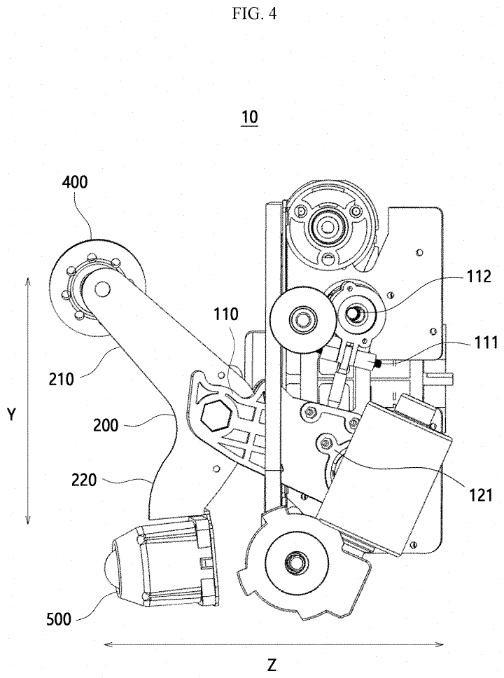

In addition, the massage unit 10 may perform a sonic vibration massage. The sonic vibration massage means that sonic vibration is provided to the user to obtain a massage effect. When an appropriate sonic vibration massage is performed on the user, the user may obtain effects of improving health, such as effects of lessening a fatigue feeling, improving blood circulation, and relieving stress. For example, the massage unit 10 may perform a sonic vibration massage by transmitting sonic vibration to the body of the user through a sonic vibration module 500 (see FIG. 4) disposed at one end portion of the connection part 200 (see FIG. 2). Here, the massage unit 10 may perform a sonic vibration massage on a body and simultaneously drive an arm 200 (see FIG. 2) through the driving unit 100 (see FIG. 2) to physically massage the body through the sonic vibration module 500 (see FIG. 4) disposed at one end portion of the arm 200 (see FIG. 2).

In addition, according to embodiments, the massage unit 10 may move the massage member to massage parts of a body at various positions. For example, the massage unit 10 may include the driving unit 100 (see FIG. 2) to move the massage member along the backrest 20 and massage a back of the user at various positions.

However, the massage device 1 shown in FIG. 1 is merely an example for convenience of description, and the present invention is not limited thereto. For example, the massage unit 10 may be installed at any one of other positions, such as the seat 30 and the arm/leg unit 40 instead of the backrest 20. According to some embodiments, components may be added to or excluded from the massage device 1 of FIG. 1 and may also be subdivided. For example, the massage device 1 according to one embodiment may further include an operation unit which receives a user input, a display unit which displays a picture or an image, and a speaker which outputs sound.

In addition, as described above, for convenience of description, the present invention will be described based on a massage, and the description of the present invention is not limited to a massage device and a massage operation. For example, in the present specification, of course, a massage device, a massage unit, and a massage member may be expressed as a stimulation device, a stimulation unit, and a stimulation member.

FIG. 2 is a block diagram illustrating a massage unit 10 according to one embodiment.

Referring to FIG. 2, the massage unit 10 may include a driving unit 100, a connection part 200, and an applicator 300.

The applicator 300 may be a unit which is in direct or indirect contact with a user to provide a massage to the user. For example, the applicator 300 may be a terminal component which finally provides a massage to the user among various components of a massage device 1 provided to provide a massage to the user.

For example, the applicator 300 may include a motion massage member which provides a motion massage to the user by performing various motions such as tapping and kneading, a vibration massage member which provides a vibration massage using vibration by a motor or vibration by a sonic vibration module, an air massage member which provides an air massage through expansion and contraction of air, a thermal massage member which provides a massage by applying warm heat or cold heat, and the like. Of course, the present invention is not limited thereto, and the applicator 300 may include various massage members which may provide a massage to the user in addition to the above-described embodiment. In addition, one massage member does not perform only one massage but may perform a plurality of massages. For example, the vibration massage member may output vibration while performing a motion such as tapping or kneading, and in this case, the vibration massage member may simultaneously perform the motion massage provided by the motion massage member together with the vibration massage.

In addition, according to embodiments, the applicator 300 may be connected to the connection part 200 and may be connected directly to the driving unit 100 without being connected to the connection part 200. In addition, the applicator 300 may be independently driven without being connected to the connection part 200 and the driving unit 100. In addition, the applicator 300 may be driven independently of the massage unit 10 without being included in the massage unit 10.

The connection part 200 may connect the applicator 300 and the driving unit 100. For example, the driving unit 100 may move the connection part 200 upward/downward/leftward/rightward/forward/backward or may move the applicator 300 in various routes such as a circular route, an elliptic route, a semicircular route, a semielliptic route, and a quarter route. According to the movement of the connection part 200, the applicator 300 connected to the connection part 200 may move in various motions. In addition, the connection part 200 may be in the form of an arm or may be formed in any form other than the arm. In addition, in the massage unit 10, the connection part 200 may be provided as one or more connection parts 200. In addition, the applicator 300 connected to the connection unit 200 may be provided as one or more applicators 300, and one or more types of the applicator 300 may also be provided.

The driving unit 100 may change a position of the massage unit 10 so that the massage unit 10 may provide a massage to the user at various positions. For example, a frame (not shown) is included in at least a partial region of the massage device 1 (for example, a backrest 20 or a seat 30 of the massage device 1), and the driving unit 100 may include a moving member (not shown, for example, a roller, a wheel, a toothed wheel, or the like). In this case, the frame (not shown) or an accommodation member (not shown) included in the frame (not shown) may be in contact with the moving member (not shown), and as the moving member (not shown) moves according to the driving of the driving unit 100, the massage device 1 may move. As an example, when the frame (not shown) is included in the backrest 20 of the massage device 1, the massage unit 10 may be lifted and lowered by the driving unit 100, and when the frame (not shown) is included in the seat 30 of the massage device 1, the massage unit 10 may be moved forward or backward by the driving unit 100.

In addition, the driving unit 100 may move a position of the applicator 300. For example, the driving unit 100 may move the connection part 200 such that the applicator 300 moves in various motions such as tapping and kneading. For example, the driving unit 100 may include a tapping motor for providing a tapping massage and/or a kneading motor for providing a kneading massage. In this case, the driving unit 100 may provide various motion massages such as a sweeping massage, an acupressure massage, a continuous hitting massage, an complex massage, and the like using the tapping motor and/or the kneading motor.

In addition, the massage unit 10 may include an x-axis motor for allowing the applicator for a massage to reciprocate in an x-axis direction, a y-axis motor for allowing the applicator to reciprocate in a y-axis direction, and a z-axis motor for allowing the applicator to reciprocate in a z-axis direction. Here, the massage unit 10 may provide various motion massages including a tapping massage, a kneading massage, a sweeping massage, an acupressure massage, a continuous hitting massage and/or a complex massage by combining reciprocating motions in the x-axis, y-axis, and z-axis directions.

In addition, the driving unit 100 may be driven using any motor such as an electric motor (an alternating current (AC) motor, a direct current (DC) motor, a geared motor, a step motor, a servo motor, a brush motor, or a brushless motor) or a hydraulic motor.

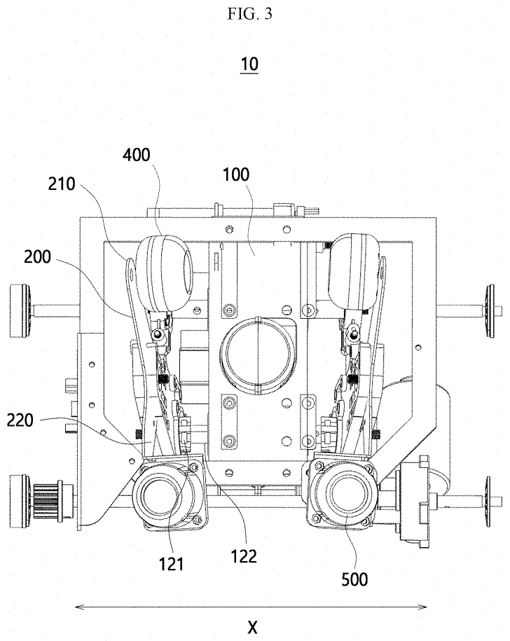

Furthermore, according to some embodiments, components may be added to or excluded from a massage unit 10 of FIGS. 3 to 5 and may also be subdivided.

In addition, the massage device 1 may include a controller 600 which controls each component of the massage device 1 or processes and calculates various types of information. For example, the controller 600 may control the massage unit 10 to provide a massage. Specifically, the controller 600 may control the driving unit 100 or directly control the applicator 300. For example, the controller 600 may directly control whether sonic vibration occurs, a frequency, an amplitude, and the like in a sonic vibration module 500.

For example, the controller 600 may control the applicator 300 by applying a control signal to the driving unit 100 or the motor included in the driving unit 100 or may control the sonic vibration module 500, which is a type of the applicator 300, by applying a control signal to the sonic vibration module 500.

In addition, the controller 600 may be included in the massage unit 10 and may be included in other components of the massage device 1 without being included in the massage unit 10.

The controller 600 may be provided in the form of an electronic circuit which physically processes an electrical signal. The controller 600 may be a concept physically including a plurality of controllers 600 as well as a single controller 600. For example, the controller 600 may be provided as one or more processors mounted on one computing device.

Examples of the controller 600 may include a central processing unit (CPU), a graphics processing unit (GPU), a digital signal processor (DSP), a state machine, an application specific integrated circuit (ASIC), a radio-frequency integrated circuit (RFIC), and a combination thereof

Hereinafter, a massage unit 10 according to one embodiment will be described with reference to FIGS. 3 and 4.

FIG. 3 is a front view of a massage unit according to one embodiment, and FIG. 4 is a side view of the massage unit according to one embodiment.

Referring to FIGS. 3 and 4, a massage unit 10 according to one embodiment may include a driving unit 100, a connection part 200, a massage ball 400, a sonic vibration module 500, and a position detection unit.

The driving unit 100 may be configured to move the massage unit 10 itself. For example, the driving unit 100 may move the massage unit 10 upward or downward along a guide rail (not shown) installed in a backrest 20. Specifically, the driving unit 100 may include a lifting motor (not shown), may allow teeth to be engaged with the guide rail so as to be movable along the guide rail, and may rotate the teeth using the lifting motor (not shown) to move the massage unit 10 along the guide rail.

In addition, the driving unit 100 may be configured to move the components of the massage unit 10. For example, the driving unit 100 may move the connection part 200 in various directions to tap, knead, or press a body. Here, the sonic vibration module 500 and/or the massage ball 400 may be connected to one end portion of the connection part 200, may come into contact with a body of a user according to the movement of the connection part 200, and may tap or massage the body. This will be described in detail in a detailed embodiment of a motion massage in Section 3.1.

The connection part 200 may include an upper part 210 and a lower part 220 which move by being interlocked with each other. For example, as the upper part 210 approaches the body of the user, the lower part 220 may also approach the body of the user.

The connection part 200 may be connected to an applicator 300, for example, the massage ball 400 and/or the sonic vibration module 500. For example, the massage ball 400 may be installed at the upper part 210 of the connection part 200, and the sonic vibration module 500 may be installed at the lower part 220 of the connection part 200. Here, the upper part 210 of the connection part 200 connected to the massage ball 400 may be configured to provide a massage such as tapping or kneading to the body of the user through the massage ball 400, and the lower part 220 of the connection part 200 connected to the sonic vibration module 500 may be configured to provide a sonic vibration massage to the body of the user through the sonic vibration module 500.

Of course, the connection part 200 is not limited to the above description, and various massage members may be connected to the upper part 210 of the connection part 200.

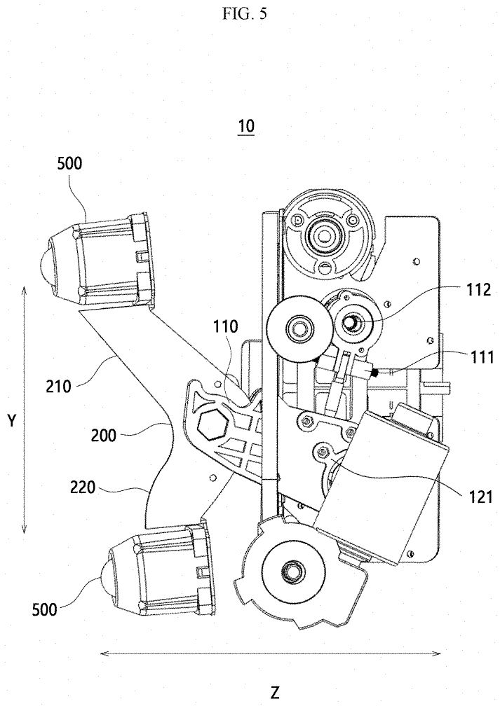

FIG. 5 is a view illustrating a massage unit according to one embodiment.

Referring to FIG. 5, a massage unit 10 according to one embodiment may include a sonic vibration module 500 instead of a massage ball 400. Here, the massage unit 10 may provide a general massage as well as a sonic vibration massage to a user using only the sonic vibration module 500.

The massage unit 10 is not limited to the above description, and the sonic vibration module 500 may be implemented in another form without being mounted on a connection part 200.

As an example, the sonic vibration module 500 may be mounted on a base of the massage unit 10. Here, the sonic vibration module 500 may not move through the connection part 200 but may move using an air cell connected to the sonic vibration module 500. Specifically, air may be injected into the air cell connected to the sonic vibration module 500 so that the sonic vibration module 500 may come into contact with a body of a user, or an orientation of the air cell may be changed so that the sonic vibration module 500 may move within a preset rotation angle range. As another example, the sonic vibration module 500 may be installed inside an airbag installed in the massage unit 10.

Of course, the connection part 200 is not limited to the above description. The connection part 200 may be connected the massage ball 400 and/or the sonic vibration module 500 in another form in which an upper part 210 of the connection part 200 is connected to the sonic vibration module 500, and a lower part 220 of the connection part 200 is connected to the massage ball 400.

In addition, with respect to a holder 110, a position of an end of the upper part 210 and a position of an end of the lower part 220 may be different in a Z-axis direction. For example, with respect to the holder 110, the end of the upper part 210 may be deeper than the end of the lower part 220. In addition, a posture (position) of the connection part 200 may be fixed in advance by the holder 110, and even when the posture of the connection part 200 is temporarily changed by an external force, the posture of the connection part 200 may be returned by an elastic member (not shown). For example, when an external force is applied to the massage ball 400 and the massage ball 400 is pressed backward, the end of the upper part 210 may be pushed backward so that the posture of the connection part 200 may be temporarily changed. In this case, as the lower part 220 connected to the sonic vibration module 500 protrudes forward, an elastic force may be accumulated in the elastic member (not shown), and when the application of the external force is finished, by an elastic force of the elastic member (not shown), as the lower part 220 is moved back, the posture of the connection part 200 may be returned to the original position thereof

1.1.2. Applicator

In an embodiment, as described above, an applicator may include various types of members such as a motion massage member, a vibration massage member, an air massage member, and a thermal massage member. Hereinafter, each applicator will be described in detail.

In addition, as described above, for convenience of description, the present invention will be described based on a massage, and the description of the present invention is not limited to a massage device and a massage operation. For example, in the present specification, of course, the motion massage member, the vibration massage member (motor vibration massage member or sonic vibration massage member), the air massage member, and the thermal massage member may be expressed a motion stimulation member, a vibration stimulation member (motor vibration stimulation member or sonic vibration stimulation member), an air stimulation member, and a thermal stimulation member.

1.1.2.1. Motion Massage Member

A motion massage member may represent an applicator which presses a user to provide a massage. For example, the motion massage member may be connected to a connection part 200 and may perform a general massage such as a tapping or kneading massage on a body of the user in synchronization with movement of the connection part 200.

The motion massage member may have a shape, material, or the like for performing a massage. For example, the motion massage member may have a curved shape like a massage ball 400 and may have an elliptical shape or a spherical shape when viewed in a plan view. As another example, the motion massage member may be made of an elastic material such as rubber or silicone for a soft massage. In addition, in one embodiment, the motion massage member may include a member such as a protrusion capable of locally providing a plurality of stimuli to the user.

1.1.2.2. Vibration Massage Member

A vibration massage member may be variously defined according to a type of device for generating vibration. For example, the vibration massage member may include a motor vibration massage member and a sonic vibration massage member.

1.1.2.2.1. Motor Vibration Massage Member

A motor vibration massage member may be a device which generates vibration using an electric motor and applies the generated vibration to a user to perform a massage.

In one embodiment, the motor vibration massage member may include an electric motor unit and a probe. Here, the electric motor unit may receive electric power to generate vibration, and the probe may be connected to the electric motor to transmit the vibration generated in the electric motor unit to the user. In addition, the electric motor unit may include various motors such as an AC motor, a DC motor, a geared motor, a step motor, a servo motor, a brush motor, and a brushless motor. In addition, the probe may be formed in various shapes such as a spherical shape, a hemispherical shape, a polyhedral shape, and a plate shape and may be made of various materials such as silicone and rubber.

In addition, the electric motor unit may generate vibrations with various outputs by adjusting the number of revolutions, an amplitude, and the like. For example, the electric motor unit may generate vibrations with various outputs under the control of a controller 600.

1.1.2.2.2. Sonic Vibration Massage Member

Sonic vibration refers to a wave generated due to vibration of a sounding body received by a medium such as air or water. That is, the sonic vibrations are vibrations generated by acoustic pressure. In this case, the vibration generated by the acoustic pressure may be vibration generated when sound is transmitted through medium such as a liquid, gas, or solid and may also refer to vibration of a mechanical structure itself generated by movement of the mechanical structure (for example, a sonic vibration module) which generates sound.

Meanwhile, as a frequency range applied to sonic vibration according to one embodiment, an audible frequency, which is safe in a human body and is capable of providing various positive effects, may be used. That is, when a range of 20 Hz or less is defined as an infrasound frequency, a range of 20 Hz to 20 kHz is defined as an audible frequency, and a range of 20 kHz or more is defined as an ultrasound frequency, the sonic vibration module according to one embodiment of the present invention may output sound waves in a range of about 20 Hz to 20 kHz, which is an audible frequency band, as sonic vibrations, thereby providing a more effective and safe stimulation massage to a human body.

A frequency applied to sonic vibration according to one embodiment may be in a range of 80 Hz to 300 Hz. As an example, such a frequency range may include a frequency that has an octave relationship with 440 Hz (lah) preferred in a healing field using music, that is, a frequency of 110 Hz which is ¼ of 440 Hz (lah) or a frequency of 220 Hz which is ½ of 440 Hz (lah).

1.1.2.2.2.1. Sonic Vibration Module

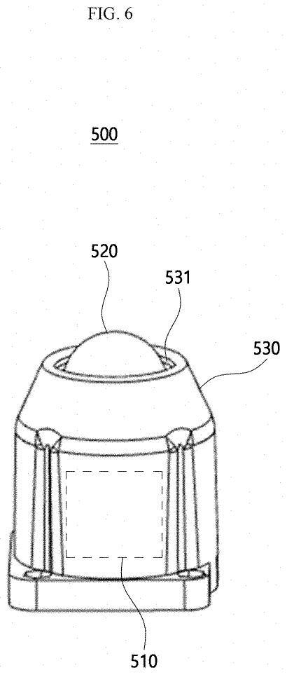

A sonic vibration module 500 will be described with reference to FIGS. 6 to 9. FIG. 6 is a view illustrating the sonic vibration module according to one embodiment. Referring to FIG. 6, the sonic vibration module 500 may include a sonic vibration generator 510, a head 520, and a housing 530. The sonic vibration module 500 may generate sonic vibration through the sonic vibration generator 510 and may transmit the generated sonic vibration to a body of a user through the head 520 connected to a sonic vibration unit.

The sonic vibration generator 510 may generate sonic vibration. For example, the sonic vibration generator 510 may include devices (not shown) for reproducing a sound source therein, for example, an amplifier and a speaker, and may generate vibration using a sound source. Here, the sonic vibration generator 510 may output sonic vibration corresponding to a sound source. The sonic vibration generator 510 will be described in detail below.

The head 520 may transmit the generated sonic vibration to the body of the user. For example, the head 520 may be connected to the sonic vibration generator 510 and may transmit the sonic vibration transmitted from the sonic vibration generator 510 to the body of the user in direct/indirect contact therewith. Here, the head 520 may be made of any material, for example, a silicone material, a wood material, a plastic material, or a metal material. The head 520 may transmit stronger sonic vibration to the user by locally transmitting the sonic vibration to the body of the user.

The housing 530 may accommodate the sonic vibration generator 510. For example, the housing 530 may surround the sonic vibration generator 510 therein and may prevent an external force due to a massage from being applied to the sonic vibration generator 510. Thus, the durability of the sonic vibration module 500 can be improved.

The housing 530 may at least partially accommodate the head 520. For example, the housing 530 may surround a portion of the head 520 connected to the sonic vibration generator 510 and may expose a portion of the head 520 through an opening such that the head 520 may be in direct/indirect contact with the body of the user. Since only a portion of the head 520 is exposed, the housing 530 may prevent the head 520 from being tilted and damaged due to an external force applied from a side surface of the head 520.

In addition, in one embodiment, the housing 530 may be implemented in various shapes. For example, a portion of the housing 530 in contact with a body may be provided as a round surface to be in smooth contact with the body. Here, a hole through which the head 520 passes may be formed in the housing 530 such that a portion of the head 520 may be exposed to the outside. Specifically, in order to prevent the head 520 from being heavily tilted due to an external force, a buffer member 531 made of a silicone material or the like may be provided in a space between the head 520 and the hole of the housing 530.

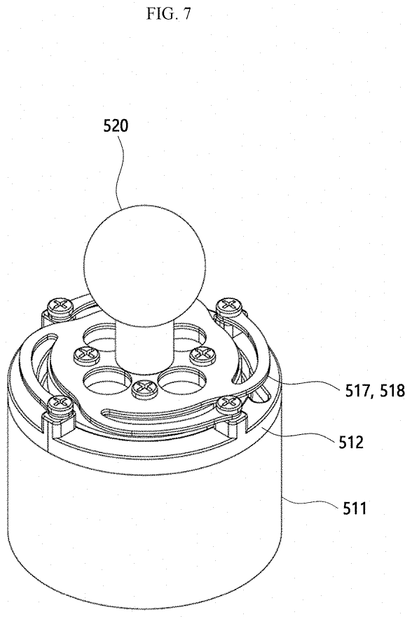

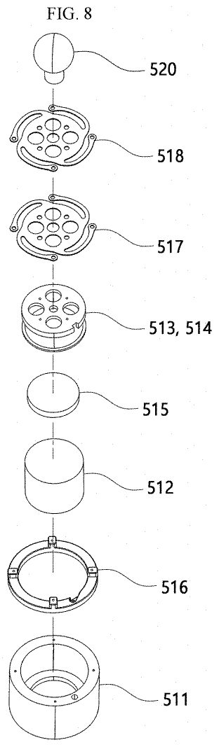

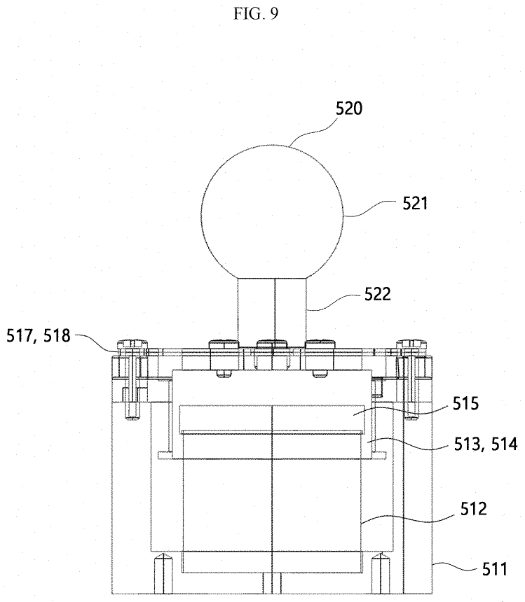

FIG. 7 is a view illustrating the head and the sonic vibration generator of the sonic vibration module according to one embodiment. FIG. 8 is an exploded perspective view illustrating the head and the sonic vibration generator according to one embodiment. FIG. 9 is a cross-sectional view illustrating the head and the sonic vibration generator according to one embodiment.

Referring to FIGS. 7 to 9, the sonic vibration module 500 according to one embodiment may include a lower plate 511, a magnetic body 512, a bobbin 513, a coil 514, a middle plate 515, an upper ring 516, a first leaf spring 517, a second leaf spring 518, and the head 520.

The lower plate 511 may have a space, in which the magnetic body 512 is accommodated, formed therein. For example, the lower plate 511 may have a cylindrical shape with an open upper portion, and the magnetic body 512 may be installed therein. The lower plate 511 may be used to form a magnetic path of a magnetic field formed by the magnetic body 512 and the coil 514.

The magnetic body 512 may be installed inside the lower plate 511 to be spaced apart from the lower plate 511. For example, a groove, in which the magnetic body 512 is fixedly installed, may be formed in a bottom surface of the lower plate 511, and an inner surface of the lower plate 511 may be spaced a certain interval from an outer peripheral surface of the magnetic body 512 installed in the groove.

The magnetic body 512 may be, for example, a permanent magnet that is a ferromagnetic body 512 such as a neodymium magnet. When power is applied to the sonic vibration module 500 to magnetize the coil 514, the magnetic body 512 may be used to generate an attractive force and a repulsive force and generate vibration. Here, the magnetic body 512 may be positioned in a lower surface of the bobbin 513 and, when the coil 514 wound on the bobbin 513 is magnetized, the magnetic body 512 may generate an efficient magnetic field to generate a mutual attractive force and a repulsive force and generate stable vibration.

The middle plate 515 may be installed on the magnetic body 512 to prevent loss of a magnetic field generated by the magnetic body 512. For example, the middle plate 515 may have a shape similar to that of an upper surface of the magnetic body 512 and may be installed between an upper portion of the magnetic body 512 and a lower portion of the bobbin 513 to guide a magnetic force of the magnetic body 512 to be concentrated on the coil 514. Here, a magnetic fluid (not shown) may be applied to an outer diameter portion of the middle plate 515 to form a magnetic field.

The bobbin 513 may be made of a material not having magnetism (for example, aluminum material or the like) and may be installed inside the lower plate 511. For example, the bobbin 513 may be installed inside the lower plate 511 in a state in which the voice coil 514 is wound thereon. The bobbin 513 may correct physical eccentricity generated due to body contact.

The bobbin 513 is formed in a cylindrical shape of which a side surface is open between an upper portion and a lower portion thereof. A radius of an upper surface and a lower surface of the bobbin 513 may be greater than a radius of the side surface thereof, and the lower portion of the side surface may extend outward so that the bobbin 513 may include the lower surface facing the upper surface. Here, the coil 514 may be wound on the side surface of the bobbin 513, and the coil 514 may be guided by the upper surface and the lower surface of the bobbin 513 which have the radius greater than the radius of the side surface of the bobbin 513. Thus, the bobbin 513 may guide the coil 514 to be stably installed at an outer peripheral portion thereof, thereby preventing the coil 514 from being separated.

The bobbin 513 may be connected to the head 520. For example, the bobbin 513 may be coupled to the head 520 through a coupling hole formed in a central portion of the upper surface thereof.

The bobbin 513 may include a heat radiation hole for radiating heat. For example, the bobbin 513 may radiate heat generated when vibration is generated through one or more heat radiation holes formed in the upper surface thereof and may reduce noise that is generated, when vibration is generated, together with a heat radiation effect.

The upper ring 516 is disposed on the lower plate 511 and may be coupled to the first leaf spring 517 and the second leaf spring 518. For example, the upper ring 516 may be coupled to the first leaf spring 517 and the second leaf spring 518 through a plurality of coupling protrusions formed on an upper surface thereof. Here, the coupling protrusions may be coupled to dampers formed in the first and second leaf springs 517 and 518. In addition, upper and lower portions of the coupling protrusion coupled to the damper are supported through an elastic member (for example, a silicone washer or the like), thereby preventing vibration from being attenuated. The upper ring 516 can form a space in which the leaf spring may move upward and downward according to the characteristics of generated sonic vibration so that the durability of the sonic vibration module 500 can be improved.

The leaf springs 517 and 518 may be installed on the bobbin 513. For example, the leaf springs 517 and 518 may be installed on the bobbin 513 and may act like a speaker to generate vibration when a sound source is applied. Specifically, the leaf springs 517 and 518 may generate sonic vibration in a vertical direction using a magnetic field generated by an interaction between the magnetic body 512 and the coil 514.

The leaf springs 517 and 518 may be made of any material suitable for generating sonic vibration. As an example, the leaf springs 517 and 518 may be made of a metal material such as copper or type 301 stainless steel (STS301).

The leaf springs 517 and 518 may include the dampers formed at an edge thereof to maximize a vibration force. For example, the leaf springs 517 and 518 may include one or more dampers which are formed in a shape elongated radially in a shape of a curved band at the edge thereof and which have coupling holes for screw coupling formed in end portions thereof. Here, the dampers may be coupled to the coupling protrusions of the upper ring 516 through the coupling holes. Of course, the shape of the damper is not limited thereto, and as an example, the damper may be formed in various ways in which an outer peripheral portion of the damper is formed in a circular structure and the end portion of the damper is disposed between fixing points.

The leaf springs 517 and 518 may include heat radiation holes for radiating heat. For example, the leaf spring 517 and 518 may radiate heat generated when vibration is generated through one or more heat radiation holes formed in an upper surface thereof and may reduce noise that is generated, when vibration is generated, together with a heat radiation effect.

The leaf springs 517 and 518 may transmit generated vibration to the outside. For example, the leaf springs 517 and 518 may be connected to the head 520 and may transmit generated sonic vibration to the head 520. Here, since sonic vibration generated in central portions of the leaf springs 517 and 518 is the strongest, the leaf springs 517 and 518 may be coupled to the head 520 through coupling holes formed in the central portions of the leaf springs 517 and 518, thereby transmitting the generated sonic vibration to the head 520.

The leaf springs 517 and 518 may be installed doubly on the bobbin 513 to improve durability. For example, the first leaf spring 517 and the second leaf spring 518 may be installed to overlap each other on the bobbin 513, but the present invention is not limited thereto. The first leaf spring 517 and the second leaf spring 518 may be installed apart from each other by a certain distance. In addition, the first leaf spring 517 and the second leaf spring 518 may be implemented to have the same material and/or shape, but the present invention is not limited thereto. The first leaf spring 517 and the second leaf spring 518 may be implemented to have different materials and/or shapes. In addition, the leaf springs 517 and 518 are not limited to the above description and may be implemented as one leaf spring without being doubly installed.

The head 520 may receive the generated vibration to transmit the vibration to the outside. For example, the head 520 may be connected to the leaf springs 517 and 518 and the bobbin 513 and may receive sonic vibration generated from the leaf springs 517 and 518 and/or the bobbin 513 to transmit the received sonic vibration to the body of the user in direct/indirect contact therewith. Specifically, a lower portion 522 of the head 520 may be inserted into the coupling holes formed in the leaf springs 517 and 518 and the coupling hole formed in the bobbin 513 and coupled to the leaf springs 517 and 518 and/or the bobbin 513. Here, a structure to be screw-coupled to the head 520 may be formed inside the coupling holes. Therefore, since the head 520 is connected to the leaf springs 517 and 518, when the leaf springs 517 and 518 generate vibration in the vertical direction by acoustic pressure, the head 520 may transmit the vibration to a body.

The head 520 may have various shapes according to a massage part or a stimulation part of a body or purpose of use. For example, the head 520 may be provided in any shape such as a plate shape, a plate shape having protrusions, a cylindrical shape, a rectangular parallelepiped shape, or a spherical shape according to a massage part and a purpose of a massage.

According to one embodiment, the head 520 may include the lower portion 522 and an upper portion 521 of the head 520. For example, the lower portion 522 and the upper portion 521 of the head 520 may be integrally formed, the lower portion may serve as a connection portion that connects the upper portion and the sonic vibration generator 510, and the upper portion may serve as a hitting portion that applies vibration. Specifically, the lower portion 522 of the head 520 may be connected to the sonic vibration generator 510, and sonic vibration generated from the sonic vibration generator 510 may be transmitted to the upper portion 521 of the head 520. The upper portion 521 of the head 520 may apply the received sonic vibration to the body of the user.

As an example, the upper portion 521 of the head 520 may be formed in a shape with a round surface including a spherical or hemispherical shape, and the lower portion 522 of the head 520 may be formed in a cylindrical shape to be inserted into the coupling holes formed in the leaf springs 517 and 518 and the coupling hole formed in the bobbin 513. However, the shape of the head 520 is not limited thereto, and as an example, the upper portion 521 of the head 520 may be implemented in various shapes such as a plate shape or a plate shape having protrusions formed thereon. However, the lower portion 522 and the upper portion 521 of the head 520 are not limited to the above description and may be implemented in other forms.

The head 520 may have a detachable/attachable structure. For example, the head 520 includes a coupling portion that is attachable to or detachable from the leaf springs 517 and 518 and may be replaced with another head 520 through the coupling portion.

In addition, although not shown, the sonic vibration module 500 may include a connection member, and the connection member may be connected to the bobbin 513 and disposed on the leaf springs 517 and 518 to serve to facilitate the attachment or detachment of various heads 520.

1.1.2.3. Air Massage Member

An air massage member may provide a massage according to a change in air pressure through expansion and contraction of an air cell. The air massage member may include the air cell and an air valve for injecting air into the air cell or discharging air from the air cell.

In addition, in order to provide stimulation to various parts of a user such as a head, a back, a waist, an arm, a leg, a calf, a hip, a sole, and a finger, the air massage member may be installed in any one of various positions of a massage device.

In addition, as described above, a sonic vibration module may be positioned outside the air massage member. Accordingly, when air is injected into or discharged from the air massage member, pressure of the sonic vibration module on the user may be increased or decreased to adjust an intensity of a vibration massage provided by the sonic vibration module. For example, when pressure of the sonic vibration module on the user is increased, the intensity of the vibration massage may be increased, and when pressure of the sonic vibration module on the user is decreased, the intensity of the vibration massage may be decreased.

In addition, the sonic vibration module may be positioned inside the air massage member. For example, the sonic vibration module may be attached inside the air cell. Even in this case, when air is injected into or discharged from the air massage member, pressure of the sonic vibration module on the user may be increased or decreased to adjust the intensity of the vibration massage provided by the sonic vibration module.

1.1.2.4. Thermal Massage Member

A thermal massage member may provide a massage by applying warm heat or cold heat. Here, warm heat may be heat that has room temperature or more to provide a warm feeling to a user, and cold heat may be heat that has room temperature or less to provide a cold feeling to the user.

In one embodiment, the thermal massage member may include a heat transfer member, and the heat transfer member may be heated to provide warm heat or cold heat to the user through conduction.

For example, the thermal massage member may include a heating unit that heats the heat transfer member and/or a cooling unit that cools the heat transfer member. In addition, the heat transfer member may include a thermoelectric element. For example, warm heat or cold heat may be generated according to a direction of a current applied to the thermoelectric element.

In addition, in another embodiment, the thermal massage member may provide air having various temperatures to provide warm heat or cold heat to the user. For example, the thermal massage member may include an air providing unit that provides air to the user. In addition, the thermal massage member may include an air heating unit for heating air and an air cooling unit for cooling air and may provide warm heat or cold heat by driving the air heating unit or the air cooling unit. In addition, the heat transfer member may be attached to another massage member such as a motion massage member, a vibration massage member, or an air massage member or may be disposed in a form included outside or inside another massage member.

2. Human Body Stimulation Operation and Massage Operation

Hereinafter, a human body stimulation operation may be an operation of providing stimulation to a user. As described above, as a purpose of stimulating the user, there are various purposes such as a massage purpose, a medical purpose, a pain relief purpose, a fatigue recovery purpose, a rehabilitation purpose, a health improvement purpose, and a weight training purpose. In addition, according to the purpose, the human body stimulation operation may also include various operations such as a massage operation, a medical operation, a pain relief operation, a fatigue recovery operation, a rehabilitation operation, a health improvement operation, and a weight training operation.

In the present specification, for convenience of description, the present invention and various embodiments will be described based on the massage operation among various human body stimulation operations. However, the present invention is not limited to the massage operation, and of course, descriptions of the present invention may be applied to the various human body stimulation operations other than the massage operation.

Hereinafter, the massage operation may be an operation of providing stimulation to the user in order to facilitate body metabolism. In one embodiment, the massage operation may include a motion massage, a vibration massage (motor vibration massage or sonic vibration massage), an air massage, a thermal massage, and a multimodal massage. In addition, the motion massage, the vibration massage (motor vibration massage or sonic vibration massage), the air massage, the thermal massage, and the multimodal massage may be expressed as a motion stimulation operation, a vibration stimulation operation (motor vibration stimulation operation or sonic vibration stimulation operation), an air stimulation operation, a thermal stimulation operation, and a multimodal stimulation operation.

Hereinafter, each massage operation will be described in detail.

2.1. Motion Massage

2.1.1. Definition and Basic Embodiment of Motion Massage

In the present specification, the expression “motion massage” may be a generally performed massage and may be an act of stimulating a body part such as repeatedly pressing the body part for a certain time or more or shaking the body part. For example, the motion massage may include various massages such as a tapping massage for tapping a body, a kneading massage for kneading the body, and a sweeping massage for sweeping the body in a specific direction. The motion massage should be broadly interpreted as including not only a conventional massage such as a tapping massage or a kneading massage but also a massage in which an applicator for massaging a body part moves and stimulates a body part.

In addition, as described above, for convenience of description, the present invention will be described based on a massage, and the description of the present invention is not limited to a massage device and a massage operation. For example, in the present specification, of course, the tapping massage, the kneading massage, the sweeping massage, and the like may be expressed as a tapping stimulation operation, a kneading stimulation operation, a sweep stimulation operation, and the like.

2.1.1.1. Detailed Embodiment of Motion Massage

2.1.1.1.1. Tapping Massage

In the present specification, a tapping massage may be a massage that provides stimulation by repeatedly coming into contact with a body of a user. For example, when the user is positioned in a z-axis direction with respect to a massage unit, the applicator may provide the tapping massage by performing a reciprocating motion in the z-axis direction.

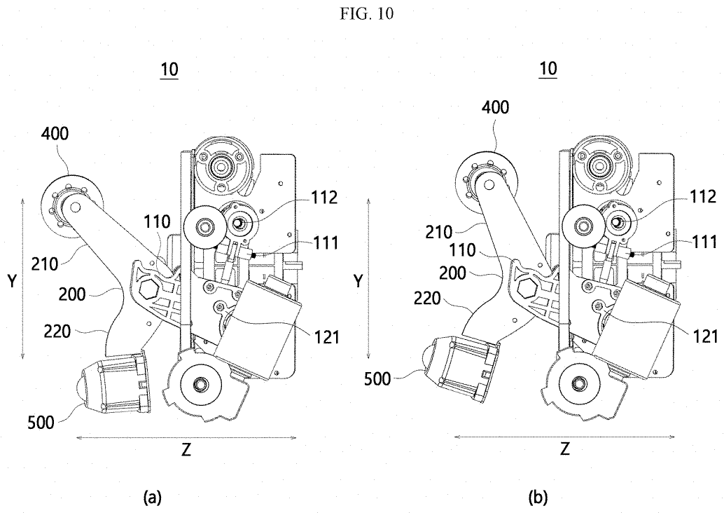

FIG. 10 shows views for describing a tapping massage according to one embodiment.

Referring to FIG. 10, a massage device 1 may provide the tapping massage using various applications.

In one embodiment, the massage device may provide the tapping massage using a massage ball 400. Specifically, FIG. 10A illustrates a massage unit when the massage ball 400 moves forward in a z-axis direction according to the tapping massage, and FIG. 10B illustrates the massage unit when the massage ball 400 moves backward in the z-axis direction according to the tapping massage.

As an example, a driving unit 100 may provide the tapping massage to a body by moving a connection part 200. For example, for the tapping massage, the driving unit 100 may include a holder 110 for mounting the connection part 200, a link for receiving power from a rotating body 111 to move the holder 110 in a certain route range, and a tapping motor 112 for rotating the rotating body 111. Specifically, the tapping motor 112 may rotate the rotating body 111, a force according to the rotation of the rotating body 111 may be transmitted to the link, and the link may move one end of the connected holder 110 within a certain motion route to move the connection part 200. Finally, a sonic vibration module 500 and the massage ball 400 may move the connection part 200 forward or backward in the z-axis direction, may move at a certain motion angle, and may come into contact with a body to tap the body. Here, when a speed of the rotating body 111 increases, a speed of tapping the body may also increase.

2.1.1.1.2. Kneading Massage

In the present specification, a kneading massage may be a massage that provides stimulation having a certain intensity or more to a user through movement of an applicator in a state in which the applicator is in contact with a body of a user. For example, when the user is positioned in a z-axis direction with respect to a massage unit, the applicator may move in the z-axis direction and then move in an x-axis direction and/or a y-axis direction to provide the kneading massage. Of course, the applicator may move in the z-axis direction while the kneading massage is performed.

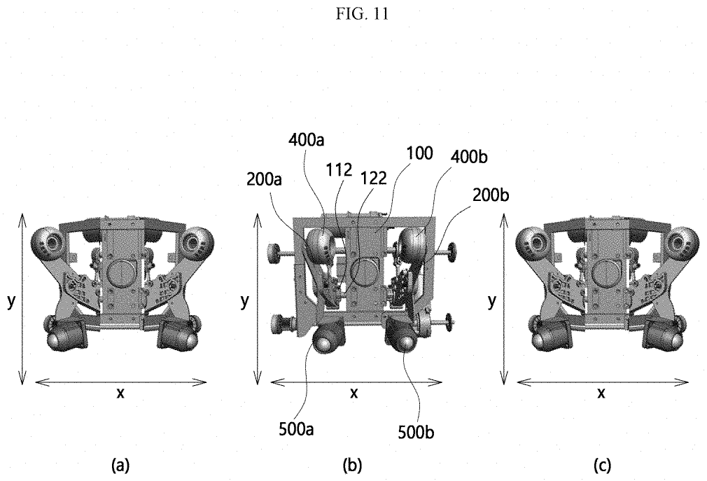

FIG. 11 shows views for describing a kneading massage according to one embodiment.

Referring to FIG. 11, a massage device 1 may provide the kneading massage using various applications.

In one embodiment, a driving unit 100 of the massage device 1 may move connection parts 200a and 200 to provide the kneading massage using a massage ball 400 and a sonic vibration module 500.

Specifically, FIG. 11 shows views illustrating the massage unit 10 in a time-series manner when the massage device 1 performs the kneading massage. FIG. 11A may illustrate a state when a separation interval between applicators is the maximum in an x-axis at a first time point when the massage device 1 performs the kneading massage, FIG. 11B may illustrate a state when the separation interval between the applicators is the minimum in the x-axis at a second time point after the first time point, and FIG. 11C may illustrate a state when the separation interval between the applicators is the maximum at a third time point after the second time point.

More specifically, for the kneading massage, the driving unit 100 may include a kneading motor (not shown), an eccentric rotating body 121, and a support shaft 122. Specifically, as the kneading motor 120 is driven, the eccentric rotating body 121 installed on the support shaft 122 may rotate eccentrically to move the connection parts 200a and 200b such that the sonic vibration module 500 and the massage ball 400 perform a kneading operation. Here, due to the eccentric rotation of the eccentric rotating body 121, the kneading operation may include all of upward/downward movement in a y-axis direction, forward/backward movement in a z-axis, and leftward/rightward movement in an x-axis direction in order to move to perform a circular motion, a semicircular motion, a quadrant motion, or an elliptical motion. For example, one pair of applicators 400a and 500a may be moved by a first connection part 200a, and another pair of applicators 400b and 500b may be moved by a second connection part 200b. In this case, when the kneading operation is the circular motion, one pair of applicators may repeatedly perform movement in which the one pair of applicators move away from each other as shown in FIG. 11A, move toward each other as shown in FIG. 11B, and move away from each other again as shown in FIG. 11C.

In addition, as the massage device 1 performs the kneading massage, contact angles between the applicators 400a, 400b, 500a, and 500b in contact with a body may also be changed.

Of course, the driving unit 100 is not limited to the above description and may be driven in other ways.

2.1.1.1.3. Other Motion Massages

In one embodiment, a massage device 1 may provide various motion massages in addition to a tapping massage and a kneading massage. For example, the massage device 1 may perform various motion massages such as a continuous hitting massage, an acupressure massage, a sweeping massage, and a complex massage. In addition, the motion massage may be performed by modifying or combining the tapping massage and/or the kneading massage. In addition, as described above, for convenience of description, the present invention will be described based on a massage, and the description of the present invention is not limited to a massage device and a massage operation. For example, in the present specification, of course, the continuous hitting massage, the acupressure massage, the sweeping massage, the complex massage, and the like may be expressed as a continuous hitting stimulation operation, an acupressure stimulation operation, a sweeping stimulation operation, a complex stimulation operation, and the like.

Specifically, the continuous hitting massage may be a massage in which a tapping massage is performed at a high speed in order to provide a high speed massage to a local body part, the acupressure massage may be a massage in which a kneading massage is performed when an applicator moves forward in the z-axis direction while a tapping massage is slowly performed to perform a massage while continuously pressing a user, and the sweeping massage may be a massage performed by moving the applicator in the y-axis direction when the applicator moves forward in the z-axis direction in order to provide a massage to a wide body range at a high speed. In addition, the complex massage may be a massage performed by combining motion massages.

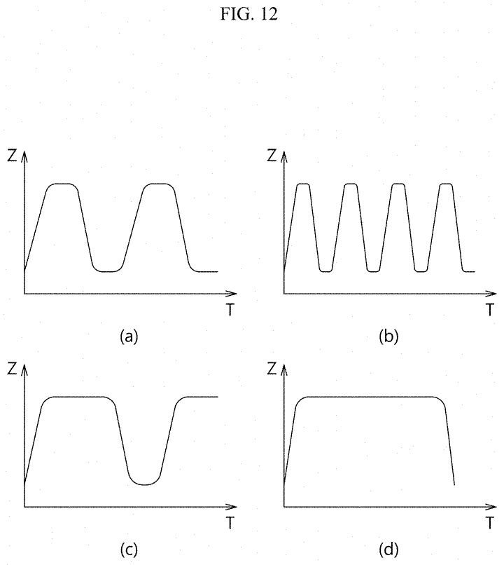

This will be described in detail with reference to FIG. 12.

FIG. 12 shows graphs for describing a motion massage according to one embodiment.

Referring to FIGS. 12, FIGS. 12A, 12B, 12C, and 12D are graphs showing movement of an applicator according to the motion massage. An x-axis of each graph represents a time, and a y-axis represents a position of the applicator in a z-axis direction (see FIG. 10).

FIG. 12A shows movement of the applicator according to a tapping massage, FIG. 12B shows movement of the applicator according to a continuous hitting massage, FIG. 12C shows movement of the applicator according to an acupressure massage, and FIG. 12D shows movement of the applicator according to a sweeping massage.

Referring to 12A, when the tapping massage is performed, the applicator may perform a reciprocating motion in the z-axis direction. In addition, referring to 12B, when the continuous hitting massage is performed, a cycle of a reciprocating motion of the applicator in the z-axis direction may be shorter than that when the tapping massage is performed. Referring to FIG. 12C, when the acupressure massage is performed, the applicator may perform a reciprocating motion in the z-axis direction, and a time for which the applicator stays far away in the z-axis direction when the acupressure massage is performed may be longer than a time for which the applicator stays far away in the z-axis direction when the tapping massage is performed. In addition, when the acupressure massage is performed, the applicator may move in an x-axis direction and/or a y-axis direction while the applicator stays far away in the z-axis direction. In addition, referring to FIG. 12D, when the sweeping massage is performed, after the applicator moves far away in the z-axis direction, the applicator may perform an upward movement or a downward movement in the y-axis direction.

2.2. Vibration Massage

In the present specification, the expression “vibration massage” may be a massage that applies vibration to a body part and may be an act of stimulating the body part through vibration. For example, the vibration massage may include a motor vibration massage that transmits vibration generated by a motor to a body part, a sonic vibration massage that transfers vibration generated by acoustic pressure to a body part, and the like. In the present specification, the vibration massage should be broadly interpreted as including not only a sonic vibration massage but also a massage that provides vibration stimulation to a body part through an applicator for massaging a body part. Hereinafter, for convenience of description, the vibration massage will be described based on the sonic vibration massage. However, the present invention is not limited thereto, and of course, the following descriptions are applicable to vibration massages other than the sonic vibration massage.

2.2.1. Definition and Embodiment of Vibration Massage

In the present specification, sonic vibration may be a type of vibration and may be vibration generated based on the generation of sound waves. For example, sonic vibration may be generated due to vibration of air generated when a sound source is input to a device for outputting sonic vibration.

In addition, a sonic vibration massage means that sonic vibration is transmitted to a body of a user to obtain a massage effect. When an appropriate sonic vibration massage is performed on the user, the user may obtain effects of improving health, such as effects of lessening a fatigue feeling, improving blood circulation, and relieving stress. The sonic vibration massage may cause various effects during a massage as compared with other vibration massages. For example, since, in the sonic vibration massage, since a repulsive force from skin is small during a massage, the sonic vibration massage may provide a good massage feeling to the user and may reduce body fatigue, which may be caused by vibration stimulation, as compared with other vibration massages. In addition, according to the sonic vibration massage, when sonic vibration is applied to skin in a direction perpendicular to a body part, penetration of the sonic vibration, which is applied to the body part, into a muscle may be further improved.

In one embodiment, when the sonic vibration massage is performed, a sonic vibration module 500 may output sonic vibrations having various characteristics. For example, the characteristics of sonic vibration may include at least one of a frequency, an amplitude, and a waveform of the sonic vibration. Here, a waveform may be related to a degree in which sonic vibration is changed for a reference time unit and may be, for example, a change pattern of at least one of a frequency and an amplitude. As an example, the waveform may include a sinusoidal waveform, a triangular waveform, and the like.

The characteristics of the sonic vibration may be related to an intensity and a massaging feeling of the sonic vibration massage.

For example, when sonic vibration having a low frequency is output from the sonic vibration module 500, an intensity of the output sonic vibration may be strong. That is, a sonic vibration massage having a higher intensity may be provided to the user using sonic vibration having a low frequency.

As another example, when sonic vibration having a high frequency is output from the sonic vibration module 500, an intensity of the output sonic vibration may be weak. That is, a sonic vibration massage having a lower intensity may be provided to the user using sonic vibration having a high frequency.

For example, when sonic vibration having a high amplitude is output from the sonic vibration module 500, an intensity of the output sonic vibration may be strong. That is, a sonic vibration massage having a higher intensity may be provided to the user using sonic vibration having a high amplitude.

For another example, when sonic vibration having a low amplitude is output from the sonic vibration module 500, an intensity of the output sonic vibration may be weak. That is, a soft sonic vibration massage having a lower intensity may be provided to the user using sonic vibration having a low amplitude.

In addition, for example, when sonic vibration having a gradually changing waveform is output from the sonic vibration module 500, a massage feeling of the output sonic vibration may be soft. That is, a sonic vibration massage with a softer massage feeling may be provided to the user using sonic vibration having a gradually changing waveform.

For another example, when rapidly changing sonic vibration is output from the sonic vibration module 500, a massage feeling of the output sonic vibration may be strong. That is, a sonic vibration massage having a stronger massage feeling may be provided to the user using sonic vibration having a rapidly changing waveform.

Of course, the characteristics of sonic vibration are not limited to the above description, and other characteristics such as a volume of an input sound source are also acceptable.

In addition, in one embodiment, the sonic vibration massage may be performed in synchronization with a motion massage. This will be described in more detail in Section 3.3.

2.3. Air Massage and Thermal Massage

In the present specification, an air massage may be a massage provided through a change in air pressure using the above-described air massage member, and a thermal massage may be a massage provided through application of hot heat or cold heat using the above-described thermal massage member.

In one embodiment, an intensity or a speed of the air massage and/or the thermal massage may be adjusted. For example, a degree of expansion of an air cell may be adjusted in a plurality of stages to adjust the intensity of the air massage, and an expansion and contraction rate of the air cell may be adjusted in a plurality of stages to adjust the speed of the air massage. As another example, a heat transfer member may be heated or cooled in a plurality of temperature stages to adjust the intensity of the thermal massage, and a heating and cooling rate of the heat transfer member may be adjusted in a plurality of stages to adjust the speed of the thermal massage.

2.4. Multimodal Massage

In the present specification, a multimodal massage may mean that one or more massages are simultaneously performed using a plurality of applications.

The multimodal massage may mean that a massage device simultaneously performs a plurality of massages. In one embodiment, the massage device may perform one type of massage as the multimodal massage using a plurality of applicators at the same time. For example, the massage device may perform sonic vibrations massage having different vibration frequencies or amplitudes as the multimodal massage using two sonic vibration modules.

In another embodiment, the massage device may simultaneously perform two or more massages among a motion massage, a vibration massage, an air massage, and a thermal massage as the multimodal massage. For example, a thermal massage module may be disposed at one end portion of a sonic vibration module, and the massage device may provide a sonic vibration massage using the sonic vibration module and simultaneously provide a thermal massage using the thermal massage module.

As another example, the massage device may provide a motion massage using a massage ball and simultaneously perform a sonic vibration massage using the sonic vibration module. In this case, the motion massage and the sonic vibration massage may be performed in synchronization with each other to increase a massage effect. This will be described in detail in Section 3.3.

3. Control of Massage Operation

3.1. Summary of Control of Motion Massage Operation

3.1.1. Control of Massage for Each Operation

In one embodiment, a massage device may receive parameters for a massage from a user and may provide a massage in response to the received parameters. For example, the massage device may receive parameters such as a type of a massage, a part to be massaged, a massage providing time, and an intensity of the massage from the user and may provide a massage according to the received parameters.

In another embodiment, the massage device may provide a massage according to a preset program. For example, the massage device may store a plurality of programs in advance, and information about at least one parameter of a plurality of parameters may be preset. At least one program may be selected from among the plurality of programs, or at least one program may be input from among the plurality of programs from the user, and a massage may be provided according to the selected or input program.

3.1.2. Control of Massage Operation based on Position of Applicator

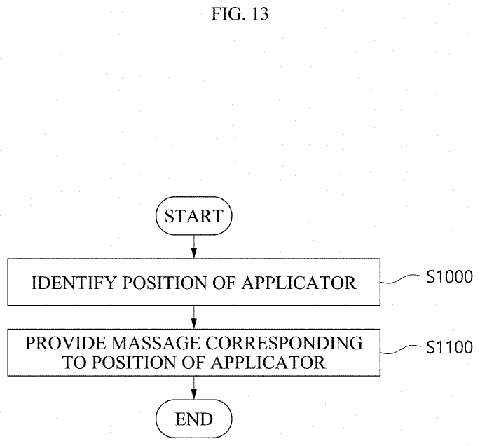

FIG. 13 is an operation flowchart of a method of providing a massage according to one embodiment. Referring to FIG. 13, the method of providing a massage according to one embodiment may include identifying, by a massage device, a position of an applicator (S1000) and providing, by the massage device, a massage corresponding to the position of the applicator (S1100). Here, the provided massage may include the above-described motion massage, sonic vibration massage, air massage, and thermal massage, but for convenience of description, the provision of the motion massage will be mainly described.

3.1.2.1. Identification of Position of Applicator

In one embodiment, the massage device may identify the position of the applicator (S1000). Specifically, in one embodiment, the massage device may include a position detection unit (not shown). The position detection unit may detect a position of a massage unit itself or components thereof. For example, the position detection unit may determine the position of the massage unit using a position detection sensor provided in a preset region of the massage device. Here, the position detection sensor may include at least one sensor for detecting at least one of a vertical position and a horizontal position of the massage unit.

The position detection unit may include, for example, an encoder, a magnetic sensor, an optical sensor, a pressure sensor, and the like. For example, the position detection unit may include the encoder and may calculate the position of the massage unit using a rotation value of a motor included in a driving unit. For another example, the position detection unit may include the optical sensor and may calculate the position of the massage unit by identifying a connection part that is moved by the driving unit as a sonic vibration module and/or a massage ball come into contact with a body.

Such a position detection unit may detect the position of the massage unit and may calculate the position of the applicator based on the detected position of the massage unit.

For another example, a controller may identify the position of the applicator from a memory (not shown) in which position information of the applicator installed at a preset position is stored. Here, the applicator may be provided in a form which is fixedly installed in the massage device to have a fixed position.

3.1.2.2. Provision of Motion Massage based on Position of Applicator

In one embodiment, the massage device may provide a massage corresponding to the position of the applicator (S1100).

In one embodiment, the controller may provide a massage through the massage unit for each position of the massage unit based on the identified position of the massage unit. For example, the controller may provide a first massage through the massage unit at a first position of the massage unit and may provide a second massage different from the first massage through the massage unit at a second position of the massage unit different from the first position. Here, in the massage provided for each position of the applicator, types, intensities, and characteristics of massages, combinations thereof, and the like may be different. As an example, the massage device may provide a sonic vibration massage, a motion massage, or other massages according to the position of the applicator, and intensities or characteristics of the provided massages may be different.

In another embodiment, the controller may estimate a body type of a user using the position of the application and may provide a massage based on the estimated body type.

Specifically, the controller may detect a portion of a body of the user through the position detection unit and may estimate the body type of the user based on a position of the detected portion of the body. For example, the controller may detect a shoulder of the user through the position detection unit and may estimate a body length of the user using a position of the detected shoulder. For another example, the controller may detect left and right ends of the user through the position detection unit and may estimate a body width of the user using positions of the detected ends.

More specifically, the massage device may detect the position of the shoulder of the user. The controller may detect the shoulder of the user through the position detection unit to estimate the body type of the user. For example, the controller may vertically move the massage unit along a backrest and detect the shoulder of the user based on a load change according to a vertical position of the applicator. Here, when the applicator moves upward beyond the shoulder of the user, since a load detected by the position detection sensor decreases, upper and lower position of the shoulder position may be known. Since a magnitude of a load is also related to front and rear positions of the applicator, when a position of a shoulder is detected, the front and rear positions of the applicator detected from the position detection sensor may also be considered.

In addition, the massage device may estimate the body length of the user body using the detected position of the shoulder. The controller may estimate the body length of the user based on a length between the detected position of the shoulder and a preset position. For example, the controller may estimate the length between the detected position of the shoulder and a position near a hip as a length of an upper body of the user. Here, the position near the hip may be detected by a separate position detection sensor, and the body length of the user may be estimated in other ways in which the body length of the user is estimated using a position near a foot rather than the position near the hip.

In addition, the massage device may determine a body part corresponding to a position of a massage applicator based on the estimated body length. The controller may divide the estimated body length into a plurality of sections each having a preset proportion and may determine a body part corresponding to each section. That is, the controller may determine a body part based on upper and lower positions. Here, the preset proportion may be set based on a standard proportion for each body part of a person. For example, the massage device may divide a body length into three sections according to the standard proportion for each body part and may make the sections correspond to a shoulder, a waist, or a hip.

In addition, the controller may acquire body information of the user (for example, weight, height, or body mass index (BMI) information of the user) from an operation unit (not shown) and may also estimate body characteristics of the user based on the acquired body information.

In addition, the controller may estimate the body type of the user through a sensor provided in the massage device. For example, the controller may detect pressure applied by the user using the pressure sensor and may estimate the body type of the user using the detected pressure. As an example, the controller may estimate a muscle mass, fat mass, or the like of the user based on the pressure detected by the pressure sensor. This is because the pressure detected by the pressure sensor varies according to a bone, fat mass, or muscle mass.

In addition, the massage device may determine a body part to be massaged based on the estimated body type of the user. For example, the controller may identify the position of the massage applicator through the position detection unit and may determine at which body part the applicator is positioned based on the estimated body type of the user. Accordingly, the massage device may more accurately determine a body part in consideration of body characteristics for each user.

In addition, the massage device may determine an estimated body type of a user and/or a body part to be massaged and may provide an optimal massage to the user by selecting a type of a massage, an intensity of the massage, a speed of the massage, or the like suitable for the body type of the user and/or the body part to be massaged.

3.2. Control of Vibration Massage Operation

3.2.1. Control Method of Controller for Controlling Vibration Massage Operation

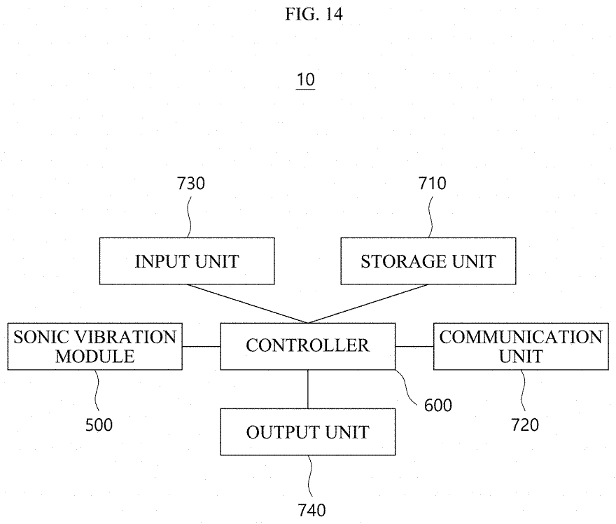

FIG. 14 is a block diagram illustrating a massage unit according to one embodiment.

Referring to FIG. 14, a massage unit 10 shown in FIG. 14 is another embodiment of the massage unit 10 described with reference to FIG. 2. All of the contents described with reference to FIGS. 2 and 14 may be applied to the massage device 10 in the present specification.

The massage unit 10 according to one embodiment may further include a storage unit 710, a communication unit 720, an input unit 730, and an output unit 740 in addition to the sonic vibration module 500 and the controller 600 described above. Here, the sonic vibration module 500 is one of embodiments of an application 300, and the massage unit 10 may include a vibration massage member, a motion massage member, an air massage member, a thermal massage member, and the like in addition to the sonic vibration module 500. Hereinafter, for convenience of description, the sonic vibration module 500 among the applicator 300 will be mainly described.

The controller 600 may control the sonic vibration module 500. For example, the controller 600 may control an output time, a vibration frequency, an amplitude, and the like of sonic vibration by the sonic vibration module 500.

In addition, the controller 600 may control the sonic vibration module 500 using a sound source signal. Here, the sound source signal may represent information that is necessary for generating sound waves in the sonic vibration module 500 and may include frequency information of a sound wave and/or intensity information of the sound wave.

For example, one sound source signal may include one piece of frequency information and one piece of intensity information and may include a plurality of pieces of frequency information and a plurality of pieces of intensity information. In addition, a frequency included in the sound source signal may be an audible frequency. As an example, the frequency included in the sound source signal may be an audible frequency in a range of 50 Hz to 300 Hz. In addition, the sound source signal may include a digital sound source in a digital format and an analog sound source in an analog format.

In one embodiment, the controller 600 may control a vibration module and an output module. The controller 600 may control the storage unit 710, the communication unit 720, the input unit 730, and the output unit 740.

In one embodiment, the storage unit 710 may store a sound source signal for controlling the sonic vibration module 500. In addition, the storage unit 710 may store a preset program for controlling the above-described massage operation.

In one embodiment, the communication unit 720 may transmit/receive data to/from an external device. For example, the communication unit 720 may transmit/receive data to/from a user device (for example, a mobile device) or a server. The communication unit 720 may include a wireless module for 3G, 4G, or long-term evolution (LTE) communication. In addition, the communication unit 720 may perform short-range wireless communication. The communication unit 720 for such short-range wireless communication may include at least one of a Bluetooth module, a radio frequency identification (RFID) module, an infrared communication module, an ultra-wideband (UWB) module, and a ZigBee module, but the present invention is not limited thereto. In addition, as an example, the communication unit 720 may receive a sound source signal from the external device, and the received sound source signal may be stored in the storage unit 710.

In one embodiment, the input unit 730 may receive data for controlling a massage device from a user. For example, the input unit 730 may include a remote controller for controlling the massage device. In addition, the input unit 730 may receive information for controlling the sonic vibration module 500. Exemplarily, the information for controlling the sonic vibration module 500 may include information for selecting a sound source signal to be applied to the sonic vibration module from among a plurality of sound source signals, information for controlling an intensity of the sound source signal, or information for controlling a frequency of the sound source signal. In addition, the information received by the input unit 730 may include other various types of information. For example, the information received by the input unit 730 may include information about a massage mode or the like included in the above-described massage program.

In one embodiment, the output unit may be a device for displaying information about the massage device to the user. As an example, the output unit may include a media output unit and a sound source output unit.

For example, the media output unit may be a component that outputs media data to the user and may be a module such as a display such as a liquid crystal display (LCD). In addition, the media output unit may display frequency information of the sound source signal for controlling the sonic vibration module 500 or intensity information of the sound source signal.

As another example, the sound source output unit is a component that outputs a sound source signal having a specific frequency to the user. For example, the sound source output unit may include a speaker.

In addition, in one embodiment, the controller 600 may perform a motion massage operation based on a sound source signal. For example, the controller 600 may generate a control signal based on a sound source signal and may apply the control signal to the driving unit 100 or a motor. Accordingly, a motion massage operation and a sonic vibration massage operation may be synchronized with each other by the sound source signal.

Hereinafter, a control method of a controller 600 will be described in detail.

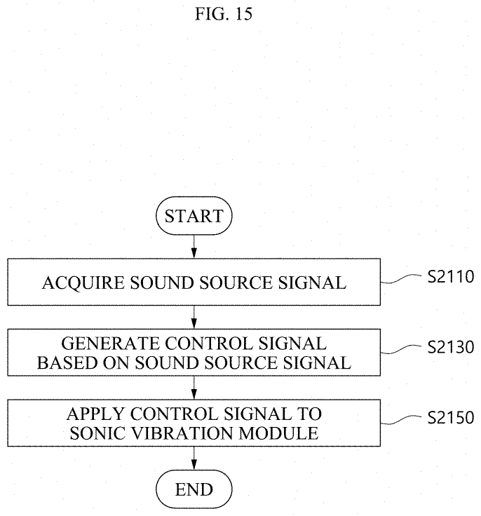

FIG. 15 is an operation flowchart illustrating a control method of a controller according to one embodiment.

Referring to FIG. 15, the control method of the controller according to one embodiment may include obtaining a sound source signal (S2110), generating a control signal based on the sound source signal (S2130), and applying the control signal to a sonic vibration module (S2150).

In operation S2110, the controller 600 may obtain the sound source signal from the outside or the inside of a sonic vibration module 500. Specifically, the controller 600 may obtain the sound source signal from an external device (for example, a mobile device or a sound server) through a communication unit 720 or load a sound source signal prestored in a storage unit 710 of the sonic vibration module 500.

More specifically, the controller 600 may obtain a sound source file (for example, a WAV file or a MP3 file) from the external device through the communication unit 720 and may store the obtained sound source file in the storage unit 710. The controller 600 may use the obtained sound source file as the sound source signal or may convert the obtained sound source file into the sound source signal. In addition, the controller 600 may obtain a file including a sound source (for example, an image file including a sound source) through the communication unit 720 and may store the obtained file including the sound source in the storage unit 710. The controller 710 may extract a sound source signal from the file including the sound source.

In addition, in operation S2130, the controller 600 may adjust a frequency and/or intensity of the obtained sound source signal and then generate a control signal based on the adjusted sound source signal. Of course, according to embodiments, the controller 600 may generate the control signal based on the sound source signal without adjusting the frequency and/or intensity of the sound source signal.

In addition, the controller 600 may process the sound source signal to be suitable for a massage operation. For example, the controller 600 may adjust a sound source reproduction time, frequency, intensity, or the like of the sound source signal to process the sound source signal so as to be suitable for a motion massage operation. The controller 600 may generate the control signal based on the processed sound source signal.

In addition, in operation S2150, the controller 600 may apply the control signal to the sonic vibration module 500 such that a control signal having a specific frequency and intensity is output from the sonic vibration module 500.

As an example, the control signal may be an electrical signal. In this case, the controller 600 may apply the control signal to a coil 514. In this case, the control signal may be an AC signal or a DC signal. In addition, the controller 600 may adjust an intensity of the control signal to adjust an intensity of vibration generated by the sonic vibration module 500. That is, the controller 600 may apply the control signal, of which the intensity is adjusted, to the sonic vibration module 500.

The sonic vibration module 500 may generate sonic vibration according to the control signal. In this case, the sonic vibration generated by the sonic vibration module 500 may correspond to the characteristics of the sound source signal that is the basis of the control signal. For example, the sonic vibration module 500 may output sonic vibration according to a frequency and intensity of the sound source signal. That is, changes in frequency and intensity of the sound source signal over time may be reflected on a frequency and intensity of the sonic vibration.

Meanwhile, the controller 600 may control an output unit to output a frequency type and intensity level of a sound source signal, which is input by a user, through a display or the like. In addition, the controller 600 may control a sound source signal having a specific frequency and intensity input by the user to be output to a speaker or the like through the output unit. Furthermore, the controller 600 may control a sound source signal input by the user to be output in the form of vibration through a sonic vibration generator 1100. In other words, the controller 600 may control one sound source signal to be simultaneously output from the sonic vibration module 500 and an output unit 740. In addition, in another embodiment, different sound source signals may be simultaneously output from the sonic vibration module 500 and the output unit 7400.

3.2.2. Sound Source Signal

As described above, a sound source signal may have an audible frequency. This is because, when a control signal based on a sound source signal in an audible frequency band is applied to a sonic vibration module 500, the sonic vibration module may generate sonic vibration in an audible frequency band, and the sonic vibration in the audible frequency band may increase a massage effect with respect to a user.

In one embodiment, a frequency and/or intensity of the sound source signal may change over time. Specifically, the frequency and/or intensity of the sound source signal may be changed by being increased and then decreased over time, which may appear as waveform characteristics of the sound source signal. The sonic vibration module 500 may output sonic vibration according to the waveform characteristics of the sound source signal. Accordingly, it can be considered that the waveform characteristics of the sound source signal reflect the characteristics of the sonic vibration output from the sonic vibration module 500. According to the characteristics of the sonic vibration, the sonic vibration module 500 may provide various sonic vibration massages to the user.

3.2.2. Waveform Characteristics of Sound Source

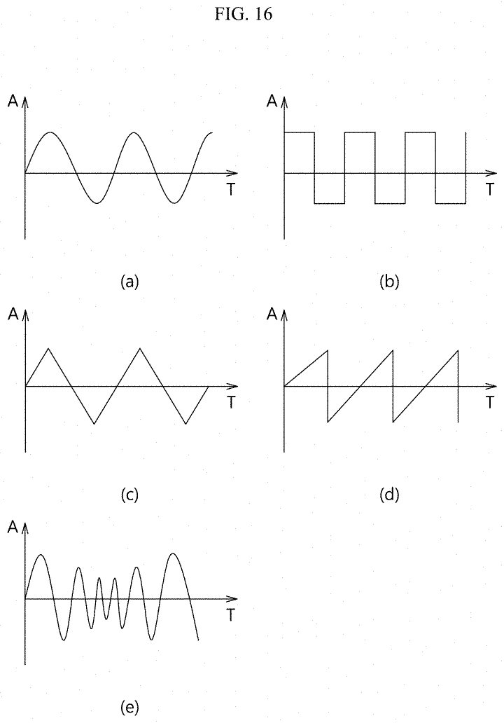

FIG. 16 shows graphs showing examples of a sound source waveform according to one embodiment. Referring to FIG. 16, in the present specification, a waveform of a sound source signal may be expressed as a sound source waveform. In addition, the sound source waveform may be expressed as a driving waveform and a sonic vibration waveform. In addition, in one embodiment, since the sound source waveform may be generated based on two or more waveforms or may be a waveform in which two or more waveforms are combined, the sound source waveform may also be expressed as a composite waveform.

In one embodiment, the sound source signal may have various types of waveforms. Since the sound source signal has various types of waveforms, it may be possible to provide a sonic vibration massage having various patterns.

Specifically, in FIGS. 16A to 16E, an x-axis may represent a time, and a y-axis may represent an amplitude. First, FIG. 16A shows a sound source waveform having a sine wave. As shown in FIG. 16A, in the sound source waveform, a change in amplitude thereof over time appears in the form of a sine wave, and a waveform may be repeated according to a certain cycle. In FIG. 16A, the number of cycles of the waveform repeated per second may become a frequency. When a control signal corresponding to a sound source signal having the sound source waveform of FIG. 16A is applied to a sonic vibration module 500, the number of vibrations per second of the sonic vibration module 500 (for example, the number of vibrations of a head 520) may be determined by the frequency of the waveform of FIG. 16A, and a vibration range of the sonic vibration module 500 (for example, a vibration range of the head 520) may be determined by an amplitude of the frequency of the waveform of FIG. 61A.

In addition, in one embodiment, a sound source waveform may have another form other than the sine wave. For example, FIG. 16B shows a sound source waveform having a quadrangular wave, FIG. 16C shows a sound source waveform having a triangular wave, and FIG. 16D shows a sound source waveform having a sawtooth wave. Of course, a sound source waveform may be formed as another waveform other than the waveforms shown in FIGS. 16A to 16D.

In addition, although the sound source waveforms shown in FIGS. 16A to 16D have a constant frequency and amplitude, the present invention is not limited thereto, and a frequency and/or waveform of the sound source waveforms may be changed. For example, FIG. 16E shows a sound source waveform having a sine wave. In the example of FIG. 16E, a frequency of the sound source waveform is decreased and then increased, and an amplitude of a sound source signal is decreased and then increased. This may indicate that a frequency and/or amplitude of the sound source signal may be changed over time.

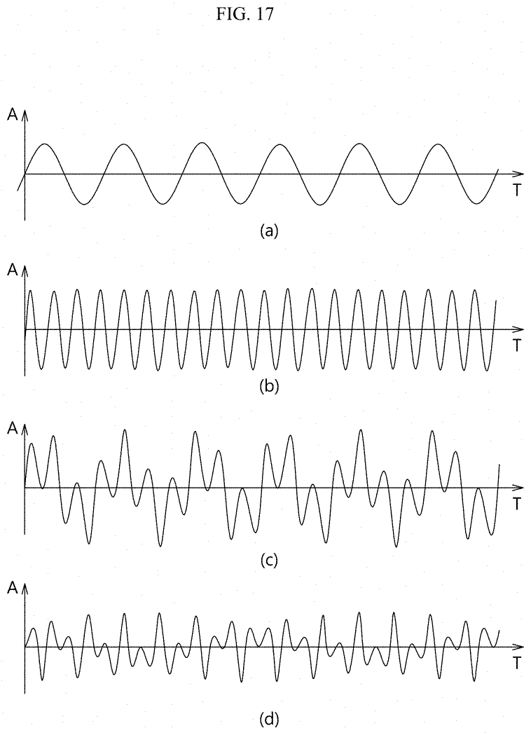

FIG. 17 shows graphs showing examples of a sound source waveform according to another embodiment.

Referring to FIG. 17, a sound source waveform may be generated based on two or more basic waveforms. For example, a sound source waveform may have a form in which two or more basic waveforms are combined. For example, a sound source waveform may represent a form in which two basic waveforms are combined or a form in which two basic waveforms are multiplied. In addition, the present invention is not limited thereto, and a sound source waveform may be generated by combining three or more basic waveforms more than two basic waveforms.

According to one embodiment, in FIGS. 17A to 17D, an x-axis may represent a time, and a y-axis may represent an amplitude. FIG. 17A shows a first basic waveform, and FIG. 17B shows a second basic waveform. Here, the first basic waveform and the second basic waveform may each represent a sound source waveform or may represent other waveforms other than a sound source signal. The first basic waveform and the second basic waveform may represent a sine wave, and a frequency of the second basic waveform may be higher than a frequency of the first basic waveform. Of course, the first basic waveform and the second basic waveform may be waveforms different from the sine wave.

FIG. 17C shows a first composite waveform in which the first basic waveform and the second basic waveform are combined. FIG. 17D shows a second composite waveform in which the first basic waveform and the second basic waveform are multiplied.

As shown in FIGS. 17C and 17D, an amplitude change degree and amplitude change cycle of the first composite waveform and the second composite waveform may be diverse as compared with the first basic waveform and the second basic waveform. Accordingly, when a sonic vibration module 500 is controlled using a composite waveform, it is possible to provide a sonic vibration massage with various feelings to a user.

3.2.3. Sonic Vibration Massage according to Changes in Frequency and Amplitude

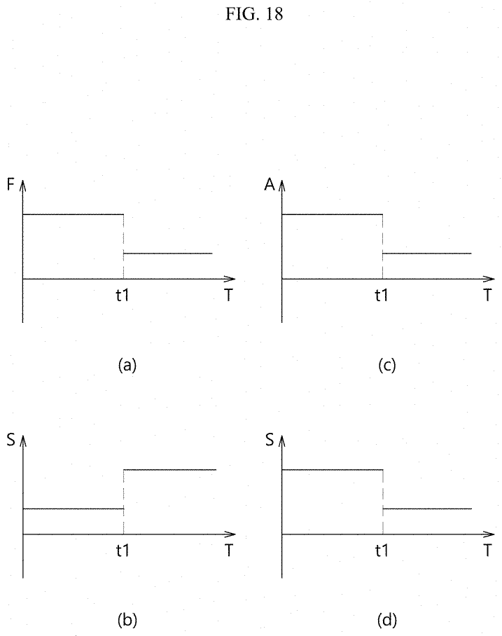

FIG. 18 shows graphs for describing a change in intensity of a sonic vibration massage according to changes in frequency and amplitude of a sound source signal according to one embodiment.

Referring to FIG. 18, an intensity of a sonic vibration massage may vary according to a frequency and/or amplitude of a sound source signal. Here, the intensity of the sonic vibration massage may be an intensity actually felt by a user or may represent an actual intensity provided to the user.

In one embodiment, even when an amplitude of a sound source signal is constant, an intensity of a sonic vibration massage may vary according to a change in frequency.

In FIG, 18A, an x-axis may represent a time, and a y-axis may represent a frequency, and in FIG. 18B, an x-axis may represent a time, and a y-axis may represent an intensity of a sonic vibration massage. In FIG. 18A, a sound wave signal may be maintained at a first frequency until a time point t1, and after the time point t1, the sound wave signal may be maintained as a second frequency that is lower than the first frequency. In this case, as shown in FIG. 18B, the intensity of the sonic vibration massage up to the time point tl may be lower than the intensity thereof after the time point t1. In this case, even when an amplitude of the sonic vibration massage in a control signal is set to be constant, the intensity of the sonic vibration massage after the time point t1 may be higher than that before the time point t1.

In addition, in one embodiment, when a frequency of a sound source waveform is constant, an intensity of a sonic vibration massage may vary according to a change in amplitude.

In FIG. 18C, an x-axis may represent a time, and a y-axis may represent an amplitude of the sound source signal, and in FIG. 18D, an x-axis may represent a time, and a y-axis may represent an intensity of the sonic vibration massage. In FIG. 18C, the sound wave signal may be maintained at a first amplitude until the time point t1 and may be maintained at the second amplitude, which is lower than the first amplitude, after the time point t1. In this case, as shown in FIG. 18D, the intensity of the sonic vibration massage up to the time point t1 may be higher than an intensity thereof after the time point tl according to an amplitude of the sonic vibration massage.

3.2.4. Sonic Vibration Massage according to Movement of Sonic Vibration Module

3.2.4.1. Sonic Vibration Massage according to Movement Cycle of Sonic Vibration Module

3.2.4.1.1. Synchronization Waveform and Vibration Waveform

As described above, a controller 600 may generate a control signal using a sound source waveform and apply the control signal to a sonic vibration module, thereby providing a sonic vibration massage with various feelings to a user.

In describing a sound source waveform in more detail, the sound source waveform may be generated based on a synchronization waveform and a vibration waveform. Here, the synchronization waveform may affect an overall waveform shape of the sound source waveform, for example, an envelope of the sound source waveform and may be a waveform having a low frequency among basic waveforms that are the basis of the sound source waveform. In addition, the synchronization waveform may have a certain pattern, and accordingly, the synchronization waveform may be expressed as a synchronization pattern, a synchronization vibration pattern, or the like.

Furthermore, the synchronization waveform may affect a vibration pattern of the sonic vibration module.

In addition, the vibration waveform affects a detailed frequency of the sound source waveform, and for example, a frequency of the vibration waveform may be included in an audible frequency band. In addition, the vibration waveform may also have a certain pattern, and accordingly, the vibration waveform may be expressed as a vibration pattern.

Hereinafter, a frequency of the synchronization waveform may be expressed as a synchronization frequency, and the frequency of the vibration waveform may be expressed as a vibration frequency. In addition, in the present specification, the synchronization waveform and the vibration waveform may also be expressed as a synchronization signal and a vibration signal.

In one embodiment, the synchronization waveform may be formed as various waveforms.

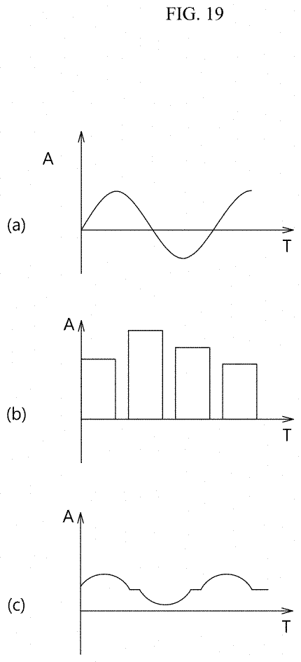

FIG. 19 shows graphs for describing an example of a synchronization waveform according to one embodiment.

Referring to FIG. 19, FIGS. 19A to 19C are graphs illustrating the synchronization waveform. An x-axis may represent a time, and a y-axis may represent an amplitude. The synchronization waveform may include a sine waveform as shown in FIG. 19A, a quadrangular waveform as shown in FIG. 19B, and a complex waveform as shown in FIG. 19C. Of course, in addition, the synchronization waveform may include various waveforms such as a triangular waveform and a sawtooth waveform.

For example, in FIG. 19B, the quadrangular waveform is a form in which two waveforms having different amplitudes appear alternately. A certain idle time may be present between the quadrangular waveforms, and during the corresponding idle time, a sonic vibration module may stop generating sonic vibration. Of course, in the example of FIG. 19B, two detailed synchronization waveforms may appear serially and alternately without an idle time. In addition, in FIG. 19C, in the complex waveform, elliptic waveforms and linear waveforms may appear alternately. Of course, in the example of FIG. 19C, in the composite waveform, the elliptical waveforms may be repeated without a straight line waveform, or elliptical waveforms with a changed shape may appear repeatedly.

In addition, in one embodiment, the synchronization waveform may be associated with movement of the sonic vibration module.

A position of the sonic vibration module may be fixed to provide a sonic vibration massage, but the sonic vibration module may move to provide the sonic vibration massage. In this case, according to one embodiment, the sonic vibration module may move according to certain movement patterns to provide the sonic vibration massage. The synchronization waveform may be synchronized with the certain movement patterns. For example, when the sonic vibration module moves by a first position along a z-axis to press a user with a first intensity, the sonic vibration module may provide a sonic vibration massage having a high intensity, and when the sonic vibration module moves by a second position closer to the massage unit than the first position along the z-axis to press the user with a second intensity lower than the first intensity, the sonic vibration module may provide a sonic vibration massage having a low intensity. As described above, the position of the sonic vibration module and an intensity of the sonic vibration massage may have a similar tendency or may be synchronized with each other, and to this end, a movement pattern of the sonic vibration module the synchronization waveform may have a similar tendency or may be synchronized with each other. This is because the synchronization waveform affects an overall waveform shape of a sound source waveform, that is, an overall vibration pattern of the sonic vibration massage.

In addition, the position of the sonic vibration module may be associated with other massages such as a motion massage. For example, as described above with reference to FIGS. 3 and 4, when a massage ball 400 providing a motion massage and a sonic vibration module 500 are connected to one connection part 200 at the same time, the sonic vibration module 500 may move according to movement of the massage ball 400, that is, a pattern of the motion massage. Accordingly, the synchronization waveform may have a similar tendency as or synchronized with a pattern of other massages such as a motion massage.

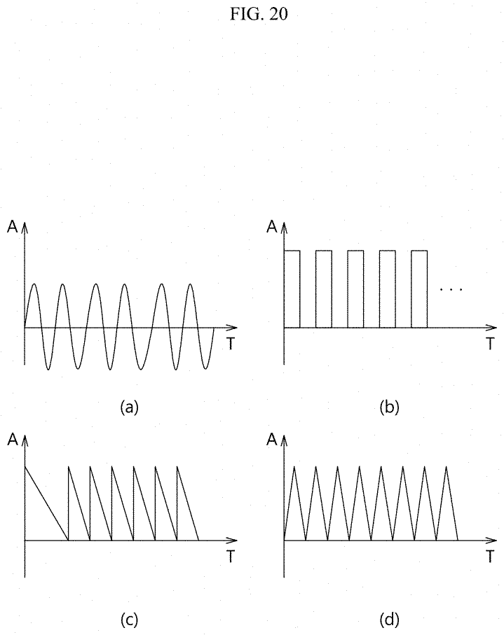

FIG. 20 shows graphs for describing an example of a vibration waveform according to one embodiment.

Referring to FIG. 20, FIGS. 20A to 20D are graphs illustrating the vibration waveform. An x-axis may represent a time, and a y-axis may represent an amplitude. The vibration waveform may include a sine waveform as shown in FIG. 20A, a quadrangular waveform as shown in FIG. 20B, a sawtooth waveform as shown in FIG. 20C, and a triangular waveform as shown in FIG. 20D. Of course, in addition, the synchronization waveform may be formed as various waveforms such as a complex waveform.

The vibration waveform affects a detailed amplitude of a sound source waveform, and a vibration frequency of the vibration waveform may be higher than a synchronization frequency of a synchronization waveform. Accordingly, according to the vibration frequency of the vibration waveform, the number of times, by which a sonic vibration module is repeated while the synchronization waveform proceeds for one cycle, may be determined.

In addition, in one embodiment, the vibration frequency may be in an audible frequency band. For example, the vibration frequency may be in a range of 80 Hz to 300 Hz.

In addition, an amplitude and frequency of the vibration waveform may be various. For example, the vibration waveform may include detailed vibration waveforms having one amplitude and/or different frequencies.

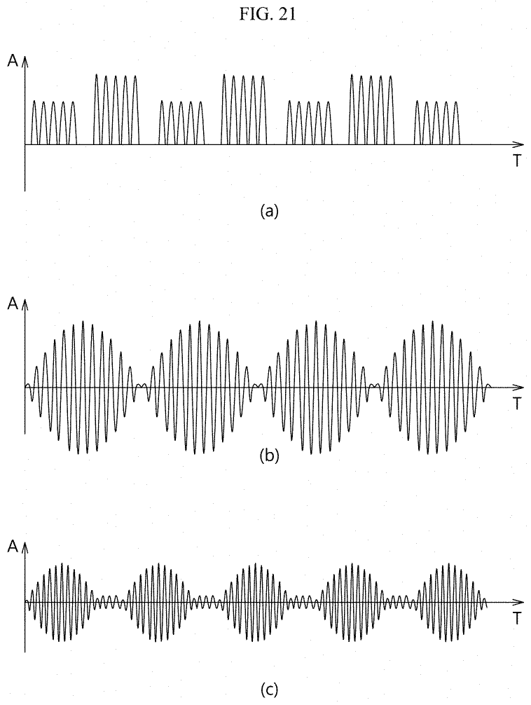

FIG. 21 shows graphs showing an example of a sound source waveform according to one embodiment.

Referring to FIG. 21, an x-axis may represent a time, and a y-axis may represent an amplitude. Specifically, in FIGS. 21A to FIG. 21C, a vibration waveform may be the sine waveform of FIG. 20A. A synchronization waveform in FIG. 21A may be the quadrangular waveform of FIG. 19A, a synchronization waveform in FIG. 21B may be the sine waveform of FIG. 19B, and a synchronization waveform in FIG. 21C may be the complex waveform of FIG. 19C.

As shown in FIGS. 21A to 21C, an overall waveform of a sound source waveform may be greatly affected by a synchronization waveform. For example, an envelope of a sound source waveform in FIG. 21A may have a shape of a quadrangular waveform that is a synchronization waveform, an envelope of a sound source waveform of FIG. 21B may have a shape in which a sine waveform, which is a synchronization waveform, appears symmetrically with respect to the y-axis, and an envelope of a sound source waveform in FIG. 21C may have a shape in which a complex waveform of an elliptic waveform and a linear waveform, which are synchronization waveforms, appears symmetrically with respect to the y-axis. In addition, detailed waveforms may fill the interior of the envelope of the sound source waveform, and a frequency of the detailed waveform may be determined based on a frequency of a vibration waveform. Since the detailed waveforms are present inside the envelope of the sound source waveform, sonic vibration can be generated in a sonic vibration module based on the sound source waveform, and more stereoscopic and various sonic vibration massages may be provided to a user.

3.2.4.1.2. Movement Cycle of Sonic Vibration Module and Synchronization Waveform

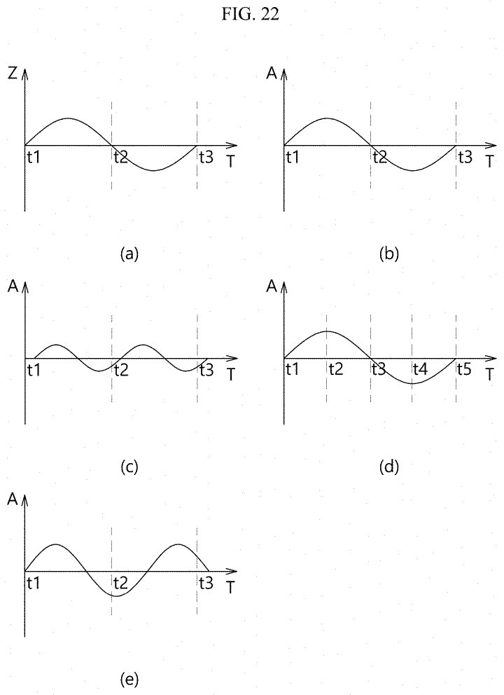

FIG. 22 shows graphs illustrating a relationship between a movement cycle of a sonic vibration module and a synchronization waveform according to one embodiment.

Referring to FIG. 22, FIG. 22A shows the movement cycle of the sonic vibration module. An x-axis may represent a time, and a y-axis may represent a movement length of the sonic vibration module along a z-axis. In FIG. 22A, the sonic vibration module may repeatedly perform a movement pattern in which the sonic vibration module moves from a reference position in a z-axis direction according to a shape of a sine wave, moves backward in a z-axis direction, and then moves to the reference position again. As described above, the synchronization waveform may be synchronized with the movement pattern of the sonic vibration module. That is, a vibration pattern of the sonic vibration module and the movement pattern of the sonic vibration module may be synchronized with each other. Specifically, a cycle of the synchronization waveform may be n times or 1/n times a cycle of the movement pattern of the sonic vibration module (here, n is a natural number). This may be to provide a comfortable massage by minimizing a sense of difference due to a massage device simultaneously providing stimulation and a sonic vibration massage according to movement of the sonic vibration module. The massage device at least partially matches start and end times of the movement pattern of the sonic vibration module with start and end times of the vibration pattern of the sonic vibration massage, thereby providing a comfortable massage, in which a sense of difference is minimized, to a user. Of course, even when the start and end times of the movement pattern of the sonic vibration module do not necessarily match the start and end times of the synchronization waveform, when the start and end times of the synchronization waveform are included within a certain time based on the start and end times of the movement pattern of the sonic vibration module, it is possible to reduce a possibility that the user feels a sense of difference due to stimulation and a sonic vibration massage being simultaneously provided according to movement of the sonic vibration module.

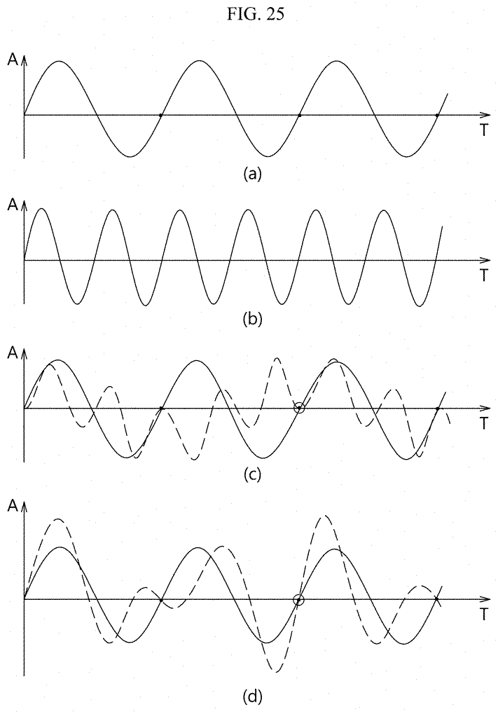

In one embodiment, a reason why the cycle of the synchronization waveform is set to be n times or 1/n times the cycle of the movement pattern of the sonic vibration module is that the synchronization waveform may have a great influence on the vibration pattern of the sonic vibration massage, and a vibration frequency of the vibration waveform may be more likely to vary as compared with a synchronization frequency of the synchronization waveform according to a user input or a preset setting. Of course, the vibration pattern of the sonic vibration massage may be changed by a vibration waveform as well as a synchronization waveform, which will be described in more detail with reference to FIG. 25.

Specifically, FIGS. 22B to 22E show the synchronization waveform. In FIGS. 22B to 22E, an x-axis may represent a time, and a y-axis may represent an amplitude.

FIG. 22B shows a case in which a cycle of the synchronization waveform is the same as a cycle of the movement pattern of the sonic vibration module. In other words, a frequency of the synchronization waveform may be the same as a frequency of the movement pattern of the sonic vibration module. In this case, the start time of the movement pattern of the sonic vibration module may correspond to the start time of the synchronization waveform, and the end time of the movement pattern of the sonic vibration module may correspond to the end time of the synchronization waveform. Accordingly, a possibility that the start and end times of the movement pattern of the sonic vibration module and the start and the end times of the vibration pattern of the sonic vibration massage may at least partially match each other may increase.

FIG. 22C shows a case in which a cycle of the synchronization waveform is ½ times a cycle of the movement pattern of the sonic vibration module. In other words, a frequency of the synchronization waveform may be twice a frequency of the movement pattern of the sonic vibration module. In this case, when the sonic vibration module moves during one cycle, the sonic vibration module may perform a sonic vibration massage during two cycles. In this case, the start time of the movement pattern of the sonic vibration module may correspond to the start time of the synchronization waveform, and the end time of the movement pattern of the sonic vibration module may correspond to the end time of the synchronization waveform. Accordingly, a possibility that the start and end times of the movement pattern of the sonic vibration module and the start and the end times of the vibration pattern of the sonic vibration massage may at least partially match each other may increase.

FIG. 22D shows a case in which a cycle of the synchronization waveform is twice a cycle of the movement pattern of the sonic vibration module. In other words, a frequency of the synchronization waveform may be ½ times a frequency of the movement pattern of the sonic vibration module. In this case, when the sonic vibration module moves during two cycles, the sonic vibration module may perform a sonic vibration massage during one cycle. In this case, when the sonic vibration module moves during two cycles, the sonic vibration module may perform a sonic vibration massage during one cycle. In this case, the start time of the synchronization waveform may correspond to the start time of the movement pattern of the sonic vibration module, and the end time of the synchronization waveform may correspond to the end time of the movement pattern of the sonic vibration module. Accordingly, a possibility that the start and end times of the movement pattern of the sonic vibration module and the start and the end times of the vibration pattern of the sonic vibration massage may at least partially match each other may increase.

On the other hand, FIG. 22E shows a case in which a cycle of the synchronization waveform is not synchronized with a cycle of the movement pattern of the sonic vibration module. In this case, the start and end times of the movement pattern of the sonic vibration module may not at least partially match the start and end times of the synchronization waveform. In addition, in this case, a time point at which the start and end times of the movement pattern of the sonic vibration module and the start and end times of the synchronization waveform at least partially match each other may be later than a time at which the cycle of the synchronization waveform and the cycle of the movement pattern of the sonic vibration module are synchronized with each other.

For example, even when the movement pattern of the sonic vibration module is repeated during a plurality of cycles, there may be no time point at which the start and end times of the movement pattern of the sonic vibration module match the start and end times of the synchronization waveform, or such a matching time point may be delayed in time. In this case, a possibility that the start and end times of the movement pattern of the sonic vibration module and the start and the end times of the vibration pattern of the sonic vibration massage may at least partially match each other may decrease. Accordingly, a possibility that the user feels a sense of difference due to stimulation and a sonic vibration massage being simultaneously provided according to movement of the sonic vibration module may increase. Therefore, the massage device may adjust a frequency (or a cycle) of the synchronization waveform such that the start and end times of the movement pattern of the sonic vibration module and the start and the end times of the vibration pattern of the sonic vibration massage may at least partially match each other.

In addition, the above examples may be applied to a case in which a synchronization pattern is any one of various waveforms such as a quadrangular waveform, a triangular waveform, a sawtooth waveform, and a complex waveform.

3.2.4.1.3. Movement Cycle of Sonic Vibration Module and Sound Source Waveform

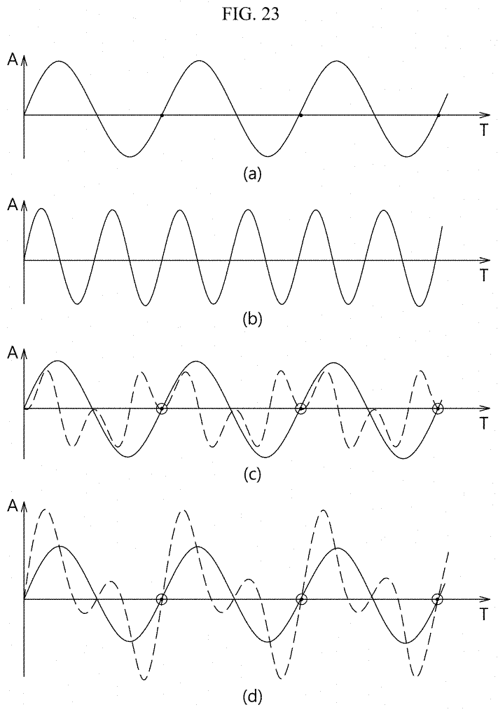

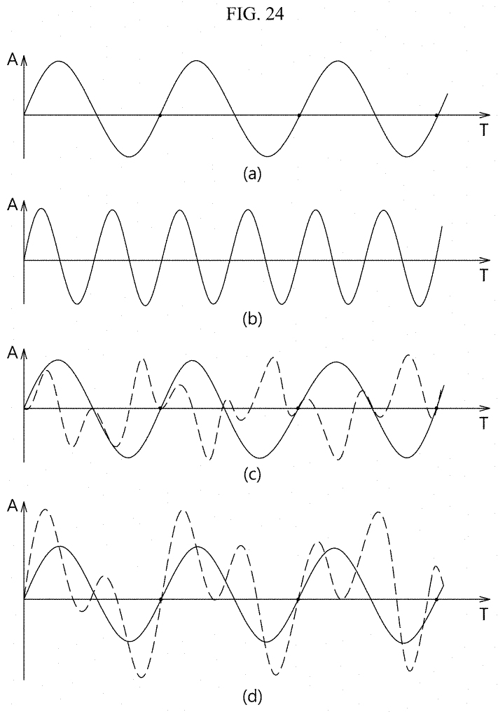

FIGS. 23 and 24 show graphs for describing a cycle of a sound source waveform according to a vibration frequency of a vibration waveform according to one embodiment.

Referring to FIGS. 23 and 24, FIGS. 23A and 24A show a synchronization waveform, FIGS. 23B and 24B show a vibration waveform, FIGS. 23C and 24C show a sound source waveform obtained by multiplying a synchronization waveform and a vibration waveform, and a synchronization waveform, and FIGS. 23D and 24D show a sound source waveform obtained by combining a synchronization waveform and a vibration waveform, and a synchronization waveform. In FIGS. 23C, 23D, 24C, and 24D, a first sound source waveform and a second sound source waveform may be indicated by a dotted line, and the synchronization waveform may be indicated by a solid line. In addition, FIGS. 23A, 23D, 24A, and 24D, an x-axis may represent a time, and a y-axis may represent an amplitude.

In one embodiment, in order to provide a vibration massage to a user without a sense of difference, a movement pattern of a sonic vibration module may be synchronized with a sound source waveform. This is because the sonic vibration module may provide a sonic vibration massage based on the sound source waveform.

Even when the movement pattern of the sonic vibration module is synchronized with the synchronization waveform, the movement pattern of the sonic vibration module may not be necessarily synchronized with the sound source waveform. This is because, due to a combination of the synchronization waveform and the vibration waveform, the synchronization waveform and the sound source waveform may be synchronized with each other but may not be synchronized with each other. Assuming that the synchronization waveform is synchronized with the movement pattern of the sonic vibration module, a waveform and/or a vibration frequency of the vibration waveform may affect the synchronization between the movement pattern of the sonic vibration module and the sound source waveform. This will be described in detail below. However, for convenience of description, on the assumption that the waveform of the vibration waveform is a sine wave, the synchronization between the movement pattern of the sonic vibration module and the sound source waveform according to a frequency change of the vibration waveform will be described.

In one embodiment, a synchronization cycle of the synchronization waveform may be n times or 1/n times a vibration cycle of the vibration waveform (here, n is a natural number). This is because, when the synchronization cycle of the synchronization waveform is n times or 1/n times the vibration cycle of the vibration waveform, the synchronization waveform or the movement pattern of the sonic vibration module and the sound source waveform may be more likely to be synchronized with each other.

Of course, in the case of sonic vibration, since a synchronization cycle may be longer than a vibration cycle, an embodiment in which the synchronization cycle is 1/n times the vibration cycle may be a main embodiment.

Specifically, FIG. 23A shows a first synchronization waveform, and FIG. 24A shows a second synchronization waveform. In this case, the first synchronization waveform and the second synchronization waveform may be the same waveform, and a waveform of the first and second synchronization waveforms may be a sine wave. The first and second synchronization waveform may have a frequency of 50 Hz and a cycle of 0.02 seconds. In addition, FIG. 23B shows a first vibration waveform, and FIG. 24B shows a second vibration waveform. In this case, a waveform of the first vibration waveform and the second vibration waveform may be a sine wave. The first vibration waveform may have a frequency of 100 Hz and a cycle of 0.01 seconds, and the second vibration waveform have a frequency 107 Hz and a cycle of 1/107 seconds. That is, the cycle of the first vibration waveform may be 1/n times the cycle of the first synchronization waveform, but the cycle of the second vibration waveform may not be 1/n times the cycle of the second synchronization waveform.

FIG. 23C shows a first sound source waveform obtained by multiplying the first synchronization waveform and the first vibration waveform, and the first synchronization waveform. In addition, FIG. 23D shows a second sound source waveform obtained by combining the first synchronization waveform and the first vibration waveform, and the first synchronization waveform. In this case, since the cycle of the first synchronization waveform and the cycle of the first vibration waveform have a relationship of 1/n times, a cycle of the first sound source waveform and a cycle of the second sound source waveform may be different according to waveforms, but in the embodiment of FIG. 23, the cycle of the first sound source waveform and the cycle of the second sound source waveform may be the least common multiple of the cycle of the first synchronization waveform and the cycle of the first vibration waveform, that is, 0.02 seconds that is the same as the cycle of the first synchronization waveform. Since the cycle of the first sound source waveform and the second sound source waveform is the same as the cycle of the first synchronization waveform, when a massage device provides a sonic vibration massage based on the first sound source waveform or the second sound source waveform, the massage device may at least partially match start and end times of the movement pattern of the sonic vibration module with start and end times of a vibration pattern of the sonic vibration massage within a certain cycle (or a certain time), thereby a comfortable massage, in which a sense of difference is minimized, to a user.

On the other hand, FIG. 24C shows a third sound source waveform obtained by multiplying a second synchronization waveform and a second vibration waveform, and the second synchronization waveform. In addition, FIG. 23D shows a fourth sound source waveform obtained by combining the second synchronization waveform and the second vibration waveform, and the second synchronization waveform. In this case, since a cycle of the second synchronization waveform and a cycle of the second vibration waveform do not have a relationship of 1/n times or n times, a cycle of the third sound source waveform and a cycle of the fourth sound source waveform may not match the cycle of the first synchronization waveform.

The massage device does not continuously match the start and end times of the movement pattern of the sonic vibration module with the start and end times of the vibration pattern of the sonic vibration massage within a certain cycle (or a certain time). Thus, movement of the sonic vibration module may not be synchronized with the sonic vibration massage, and accordingly, a possibility that the user feels a sense of difference due to stimulation and thee sonic vibration massage being simultaneously provided according to the movement of the sonic vibration module may increase. Accordingly, the massage device may adjust a frequency (or a cycle) of the synchronization waveform and a frequency (or a cycle) of the vibration waveform such that the cycle of the synchronization waveform and the cycle of the vibration waveform have a relationship of 1/n times or n times.

In addition, in one embodiment, even when a synchronization cycle of the synchronization waveform and a vibration cycle of the vibration waveform do not have a relationship of n times or 1/n times, a difference value between the synchronization cycle and the least common multiple of the synchronization cycle and the vibration cycle may be a certain value or less. A time point at which the synchronization cycle and the vibration cycle have the least common multiple may be a time point at which an end time of the synchronization waveform matches an end time of the sound source waveform, and this is because, when a difference between the synchronization cycle and the least common multiple of the synchronization cycle and the vibration cycle is not large, it is highly likely that the user does not feel a sense of difference.

FIG. 25 shows graphs for describing a cycle of a sound source waveform according to a vibration frequency of a vibration waveform according to another embodiment.

Referring to FIG. 25, FIG. 25A shows a first synchronization waveform. A waveform of the first synchronization waveform may be a sine wave, and the first synchronization waveform may have a frequency of 50 Hz and a cycle of 0.02 seconds. In addition, FIG. 25B shows a first vibration waveform. A waveform of the first vibration waveform may be a sine wave, and the first vibration waveform may have a frequency of 75 Hz and a cycle of 1/75 seconds. In addition, FIG. 25C shows a first sound source waveform obtained by multiplying the first synchronization waveform and the first vibration waveform, and the first synchronization waveform, and FIG. 25D shows a second sound source waveform obtained by combining the first synchronization waveform and the first vibration waveform, and the first synchronization waveform. In FIGS. 25C and 25D, the first sound source waveform and the second sound source waveform may be indicated by a dotted line, and the first synchronization waveform may be indicated by a solid line.

In the embodiment of FIG. 25, the cycle of the first synchronization waveform and the cycle of the first vibration waveform may not have a relationship of n times or 1/n times (here, n is a natural number). Accordingly, a cycle of the first and second sound source waveforms may not match the cycle of the first synchronization frequency. However, the cycle of the first and second sound source waveforms may be 1/25 seconds that is the least common multiple of the cycle of the first synchronization waveform and the cycle of the first vibration waveform and may be twice 1/50 seconds that is the cycle of the first synchronization waveform. That is, when the first synchronization frequency is repeated twice, an end time of the first synchronization waveform may match an end time of the first and second sound source waveforms. As described above, when a synchronization frequency is repeated within a preset number of times (twice in the embodiment of FIG. 25), and when a synchronization waveform matches with a sound source waveform, that is, when a difference value between a cycle of the synchronization waveform and the least common multiple of the cycle of the synchronization waveform and a cycle of a vibration waveform is a certain value or less (cycle of the synchronization waveform in the embodiment of FIG. 25), a user may not feel a sense of difference with respect to a sonic vibration massage. Accordingly, a massage device may adjust a frequency (or a cycle) of the synchronization waveform and a frequency (or a cycle) of the vibration waveform such that a difference value between a synchronization cycle and the least common multiple of the cycle of the synchronization waveform and the cycle of the vibration waveform is a certain value or less.

When an intensity with which the user is stimulated by movement of a sonic vibration module is high, the user may feel a natural massage when a sonic vibration massage having a strong intensity is provided. On the contrary, when an intensity with which the user is stimulated by movement of the sonic vibration module is low, the user may feel relatively a lot of sense of difference when a sonic vibration massage having a strong intensity is provided. Accordingly, the massage device may control the sonic vibration module to provide a sonic vibration massage having a strong intensity to the user when an intensity with which the user is stimulated by movement of the sonic vibration module is high and to provide a sonic vibration massage having a weak intensity to the user when an intensity with which the user is stimulated by movement of the sonic vibration module is low.

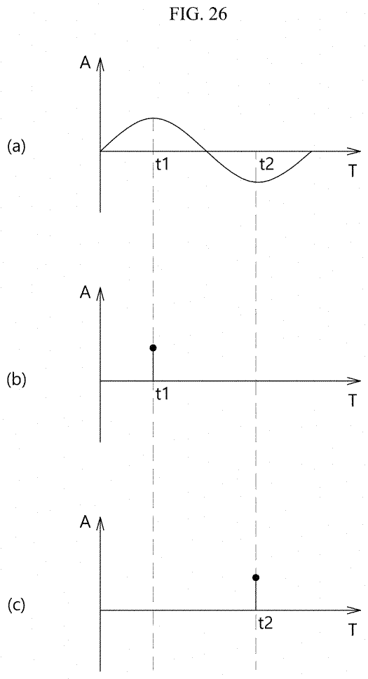

FIG. 26 shows graphs for describing a relationship between a synchronization waveform and a sound source waveform according to one embodiment.

Referring to FIG. 26, FIG. 26A shows the synchronization waveform, FIG. 26B shows a time point at which a maximum value appears in a first sound source waveform, and FIG. 26C shows a time point at which a maximum value appears in a second sound source waveform. In FIGS. 26A to 26C, an x-axis may represent a time, and a y-axis may represent an amplitude. Here, the time point at which the maximum value appears in the sound source waveform may correspond to a time point at which a sonic vibration massage having the strongest intensity is provided.

In one embodiment, the time point at which the maximum value appears in the sound source waveform may vary according to a vibration frequency of a vibration waveform, that is, a cycle of the vibration waveform.

For example, when a sonic vibration massage is provided using the first sound source waveform, as shown in FIG. 26B, a sonic vibration massage having the strongest intensity may be provided at a time point tl at which an intensity with which a user is stimulated by movement of a sonic vibration module is the highest. On the other hand, when a sonic vibration massage is provided using the second sound source waveform, as shown in FIG. 26C, a sonic vibration massage having the strongest intensity may be provided at a time point t2 at which an intensity with which the user is stimulated by movement of the sonic vibration module is the lowest. In this case, the sonic vibration module weakly presses the user, but an intensity of the sonic vibration massage is the highest. Thus, the user may feel a sense of difference due to stimulation and the sonic vibration massage being simultaneously provided according to movement of the sonic vibration module.

In order to reduce such a sense of difference, a massage device may adjust a frequency (or a cycle) of a synchronization waveform and a frequency (or a cycle) of a vibration waveform such that a sonic vibration massage having the strongest intensity is provided at a time point at which an intensity with which the user is stimulated by movement of the sonic vibration module is the highest.

In addition, in one embodiment, when a sonic vibration massage having the strongest intensity is not provided at a time point at which an intensity with which the user is stimulated by movement of the sonic vibration module is the lowest, that is, when the sonic vibration massage having the strongest intensity is provided at a different time point rather than the time point at which the intensity with which the user is stimulated by movement of the sonic vibration module is the lowest, the use may feel less sense of difference. Therefore, the massage device may adjust a frequency (or cycle) of a synchronization waveform and a frequency (or cycle) of a vibration waveform such that a sonic vibration massage having the strongest intensity is provided at a time point at which an intensity with which the user is stimulated by movement of the sonic vibration module is the lowest.

3.2.4.1.4. Movement Speed of Sonic Vibration Module and Sonic Vibration Massage

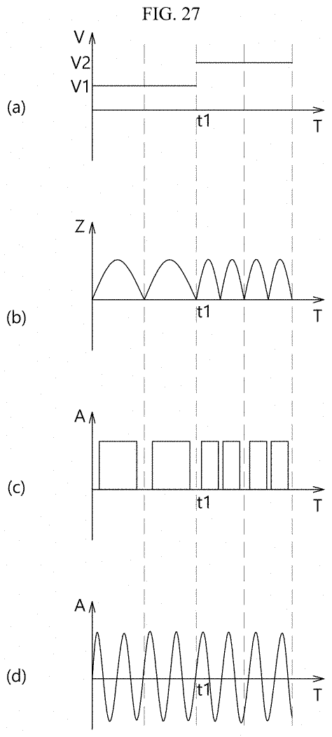

FIG. 27 shows graphs for describing a relationship between a movement speed of a sonic vibration module and a sound source signal according to one embodiment.

Referring to FIG. 27, FIG. 27A shows the movement speed of the sonic vibration module, FIG. 27B shows a movement route of the sonic vibration module, FIG. 27C shows a synchronization waveform of the sound source signal, and FIG. 27D shows a vibration waveform of the sound source signal. In FIG. 27A, an x-axis may represent a time, and a y-axis may represent a speed. In FIG. 27B, an x-axis may represent a time, and a y-axis may represent a position of the sonic vibration module on a z-axis. In FIGS. 27C and 27D, an x-axis may represent a time, and a y-axis may represent an amplitude of the sonic vibration module.

In the example of FIG. 27, as shown in FIG. 27A, the movement speed of the sonic vibration module may be doubled from a time point tl. That is, as shown in FIG. 27B, when the movement speed of the sonic vibration module is V2, the sonic vibration module may reciprocate one more time along the z-axis than when the movement speed of the sonic vibration module is V1. Accordingly, for synchronization with the movement route of the sonic vibration module, a frequency of the synchronization waveform of the sound source signal may be doubled from the time point t1. That is, a cycle of the synchronization waveform of the sound source signal may be decreased to ½. However, a frequency of the vibration waveform of the sound source signal may be maintained. This is because, even when the movement speed of the sonic vibration module is changed, a sonic vibration massage may be provided with the same vibration frequency to reduce a user's sense of difference. Of course, the present invention is not limited thereto, and according to embodiments, at least one of the frequency of the synchronization waveform and the frequency of the vibration waveform may be changed as the movement speed of the sonic vibration module may be changed. In addition, according to embodiments, as the movement speed of the sonic vibration module is changed, at least one of an amplitude of the synchronization waveform and/or an amplitude of the vibration waveform may be changed.

3.2.4.1.5. Stimulation Intensity of Sonic Vibration Module and Sonic Vibration Massage

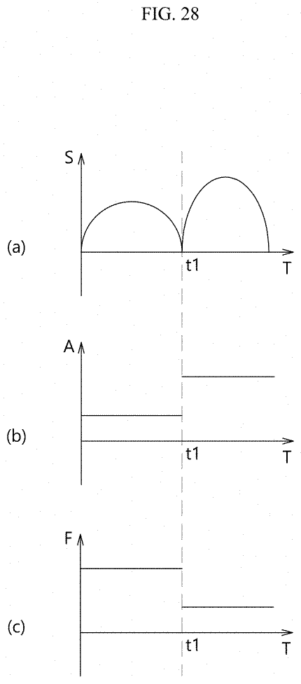

FIG. 28 shows graphs illustrating a relationship between a stimulation intensity of a sonic vibration module and a sonic vibration massage according to one embodiment.

Referring to FIG. 28, FIG. 28A shows the stimulation intensity of the sonic vibration module, FIG. 28B shows an amplitude of the sonic vibration massage, and FIG. 28C shows a frequency of the sonic vibration massage. In FIG. 28A, an x-axis may represent a time, and a y-axis may represent a speed. In FIG. 28B, an x-axis may represent a time, and a y-axis may represent the amplitude of the sonic vibration massage. In FIG. 28C, an x-axis may represent a time, and a y-axis may represent the frequency of the sonic vibration massage.

In one embodiment, a massage device may provide a motion massage to a user through movement of the sonic vibration module. In this case, a degree of stimulation provided to the user may vary according to a movement position of the sonic vibration module. For example, as shown in FIG. 28A, the sonic vibration module may move to provide a motion massage at a high intensity from a time point tl. In this case, the massage device may adjust an intensity of the sonic vibration massage in response to an intensity of the motion massage by the sonic vibration module. Accordingly, the intensity of the motion massage is synchronized with the intensity of the sonic vibration massage with respect to the user, thereby reducing a user's sense of difference and increasing massage satisfaction.

For example, as shown in FIG. 28B, the massage device may increase the intensity of the sonic vibration massage while increasing an amplitude of sonic vibration from the time point t1. In addition, as shown in FIG. 28C, the massage device may increase the intensity of the sonic vibration massage while increasing a frequency of the sonic vibration from the time point tl.

In addition, the stimulus intensity of the sonic vibration module of FIG. 28A may be substituted with a stimulus intensity of other applications other than the sonic vibration module. For example, when the massage device provides a motion massage and a sonic vibration massage at the same time, the massage device may adjust an intensity of the sonic vibration massage in response to an intensity of the motion massage by a motion massage member. As another example, when the massage device provides an air massage or thermal massage and a sonic vibration massage at the same time, the massage device may adjust an intensity of the sonic vibration massage in response to an intensity of the air massage by an air massage member or the thermal massage by a thermal massage member.

Of course, the present invention is not limited thereto, and according to embodiments, irrespective of the intensity of the motion massage, the intensity of the air massage, or the intensity of the thermal massage, the massage device may set the intensity of the sonic vibration massage and adjust the intensity of the sonic vibration massage to be inversely proportion to the intensity of the motion massage, the intensity of the air massage, or the intensity of the thermal massage.

3.3. Multimodal Massage

3.3.1. Performance of Vibration Massage according to Other Massage Operations

In one embodiment, a massage device may perform a vibration massage in response to an operation of other massages other than the vibration massage. Specifically, the massage device may provide not only one type of massage but also a plurality of types of massages at the same time. Here, various types of massages provided at the same time may be defined as a multimodal massage.

In this case, when the vibration massage and other massages are performed independently, a user may feel a sense of difference due to a plurality of types of massages being provided. In order for the user to more comfortably receive a massage, the massage device may provide the multimodal massage by synchronizing the vibration massage with other massages. Hereinafter, more detailed descriptions will be provided.

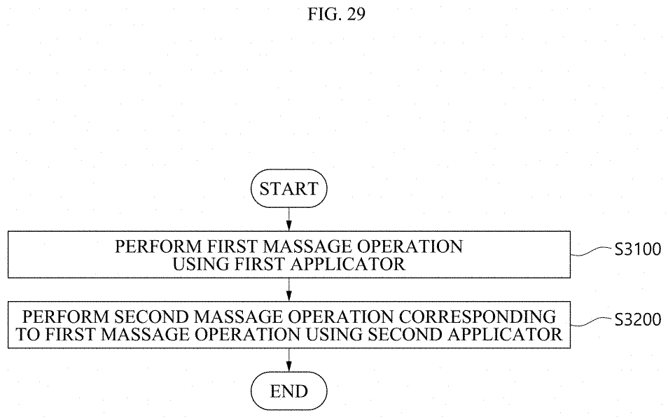

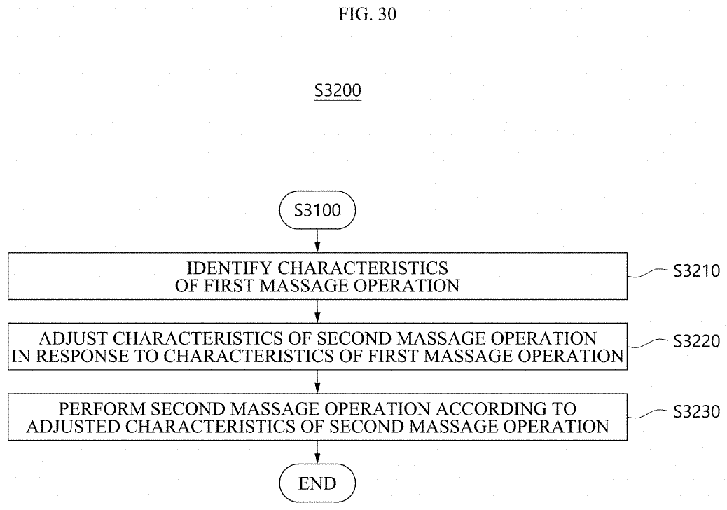

For convenience of description, the multimodal massage will be described below based on a sonic vibration massage. However, the present invention is not limited thereto, and of course, the technical matters described below may be applied to other vibration massages other than the sonic vibration massage. FIGS. 29 and 30 are operation flowcharts of a control method of a massage device for performing a multimodal massage according to one embodiment.

Referring to FIG. 29, in one embodiment, the control method of the massage device may include performing a first massage operation using a first applicator (S3100) and performing a second massage operation corresponding to the first massage operation using a second applicator (S3200).

Specifically, in operation S3100, the first applicator may include various massage members such as the above-described motion massage member, air massage member, and thermal massage member. In addition, a first massage may be a massage corresponding to the first applicator. For example, when the first applicator is the motion massage member, the first massage may be a motion massage.

In addition, in operation S3200, the second applicator may be a vibration massage member. For convenience of description, a sonic vibration massage member among vibration massage members will be specifically described as the second applicator. The massage device may perform a sonic vibration massage using the sonic vibration massage member. In this case, the massage device may provide a second massage, that is, the sonic vibration massage, in synchronization with the first massage operation.

More specifically, referring to FIG. 30, in operation S3200, the control method of the massage device may include identifying the characteristics of the first massage operation (S3210), adjusting the characteristics of the second massage operation in response to the characteristics of the first massage operation (S3220), and performing the second massage operation according to the adjusted characteristics of the second massage operation (S3230).

Here, the characteristics of a massage operation may include various parameters capable of representing the massage operation, such as a type of a massage, a speed of the massage, an intensity of the massage, a movement pattern of the applicator, and a movement speed of the applicator.

In operation S3210, the massage device may identify the characteristics of the first massage operation. For example, when the first massage is a motion massage, the massage device may identify a type of the motion massage (for example, a tapping massage, a kneading massage, or the like), a speed of the motion massage, an intensity of the motion massage, a movement pattern or a movement speed of a motion massage member, or the like.

In one embodiment, when the first massage is performed according to a preset program, the massage device may identify the characteristics of the first massage operation from the preset program. In another embodiment, the massage device may analyze operation characteristics of the first applicator in real time using various sensors included in the massage device.

In addition, in operation S3220, the massage device may adjust the characteristics of the second massage operation in order to synchronize the second massage operation with the first massage operation. For example, when the second massage is a sonic vibration massage and the first massage is a motion massage, the massage device may adjust a frequency or amplitude of the sonic vibration massage or a movement pattern or movement speed of a sonic vibration module according to the characteristics of a motion massage operation. An example, the massage device may select a sound source signal corresponding to the characteristics of the first massage operation from among a plurality of sound source signals and may adjust an amplitude of the sound source signal to adjust the characteristics of the sonic vibration massage. As another example, the massage device may adjust a frequency and amplitude of the sound source signal in real time to adjust the characteristics of the sonic vibration massage. As still another example, the massage device may adjust the characteristics of the sonic vibration massage by changing a direction of a current applied to the sonic vibration module, adjusting an intensity of the current, changing a direction of a voltage, and adjusting a magnitude of the voltage.

In addition, in one embodiment, the massage device may adjust the characteristics of the second massage operation according to a second massage operation program stored in the preset program and may adjust operation characteristics of the first massage operation according to a first massage operation program stored in the preset program. In addition, the massage device may adjust the characteristics of the second massage operation in response to the characteristics of the first massage operation analyzed in real time.

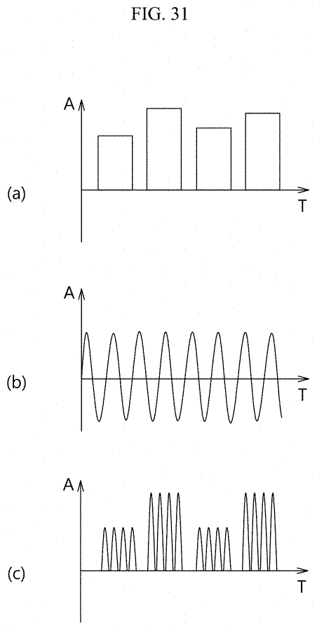

The adjustment of the characteristics of the second massage operation will be described in more detail with reference to FIGS. 31 to 42 below.

Thereafter, the massage device may perform the second massage operation according to the adjusted characteristics of the second massage operation according to operation S3230.

3.3.2. Characteristics of Sound Source Signal according to Other Massage Operations

In one embodiment, as described above, the characteristics of a sonic vibration massage may be adjusted according to other massage operations other than the sonic vibration massage. This may be to reduce a user's sense of difference, which may be generated due to a plurality of types of massages being simultaneously provided, and to provide a comfortable massage.

In this case, operation characteristics of the sonic vibration massage may be determined based on a sound source signal. That is, operation characteristics of the other massages are synchronized with the sound source signal, thereby providing a multimodal massage in which different massages are synchronized with each other.

In one embodiment, as described with reference to FIG. 22, start and end times of a movement pattern of a sonic vibration module may at least partially match start and end times of a vibration pattern of the sonic vibration massage so that a comfortable massage may be provided to a user. To this end, a cycle of a synchronization waveform of the sound source signal may be n times or 1/n times a movement cycle of the sonic vibration module.

This may also be applied to the operation characteristics of other massages other than a vibration massage. For example, a movement cycle of the sonic vibration module of FIG. 22A may be substituted with a movement cycle of a motion massage. The motion massage may be provided to the user according to a movement cycle of a motion massage member, and accordingly, when start and end times of a movement pattern of the motion massage member at least partially match the start and end times of the vibration pattern of the sonic vibration massage, a comfortable massage may be provided to the user. When a cycle of the synchronization waveform of the sound source signal is n times or 1/n times the movement cycle of the motion massage member, the start and end times of the movement pattern of the motion massage member may at least partially match the start and end times of the vibration pattern of the sonic vibration massage.

In addition, according to embodiments, the sonic vibration module and other massage members may move by being interlocked with each other. In this case, movement of the sonic vibration module may be determined by movement of the other massage members, that is, by other massage operations. In this case, a relationship between the movement cycle of the sonic vibration module and the synchronization waveform of the sound source signal may also be applied to a relationship between a movement cycle of other massage members and the synchronization waveform of the sound source signal.

Hereinafter, for more detailed descriptions, a relationship between various operations of a motion massage and a sonic vibration massage will be described.

3.3.3. Vibration Massage Operation according to Tapping Massage Operation

In one embodiment, when a tapping massage is performed using a motion massage member, a massage device may provide a sonic vibration massage in response to the characteristics of the tapping massage. To this end, the massage device may perform the sonic vibration massage using a sound source signal corresponding to the characteristics of the tapping massage. Hereinafter, the sound source signal corresponding to the characteristics of the tapping massage will be described.

FIG. 31 shows graphs for describing a sound source signal corresponding to a tapping massage according to one embodiment.

Referring to FIG. 31, FIG. 31A shows a synchronization waveform of the sound source signal, FIG. 31B shows a vibration waveform of the sound source signal, and FIG. 31C shows a sound source waveform based on the synchronization waveform and the vibration waveform. In addition, in FIGS. 3A to 31C, an x-axis may represent a time, and a y-axis may represent an amplitude.

In one embodiment, when a motion massage member performs the tapping massage, the motion massage member may perform a reciprocating motion in a z-axis direction. That is, when a movement length of the motion massage member along a z-axis is long, that is, when the motion massage member moves forward along the z-axis, the motion massage member may come into strong contact with a user, and when the movement length along the z-axis is short, that is, when a massage device moves backward along the z-axis, the motion massage member may come into weak contact with the user or may not come into contact with the user.

The massage device may synchronize an intensity of a sonic vibration massage in synchronization with a time when the motion massage member moves along the z-axis.

In one embodiment, the massage device may increase the intensity of the sonic vibration massage when the movement length of the motion massage member along the z-axis is long and may decrease the intensity of the sonic vibration massage when the movement length of the motion massage member along the z-axis is short. This may be to increase an effect of the tapping massage by providing the sonic vibration massage at the same intensity and the same time as the tapping massage.

In FIG. 31A, the synchronization waveform may be a quadrangular waveform. In addition, waveforms having different amplitudes may appear alternately. This may be to alternately control the intensity of the sonic vibration massage in order to provide the sonic vibration massage in synchronization with the tapping massage. In the example of FIG. 31A, respective waveforms are illustrated as having one amplitude for convenience of description, but the respective waveforms may have a plurality of amplitudes. In this case, representative amplitudes of the respective waveforms may be different. Here, the representative amplitude may be an amplitude capable of representing the plurality of amplitudes included in the respective waveforms, such as an average value, a mode value, a maximum value, and the like of the plurality of amplitudes included in the respective waveforms. A concept of the representative amplitude may be applied not only to the description of FIG. 31 but also to the entire present specification.

In one embodiment, the massage device may control a high-amplitude waveform to be positioned at a time point at which the movement length of the motion massage member movement along the z-axis is long and may control a short-amplitude waveform to be positioned at a time point at which the movement length of the motion massage member movement along the z-axis is short. Of course, the present invention is not limited thereto, the massage device may control a high-amplitude waveform to be positioned at a time point at which the movement length of the motion massage member movement along the z-axis is short and may control a short-amplitude waveform to be positioned at a time point at which the movement length of the motion massage member movement along the z-axis is long.

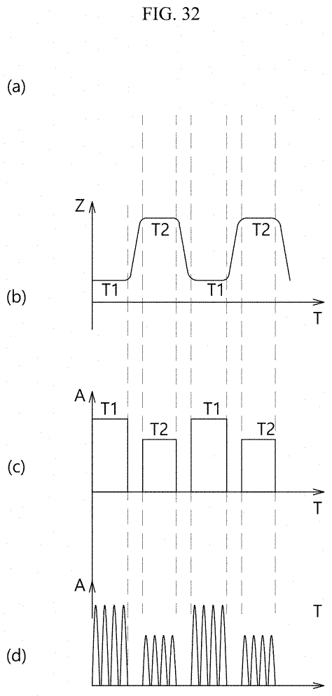

As shown in FIG. 32B, the vibration waveform of the sound source signal may have a constant frequency irrespective of a position of the motion massage member. In the example of FIG. 31B, the vibration waveform may be a sine waveform. Of course, the present invention is not limited thereto, and the vibration waveform may be various waveforms other than the sine waveform.

When the synchronization waveform of FIG. 31A and the vibration waveform of FIG. 31B are combined, as shown in FIG. 31C, magnitudes of amplitudes of the sound source signal may be the same, and a vibration frequency may be the same for each waveform. The massage device may perform a sonic vibration massage synchronized with a motion massage operation based on the sound source signal of FIG. 31C.

Furthermore, in another embodiment, the massage device may perform a sonic vibration massage synchronized with a motion massage operation based on a sound source signal in which detailed waveforms included in a sound source waveform has the same amplitude and different vibration frequencies. In this case, the massage device may control a low-vibration frequency waveform to be positioned at a time point at which the movement length of the motion massage member movement along the z-axis is long and may control a high-vibration frequency waveform to be positioned at a time point at which the movement length of the motion massage member movement along the z-axis is short. Of course, the present invention is not limited thereto, the massage device may control a high-vibration frequency waveform to be positioned at a time point at which the movement length of the motion massage member movement along the z-axis is long and may control a low-vibration frequency waveform to be positioned at a time point at which the movement length of the motion massage member movement along the z-axis is short. Accordingly, the massage device provides a sonic vibration massage having an intensity corresponding to the movement length of the motion massage member along the z-axis, thereby improving an effect of the tapping massage. In addition, in the above example, although it has been described that the detailed waveforms have one frequency, the respective waveforms may have a plurality of frequencies. In this case, representative frequencies of the respective waveforms may be different. Here, the representative frequency may be a frequency capable of representing the plurality of frequencies included in the respective waveforms, such as an average value, a mode value, a maximum value, and the like of the plurality of frequencies included in the respective waveforms. A concept of the representative frequency may be applied not only to the description of FIG. 31 but also to the entire present specification.

FIG. 32 shows diagrams for describing a sound source signal according to a tapping massage according to another embodiment.

Referring to FIG. 32, FIG. 32A is a diagram for describing a positional relationship between a motion massage member and a sonic vibration module according to the tapping massage, and FIG. 32B is a diagram showing a position of the motion massage member on a z-axis according to the tapping massage. FIG. 32C shows a synchronization waveform of the sonic vibration module according to the tapping massage, and FIG. 32D is a diagram showing a sound source waveform of the sonic vibration module according to the tapping massage. In FIG. 32B, an x-axis may represent a time, and a y-axis may represent a position on the z-axis. In FIGS. 32C and 32D, an x-axis may represent a time, and ay-axis may represent an amplitude.

As shown in FIG. 32A, the motion massage member and the sonic vibration module may be connected through a connection part. For example, the motion massage member may be positioned at an upper side of the connection part, and the sonic vibration module may be positioned at a lower side of the connection part.

As shown in FIGS. 32A and 32B, the massage member may move long along the z-axis during a time period T2 to come into strong contact with a user. In this case, the sonic vibration module connected to the connection part may move relatively short along the z-axis as compared with the motion massage member during the time period T2, and accordingly, the sonic vibration module may come into weak contact with the user or may not come into contact with the user. In addition, after the motion massage member moves long along the z-axis, the motion massage member may move short along the z-axis during the time period T1 to come into weak contact with the user or to not come into contact with the user. In this case, the sonic vibration module may move relatively long in the z-axis as compared with the motion massage member during the time period T1, and accordingly, the sonic vibration module may come into strong contact with the user.

When a tapping massage operation is performed, a massage device may provide a sonic vibration massage synchronized with positions of the motion massage member and the sonic vibration module. To this end, the massage device may perform the sonic vibration massage using the sound source signal corresponding to the tapping operation.

Specifically, when the tapping massage operation is performed, a synchronization waveform of the sound source signal may have a form in which first synchronization waveforms having a small amplitude and second synchronization waveforms having a large amplitude alternate as shown in FIG. 32C. In this case, during the time period T2 that is a time period in which the motion massage member comes into stronger contact with the user than the sonic vibration module, the first synchronization waveform with a small amplitude may appear, and during the time period T1 that is a time period in which the motion massage member comes into weaker contact with the user than the sonic vibration module, the second synchronization waveform having a large amplitude may appear. Accordingly, as shown in FIG. 32D, a first sound source waveform having a small amplitude may appear during the time period T2, and a second sound source waveform having a large amplitude may appear during the time period T1.

When the massage device performs a sonic vibration massage according to the sound source signal, and when the motion massage member comes into strong contact with the user, and the sonic vibration module comes into weak contact with the user, a sonic vibration massage having a weak intensity may be performed. In addition, when the motion massage member comes into weak contact with the user, and the sonic vibration module comes into strong contact with the user, a sonic vibration massage having a strong intensity may be performed. As described above, since the motion massage member provides a motion massage having a strong intensity and then provides a sonic vibration massage having a strong intensity, it is possible to continuously provide a massage having a strong intensity to the user. In addition, since a sonic vibration massage having a strong intensity is provided when the sonic vibration module comes into strong contact with the user, and a sonic vibration massage having a weak strength is provided when the sonic vibration module comes into weak contact with the user, it is possible to improve the efficiency of the sonic vibration massage.

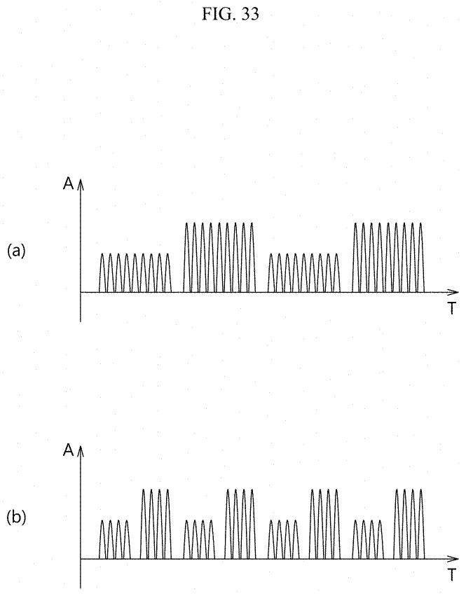

FIG. 33 shows graphs for describing a sound source signal according to a tapping massage according to still another embodiment.

Referring to FIG. 33, FIGS. 33A and 33B show the sound source signal applied to a sonic vibration module when the tapping massage is provided. In FIGS. 33A and 33B, an x-axis may represent a time, and a y-axis may represent an amplitude.

In one embodiment, a speed of the tapping massage may be various. For example, a massage device may perform the tapping massage at a first speed and may perform the tapping massage at a second speed that is faster than the first speed. In this case, a movement speed of a motion massage member and a movement time of a sonic vibration module may changed according to the speed of the tapping massage, and accordingly, a sound source waveform may also vary.

For example, when the speed of the tapping massage is the relatively slow first speed, the sound source waveform may appear in a form in which first waveforms having a relatively low amplitude and second waveforms having a relatively high amplitude alternate as shown in FIG. 33A. When the speed of the tapping massage is the second speed that is faster than the first speed, the sound source waveform may appear in a form in which third waveforms having a relatively low amplitude and fourth waveforms having a relatively high amplitude alternate as shown in FIG. 33B. In this case, the number of the third waveforms and the fourth waveforms may be greater than the number of the first waveforms and the second waveforms. This may be due to the number of times, in which the motion massage member and the sonic vibration module come into strong contact with a user, increasing as the speed of the tapping massage increases. In addition, a length of the third and fourth waveforms (that is, a duration of each waveform) may be shorter than that of the first and second waveforms. This may be due to a decrease in a contact time when the motion massage member and the sonic vibration module come into contact with the user once.

However, in this case, vibration frequencies of the first to fourth waveforms may all be the same. This is because, even when the speed of the tapping massage is changed, a sonic vibration massage may be provided at the same vibration frequency to reduce a user's sense of difference. Of course, the present invention is not limited thereto, and according to embodiments, the vibration frequency may be changed when the speed of the tapping massage is changed.

3.3.4. Vibration Massage Operation according to Acupressure Massage Operation

In one embodiment, when an acupressure massage is performed using a motion massage member, a massage device may provide a sonic vibration massage in response to the characteristics of the acupressure massage. To this end, the massage device may perform the sonic vibration massage using a sound source signal corresponding to the characteristics of the acupressure massage. Hereinafter, the sound source signal corresponding to the characteristics of the acupressure massage will be described.

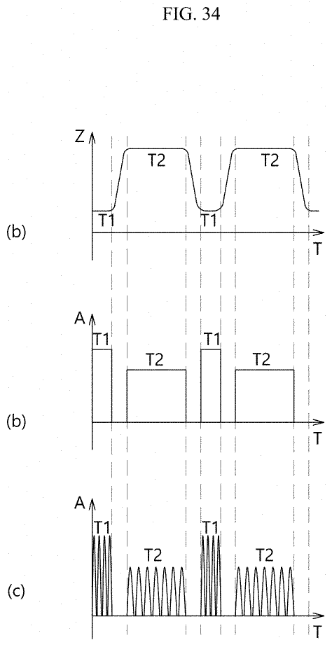

FIG. 34 shows graphs for describing a sound source signal corresponding to an acupressure massage according to one embodiment.

Referring to FIG. 34, FIG. 34A is a diagram showing a position of a motion massage member on a z-axis according to the acupressure massage, FIG. 34B shows a synchronization waveform of a sonic vibration module according to the acupressure massage, FIG. 34C is a diagram showing a sound source waveform of the sonic vibration module according to the acupressure massage. In FIG. 34A, an x-axis may represent a time, and ay-axis may represent a position on the z-axis. In FIGS. 34B and 34C, an x-axis may represent a time, and a y-axis may represent an amplitude.

As described above, the acupressure massage may be a massage in which a kneading massage is performed when an applicator moves forward in a z-axis direction while a tapping massage is slowly performed to perform a massage while continuously pressing a user. Accordingly, when the acupressure massage is performed, after the motion massage member maintains a state of moving forward in the z-axis direction as shown in FIG. 34A for a time period T2 that is a relatively long time period, the motion massage member may move in an x-axis direction and/or a y-direction to perform the acupressure massage.

In this case, when the motion massage member may be positioned at an upper side of a connection part, and the sonic vibration module may be positioned at a lower side of the connection part, the sonic vibration module may be in a state of moving backward in the z-axis direction during the time period T2.

In addition, after the time period T2 ends, the motion massage member may maintain a state of moving backward in the z-axis direction for a relatively short time period T1. In this case, the sonic vibration module may be in a state of moving forward in the z-axis direction during the time period T1.

In one embodiment, when an acupressure massage operation is performed, a massage device may provide a sonic vibration massage synchronized with positions of the motion massage member and the sonic vibration module. To this end, the massage device may perform the sonic vibration massage using the sound source signal corresponding to the acupressure massage operation.

Specifically, a synchronization waveform of the sound source signal may have a form in which first synchronization waveforms having a small amplitude and second synchronization waveforms having a large amplitude alternate as shown in FIG. 34B. In this case, as compared with a tapping massage, when the acupressure massage is performed, a time for which the motion massage member is in strong contact with the user and a time for which the sonic vibration module is in weak contact with the user or is not in contact with the user may be increased. Accordingly, the second synchronization waveform having a small amplitude may appear during the time period T2, and the first synchronization waveform having a high amplitude may appear during the time period T1. In addition, as shown in FIG. 34C, even in the sound source waveform, a first sound source waveform having a small amplitude may appear during the time period T2, and a second sound source waveform having a large amplitude may appear during the time period T1. In this case, since the time period T2 is longer than the time period T1, a length of the second synchronization waveform may be longer than a length of the first synchronization waveform.

As described above, when the motion massage member performs the acupressure massage at a strong intensity, a sonic vibration massage having a weak intensity may be performed, and when the motion massage member performs the acupressure massage at a weak intensity, a sonic vibration massage having a strong intensity may be performed. Accordingly, since a sonic vibration massage having a strong strength is provided after a motion massage having a strong strength is performed, it is possible to continuously provide a specific intensity massage to the user. In addition, a sonic vibration massage having a weak intensity is provided when an acupressure massage having a strong intensity is performed, thereby focusing more on the acupressure massage by the motion massage member.

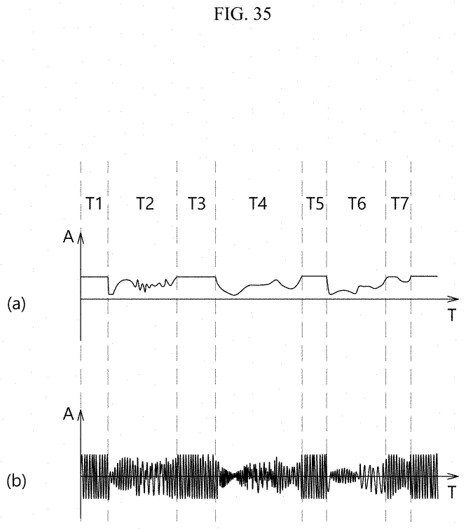

FIG. 35 shows graphs for describing a sound source signal according to an acupressure massage according to another embodiment.

Referring to FIG. 35, FIG. 35A shows a synchronization waveform of the sound source signal when the acupressure massage is provided, and FIG. 35B shows a sound source waveform of the sound source signal when the acupressure massage is provided.

In FIGS. 35A and 35B, time periods T1, T3, T5, and T7 may be time periods when a motion massage member moves backward along a z-axis with respect to a user and a sonic vibration module moves forward along the z-axis, and time periods T2, T4, and T6 may represent time periods when the motion massage member moves forward along the z-axis with respect to the user and the sonic vibration module moves backward along the z-axis.

In one embodiment, representative amplitudes of the synchronization waveform and the sound source waveform in the time periods T1, T3, T5, and T7 may be higher than representative amplitudes of the synchronization waveform and the sound source waveform in the time periods T2, T4, and T6. This may be to allow the user to focus on the acupressure massage by the motion massage member because the time periods T2, T4, and T6 are periods in which the acupressure massage by the motion massage member is performed.

In addition, when the acupressure massage is performed, since a time for which the motion massage member is in strong contact with the user is longer than a time for which the motion massage member is in weak contact with the user, lengths of the synchronization waveform and the sound source waveform in the time periods T2, T4, and T6 may be longer than lengths of the synchronization waveform and the sound source waveform in the time periods T1, T3, T5, and T7.

Furthermore, in one embodiment, amplitudes of the synchronization waveform and the sound source waveform may not be fixed but may be changed. This may be to provide a dynamic massage to the user by providing a sonic vibration massage at various amplitudes.

In addition, in one embodiment, vibration frequencies of the synchronization waveform and the sound source waveform may be changed in the time periods. For example, the vibration frequencies of the synchronization waveform and the sound source waveform in the same time period may be changed over time. This may also be to provide a dynamic feeling massage to the user.

In addition, in another embodiment, the vibration frequencies of the synchronization waveform and the sound source waveform may be the same in the time periods. This may be to provide a sonic vibration massage at the same vibration frequency to reduce a user's sense of difference due to a motion massage and the sonic vibration massage being provided at the same time.

3.3.5. Vibration Massage Operation according to Continuous Hitting Massage Operation

In one embodiment, when a continuous hitting massage is performed using a motion massage member, a massage device may provide a sonic vibration massage in response to the characteristics of the continuous hitting massage. To this end, the massage device may perform the sonic vibration massage using a sound source signal corresponding to the characteristics of the continuous hitting massage. Hereinafter, the sound source signal corresponding to the characteristics of the continuous hitting massage will be described.

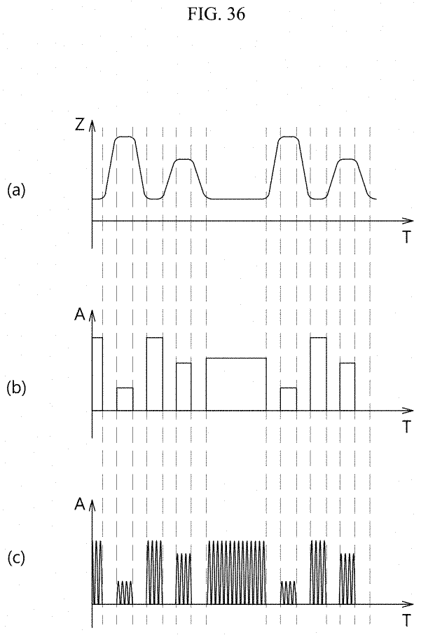

FIG. 36 shows graphs for describing a sound source signal corresponding to a continuous hitting massage according to one embodiment.

Referring to FIG. 36, FIG. 36A is a diagram showing a position of a motion massage member on a z-axis according to the continuous hitting massage, FIG. 36B shows a synchronization waveform of a sonic vibration module according to the continuous hitting massage, and FIG. 36C is a diagram showing a sound source waveform of the sonic vibration module according to the continuous hitting massage. In FIG. 36A, an x-axis may represent a time, and a y-axis may represent a position on the z-axis. In FIGS. 36B and 36C, an x-axis may represent a time, and a y-axis may represent an amplitude.

As described above, the continuous hitting massage may be a massage in which a tapping massage is performed at a high speed in order to provide a high speed massage to a local body part. Accordingly, when the continuous hitting massage is performed, a forward state and a backward state of the motion massage member in a z-axis direction may be rapidly alternated as shown in FIG. 36A, and after the motion massage member maintains the backward state in the z-axis direction for a relatively long time, the forward state and the backward state of the motion massage member in the z-axis direction may rapidly alternate. In this case, in states in which the motion massage member moves forward in the z-axis direction, lengths of the motion massage member in the z-axis direction may be slightly different. For example, a length of the motion massage member in the z-axis direction when the motion massage member secondarily moves forward in the z-axis direction may be shorter than a length of the motion massage member in the z-axis direction when the motion massage member first moves forward in the z-axis direction. This may be to provide a motion massage with various feelings to a user by varying a stimulation intensity according to the motion massage member.

In addition, when the motion massage member may be positioned at an upper side of a connection part, and the sonic vibration module may be positioned at a lower side of the connection part, the sonic vibration module may move backward along the z-axis when the motion massage member moves forward along the z-axis.

In one embodiment, when a continuous hitting massage operation is performed, a massage device may provide a sonic vibration massage synchronized with positions of the motion massage member and the sonic vibration module. To this end, the massage device may perform the sonic vibration massage using the sound source signal corresponding to the continuous hitting massage operation.

As in the above-described tapping massage and acupressure massage, even in the case of the continuous hitting massage, when the motion massage member moves forward in the z-axis and the sonic vibration module moves backward in the z-axis, amplitudes of the synchronization waveform and the sound source waveform in FIGS. 36B and 36C may be relatively small, and when the motion massage member moves backward in the z-axis and the sonic vibration module moves forward in the z-axis, the amplitudes of the synchronization waveform and the sound source waveform in FIGS. 36B and 36C may be relatively large. Accordingly, when the continuous hitting massage is performed, in the synchronization waveform and the sound source waveform, waveforms having a relatively large amplitude and waveforms having a relatively small amplitude may appear alternately. However, in states in which the motion massage member moves forward in the z-axis direction, since the lengths of the motion massage member in the z-axis direction may be slightly different, amplitudes of the waveforms having a relatively small amplitude may be slightly different. Accordingly, the massage device may provide a sonic vibration massage synchronized to the continuous hitting massage.

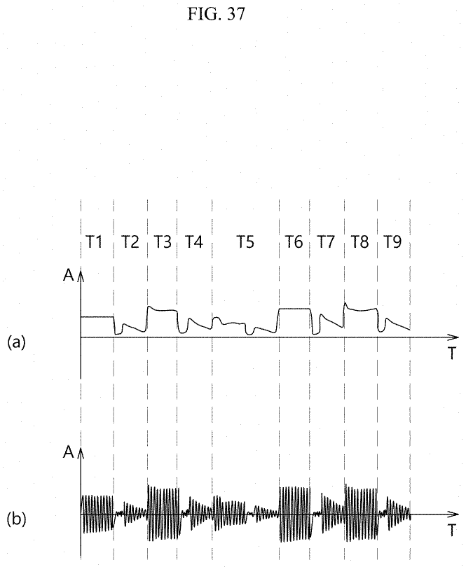

FIG. 37 shows graphs for describing a sound source signal corresponding to a continuous hitting massage according to another embodiment.

Referring to FIG. 37, FIG. 37A shows a synchronization waveform of the sound source signal when the continuous hitting massage is provided, and FIG. 37B shows a sound source waveform of the sound source signal when the continuous hitting massage is provided.

In FIGS. 37A and 37B, time periods T1, T3, T6, and T8 may be time periods when a motion massage member moves backward along a z-axis with respect to a user and a sonic vibration module moves forward along the z-axis, and time periods T2, T4, T5, and T7 may represent time periods when the motion massage member moves forward along the z-axis with respect to the user and the sonic vibration module moves backward along the z-axis.

In one embodiment, representative amplitudes of the synchronization waveform and the sound source waveform in the time periods T1, T3, T6, and T8 may be higher than representative amplitudes of the synchronization waveform and the sound source waveform in the time periods T2, T4, T5, and T7. This may be to allow the user to focus on the continuous hitting massage by the motion massage member because the time periods T2, T4, T5, and T7 are periods in which the continuous hitting massage by the motion massage member is performed.

In addition, in one embodiment, amplitudes of the synchronization waveform and the sound source waveform may not be fixed but may be changed. This may be to provide a dynamic feeling massage to the user by providing a sonic vibration massage at various amplitudes.

In addition, in one embodiment, as in an acupressure massage, vibration frequencies of the synchronization waveform and the sound source waveform may be fixed or changed in the time periods.

3.3.6. Vibration Massage Operation according to Sweeping Massage Operation

In one embodiment, when a seeping massage is performed using a motion massage member, a massage device may provide a sonic vibration massage in response to the characteristics of the sweeping massage. To this end, the massage device may perform the sonic vibration massage using a sound source signal corresponding to the characteristics of the sweeping massage. Hereinafter, the sound source signal corresponding to the characteristics of the sweeping massage will be described.

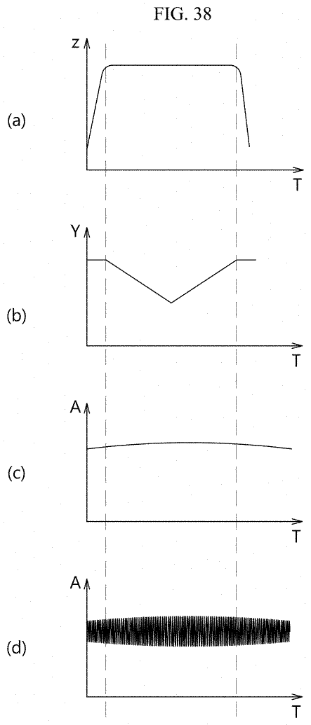

FIG. 38 shows graphs for describing a sound source signal corresponding to a sweeping massage according to one embodiment.

Referring to FIG. 38, FIG. 38A is a diagram showing a position of a motion massage member on a z-axis according to a continuous hitting massage, FIG. 38B shows a position of the motion massage member on a y-axis according to the continuous hitting massage, FIG. 38C shows a synchronization waveform of a sonic vibration module according to the sweeping massage, and FIG. 38D is a diagram showing a sound source waveform of the sonic vibration module according to the sweeping massage. In FIGS. 38A and 38B, an x-axis may represent a time, and a y-axis may represent a position on the z-axis. In FIGS. 38C and 38D, an x-axis may represent a time, and a y-axis may represent an amplitude.

As described above, the sweeping massage may be a massage performed by moving an applicator in a y-axis direction when the applicator moves forward in a z-axis direction in order to provide a massage to a wide body range at a high speed.

Accordingly, when the sweeping massage is performed, as shown in FIGS. 38A and 38B, when the motion massage member moves forward along the z-axis, the motion massage member moves to a low position along the y-axis, and then moves to a high position along the y-axis again. In this case, a position movement of the motion massage member along the y-axis may be performed at a relatively high speed. This may be to provide a massage to a wide part within a short time through rapid movement of the motion massage member.

As described above, as the motion massage member rapidly moves along the y-axis in the sweeping massage, a stimulation intensity by the motion massage member may be relatively low. In this case, in order to synchronize an intensity of the sweeping massage with an intensity of a sonic vibration massage, the intensity of a sonic vibration massage provided together with the sweeping massage may be adjusted to be relatively low.

More specifically, as shown in FIGS. 38C and 38D, a synchronization waveform and a sound source waveform of the sound source signal may have a long parabolic shape, and a difference between the largest amplitude and the smallest amplitude in the synchronization waveform may be set within a preset difference. This is because the stimulation intensity by the motion massage member in the sweeping massage may not be changed according to the position of the motion massage member. In addition, according to embodiments, the synchronization waveform may have a straight line shape of which an amplitude is not changed.

Of course, according to embodiments, the stimulation intensity by the motion massage member in the sweeping massage may be changed according to the position of the motion massage member. In this case, in response to the stimulation intensity by the motion massage member, an amplitude of the synchronization waveform may also be adjusted.

In addition, according to embodiments, the stimulation intensity provided by the motion massage member and the sonic vibration module may be changed according to a body part with which the motion massage member and the sonic vibration module are in contact. This is because a required stimulation intensity may be different for each body part. In this case, the amplitude of the synchronization waveform may be adjusted such that an appropriate stimulation intensity by a sonic vibration massage is provided for each body part.

In addition, in one embodiment, as in an acupressure massage, vibration frequencies of the synchronization waveform and the sound source waveform may be changed or fixed. When the vibration frequencies of the synchronization waveform and the sound source waveform are changed, the stimulation intensity by the sonic vibration massage may be adjusted by adjusting the vibration frequencies.

3.3.7. Vibration Massage Operation According to Kneading Massage Operation

In one embodiment, when a kneading massage is performed using a motion massage member, a massage device may provide a sonic vibration massage in response to the characteristics of the kneading massage. To this end, the massage device may perform the sonic vibration massage using a sound source signal corresponding to the characteristics of the kneading massage. Hereinafter, the sound source signal corresponding to the characteristics of the kneading massage will be described.

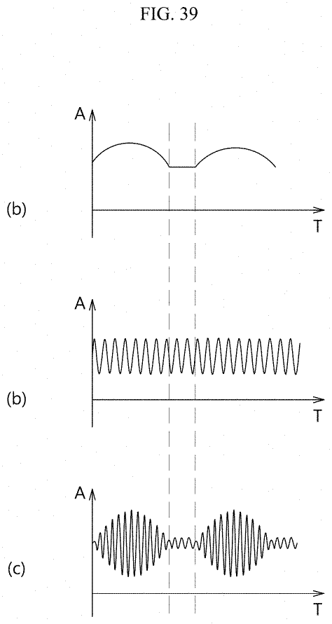

FIG. 39 shows graphs for describing a sound source signal corresponding to a kneading massage according to one embodiment.

Referring to FIG. 39, FIG. 39A shows a synchronization waveform of the sound source signal, FIG. 39B shows a vibration waveform of the sound source signal, and FIG. 39C shows a sound source waveform in which the synchronization waveform and the vibration waveform are combined. In addition, in FIGS. 39A to 39C, an x-axis may represent a time, and a y-axis may represent an amplitude.

In one embodiment, the kneading massage may be a massage that provides stimulation having a certain intensity or more to a user through movement of an applicator in a state in which the applicator is in contact with a body of a user. For example, as described above, when the user is positioned in a z-axis direction with respect to a massage unit, a motion massage member may move in the z-axis direction and then move in an x-axis direction and/or a y-axis direction to provide the kneading massage. Of course, the motion massage member may move in the z-axis direction while the kneading massage is performed.

In one embodiment, a massage device may synchronize an intensity of a sonic vibration massage in synchronization with a time when the motion massage member moves in the x-axis direction and/or a y-axis direction.

In one embodiment, the massage device may move the motion massage member in the x-axis direction and the y-axis direction according to various routes such as a circular route, an elliptic route, a semicircular route, a semielliptic route, and a quarter route. In this case, a massage stimulation intensity may be changed according to the route of the motion massage member. For example, in a case in which the motion massage member moves along a circular route, when the motion massage member draws a semicircle from an initial position thereof to a first position, the massage stimulation intensity may be increased according to the route of the motion massage member, and when the motion massage member returns and draws a semicircle from the first position to the initial position, the massage stimulation intensity may be decreased according to the route of the motion massage member. In one embodiment, when the motion massage member may move along a certain route such that the massage stimulation intensity is changed, a contact part of a user may be identified in advance. In this case, the massage device may control a movement route of the motion massage member such that strong stimulation is applied to a specific body part requiring strong stimulation.

In addition, in one embodiment, the massage stimulation intensity may be changed due to the characteristics of a body part of the user with which the motion massage member is in contact. For example, an inner portion of a back of the user may protrude further toward the massage device than an outer portion of the back, and accordingly, even when the motion massage member moves to the same length along a z-axis, a massage stimulation intensity applied to the inner portion of the back of the user may be high.

In addition, the massage device may control a massage intensity of a sonic vibration module massage in response to the massage stimulation intensity applied to the user by the motion massage member. For example, when the massage stimulation intensity by the motion massage member is high, the massaged intensity of the sonic vibration module may be controlled to be high, and when the massage stimulation intensity by the motion massage member is low, the massage intensity of the sonic vibration module may be controlled to be low. This may be to increase an effect of the kneading massage by providing a sonic vibration massage at the same intensity and the same time as the kneading massage.

In FIG. 39A, the synchronization waveform may have a form in which first to third waveforms are mixed. A first synchronization waveform may have a form in which an amplitude is increased and then decreased, a second synchronization waveform may have a form in which an amplitude is maintained, and a third synchronization waveform may have a form in which an amplitude is increased and then decreased.

In one embodiment, when the massage device performs the kneading massage, the massage stimulation intensity by the motion massage member may be increased and then decreased during a first time period, movement of the motion massage member may be stopped during a second time period, and the massage stimulation intensity by the motion massage member may be increased again and then decreased during a third time period. The synchronization waveform of FIG. 39A is for controlling the sonic vibration module in response to a pattern of the kneading massage. The first synchronization waveform may be applied during the first time period, the second synchronization waveform may be applied during the second time period, and the third synchronization waveform may be applied during the third time period.

In addition, as shown in FIG. 39B, the vibration waveform of the sound source signal may have a constant frequency irrespective of a position of the motion massage member. In the example of FIG. 39B, the vibration waveform may be a sine waveform. Of course, the present invention is not limited thereto, and the vibration waveform may be various waveforms other than the sine waveform.

The synchronization waveform of FIG. 39A and the vibration waveform of FIG. 39B may be combined so that the sound source waveform as shown in FIG. 39C may appear. According to the sound source waveform, the massage device may increase and then decrease an amplitude of the sonic vibration module for the first time period, may maintain the amplitude of the sonic vibration module for the second time period, and may increase and then decrease the amplitude of the sonic vibration module during the third time period. Accordingly, the massage device may provide a sonic vibration massage synchronized with the kneading massage of the motion massage member.

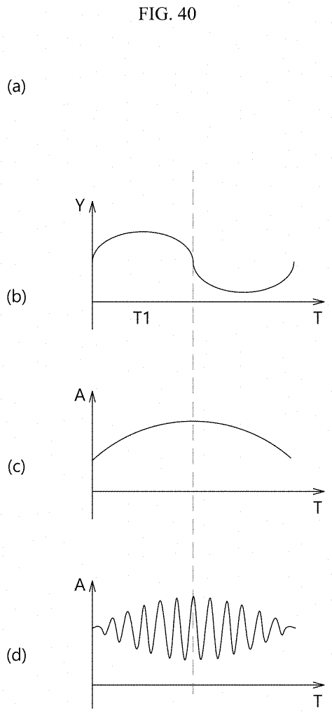

FIG. 40 shows diagrams for describing a sound source signal corresponding to a kneading massage according to another embodiment.

Referring to FIG. 40, FIG. 40A is a diagram for describing a movement route of a motion massage member according to the kneading massage, and FIG. 40B is a diagram showing a position of the motion massage member on a y-axis according to the kneading massage. FIG. 40C shows a synchronization waveform of a sonic vibration module according to the kneading massage, and FIG. 40D is a diagram showing a sound source waveform of the sonic vibration module according to the kneading massage. In FIG. 40B, an x-axis may represent a time, and the y-axis may represent a position on the y-axis. In FIGS. 40C and 40D, an x-axis may represent a time, and a y-axis may represent an amplitude.

As shown in FIG. 40A, the motion massage member and the sonic vibration module may be connected through a connection part. For example, the motion massage member may be positioned at an upper side of the connection part, and the sonic vibration module may be positioned at a lower side of the connection part. Hereinafter, for convenience of description, descriptions will be provided based on the motion massage member moving along a circular route, and one pair of motion massage member and sonic vibration module among two pairs of motion massage members and sonic vibration modules shown in FIG. 40A.

In addition, as shown in FIGS. 40A and 40B, when the motion massage member moves along the circular route, during a time period T1, a position of the motion massage member may increase and then decrease along the y-axis, and during the time period T1, the position of the motion massage member may generally increase with respect to the x-axis. In this case, a massage stimulation intensity by the motion massage member may increase. In addition, during a time period T2, the position of the motion massage member may decrease and then increase along the y-axis, and during the time period T1, the position of the motion massage member may generally decrease with respect to the x-axis. In this case, the massage stimulation intensity by the motion massage member may decrease.

When a kneading massage operation is performed, a massage device may provide a sonic vibration massage synchronized with positions of the motion massage member and the sonic vibration module. To this end, the massage device may perform the sonic vibration massage using the sound source signal corresponding to the kneading operation.

Specifically, when the kneading massage operation is performed, an amplitude of a synchronization waveform of the sound source signal may increase during the time period T1 and decrease during the time period T2 as shown in FIG. 40C. That is, the synchronization waveform may include a first detailed synchronization waveform of which an amplitude increases during the time period T1 and a second detailed synchronization waveform of which an amplitude decreases during the time period T2. In this case, as the time period T2 arrives in succession after the time period T1 has elapsed, the first detailed synchronization waveform and the second detailed synchronization waveform may be serially connected.

In addition, as shown in FIG. 40D, an amplitude of a sound source waveform of the sound source signal may increase during the time period T1 and decrease during the time period T2. Similarly to the synchronization waveform, the sound source waveform may also include a first detailed sound source waveform of which an amplitude increase during the time period T1 and a second detailed sound source waveform of which an amplitude increase during the time period T2. As an example, the first detailed sound source waveform and the second detailed sound source waveform may be serially connected. Of course, in another example, the first detailed sound source waveform and the second detailed sound source waveform may not be serially connected, and another waveform may be included between the first detailed sound source waveform and the second detailed sound source waveform.

Due to the fact that the massage stimulation intensity by the motion massage member increases during the time period T1 and decreases during the time period T2, the first detailed sound source waveform, of which the amplitude increases during time period T1, may appear, and the second detailed sound source waveform, of which the amplitude decreases during time period T2, may appear. That is, an amplitude of the sound source waveform may be adjusted in response to the massage stimulation intensity by the motion massage member.

Furthermore, in another embodiment, the massage device may perform a sonic vibration massage synchronized with a motion massage operation based on a sound source signal in which detailed waveforms included in a sound source waveform has the same amplitude and different vibration frequencies. In this case, the massage device may control a frequency of the detailed waveform to be decreased during the time period T1 in which the massage stimulation intensity by the motion massage member increases and may control the frequency of the detailed waveform to be increased during the time period T2 in which the intensity of massage stimulation by the motion massage member decreases.

Of course, the present invention is not limited thereto, the massage device may control the frequency of the detailed waveform to be increased during the time period T1 in which the massage stimulation intensity by the motion massage member increases and may control the frequency of the detailed waveform to be decreased during the time period T2 in which the intensity of massage stimulation by the motion massage member decreases. Accordingly, the massage device provides a sonic vibration massage having an intensity corresponding to the massage stimulation intensity by the motion massage member, thereby improving an effect of the kneading massage.

In addition, in one embodiment, a speed of the kneading massage may be various. For example, the massage device may perform the kneading massage at a first speed and may perform the kneading massage at a second speed that is faster than the first speed. In this case, a movement speed of the motion massage member and a movement time of the sonic vibration module may be changed according to the speed of the kneading massage, and accordingly, the sound source waveform may also be changed.

For example, when the speed of the kneading massage is the first speed, the sound source waveform may appear as shown in FIG. 40D, and when the speed of the kneading massage is the second speed that is faster than the first speed, lengths of the time periods T1 and the time periods T2 may be shortened. This may be to increase a speed of the sonic vibration massage in response to an increase in speed of the kneading massage and simultaneously provide the sonic vibration massage corresponding to a stimulation intensity by the kneading massage.

In addition, as another example, when the speed of the kneading massage is changed, the sonic vibration massage may be provided using a sound source signal different from an existing sound source signal. For example, when the speed of the kneading massage is increased, the sonic vibration massage at a higher speed may be provided using a sound source signal of a sound source having beats per minute (BPM) that is higher than that of an existing sound source.

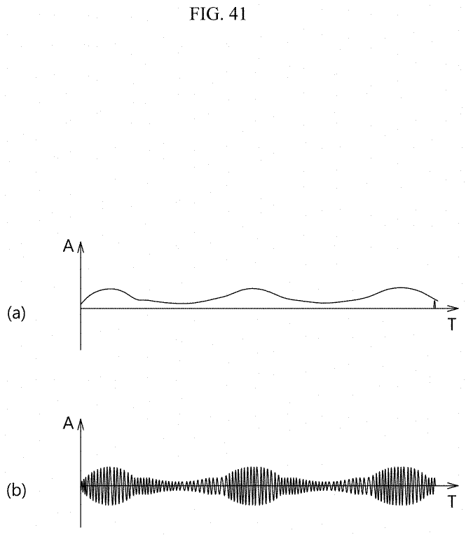

FIG. 41 shows graphs for describing a sound source signal according to a kneading according to still another embodiment.

Referring to FIG. 41, FIG. 41A shows a synchronization waveform of the sound source signal when the kneading massage is provided, and FIG. 41B shows a sound source waveform of the sound source signal when the kneading massage is provided.

In FIGS. 41A and 41B, amplitudes of the synchronization waveform and the sound source waveform may serially include waveforms that increase and then decrease. This may be due to a stimulation intensity by a motion massage member being increased and then decreased when the kneading massage is provided.

In addition, FIGS. 41A and 41B, detailed waveforms included in the synchronization waveform and the sound source waveform may be slightly changed. This may be to provide a dynamic feeling massage to a user by allowing a massage device to provide a sonic vibration massage at various amplitudes.

In addition, in one embodiment, vibration frequencies of the synchronization waveform and the sound source waveform may be changed or may be fixed.

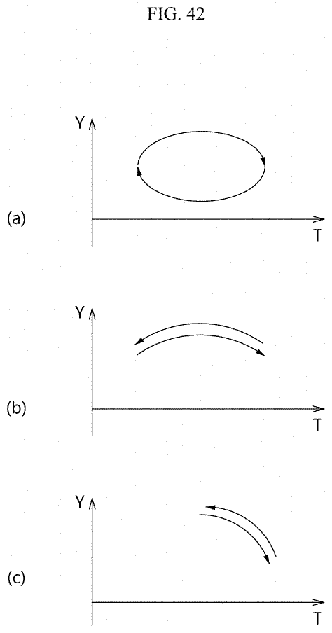

FIG. 42 shows graphs for describing a movement route of a motion massage member when a kneading massage is provided according to one embodiment.

Referring to FIG. 42, in FIGS. 42A to 42C, an x-axis may represent a time, and a y-axis may represent a position of the motion massage member on the y-axis.

Specifically, when the kneading massage is provided, the motion massage member may reciprocate along a circular route as shown in FIG. 42A. That is, a massage device may perform a first movement for moving the motion massage member from a first position to a second position and may perform a second movement for moving the motion massage member from the second position to the first position along a route rather than a route of the first movement. In this case, a massage stimulation intensity by the motion massage member may have a pattern in which the massage stimulation intensity increases and then decreases. Accordingly, when the massage device applies the sound source signal of FIG. 41 to a sonic vibration module, a sonic vibration corresponding to the kneading massage may be provided.

In addition, the motion massage member may reciprocate along a semicircular route as shown in FIG. 42B. That is, the massage device may perform a first movement for moving the motion massage member from a first position to a second position and may perform a second movement for moving the motion massage member from the second position to the first position along a route of the first movement. Even in this case, similarly to a case in which the motion massage member reciprocates along the circular route, the massage stimulation intensity by the motion massage member may have a pattern in which the massage stimulation intensity increases and then decreases. Accordingly, when the massage device applies the sound source signal of FIG. 41 to the sonic vibration module, a sonic vibration corresponding to the kneading massage may be provided.

However, in some cases, when the motion massage member reciprocates along the semicircular route, the massage stimulation intensity by the motion massage member may be lower than that when the motion massage member reciprocates along a circular route, that is, a difference in massage stimulation intensity according to movement of the motion massage member may be small. In this case, the massage device may provide a sonic vibration massage using the sound source signal used for the sweeping massage of FIG. 39D rather than the sound source signal of FIG. 41. Accordingly, the massage device may provide a sonic vibration massage corresponding to the kneading massage in which a deviation in massage stimulus according to movement of the motion massage member is small.

In addition, the motion massage member may reciprocate along a quadrant route as shown in FIG. 42C. In this case, the massage device may perform a first movement for moving the motion massage member from a first position to a second position and may perform a second movement for moving the motion massage member from the second position to the first position along a route of the first movement. However, according to embodiments, a length between the first position and the second position when the motion massage member moves along the quadrant route may be shorter than a length between the first position and the second position when the motion massage member moves along the circular route and the semicircular route. Accordingly, a time for which the motion massage member moves may also be reduced. In addition, a difference in massage stimulation intensity when the motion massage member moves along the quadrant route may be smaller than a difference in massage stimulation intensity when the motion massage member reciprocates through the circular or semicircular route. Even in this case, the massage device may provide a sonic vibration massage using the sound source signal used for the sweeping massage of FIG. 39D rather than the sound source signal of FIG. 41. Accordingly, the massage device may provide a sonic vibration massage corresponding to the kneading massage in which a deviation in massage stimulus according to movement of the motion massage member is small.

Of course, the present invention is not limited thereto, and according to embodiments, even when the motion massage member moves along the quadrant route, a difference in massage stimulation intensity according to movement of the motion massage member may be large. In this case, the massage device may perform a sonic vibration massage using the sound source signal of FIG. 41. However, a length of a waveform included in the sound source signal may be changed according to a time for which the motion massage member reciprocates.

In addition, according to embodiments, when the motion massage member moves along a circular route, a semicircular route, and a quadrant route, the massage device may also provide a sonic vibration massage using other sound source signals other than the sound source signal of FIG. 41 or the sound source signal used for sweeping massage of FIG. 39D. Accordingly, the massage device may provide a sonic vibration massage with various feelings to a user.

3.4. Provision of Vibration Massage Based on Contact or Non-Contact of User

In one embodiment, a sonic vibration module may be disposed at any one of various positions of a massage device. For example, the sonic vibration module may be disposed at any one of various positions such as a seat, an arm, and a leg as well as a massage module. In addition, the massage device may be implemented as any type such as a vehicle seat type, a bed type, or a sofa type as well as a chair type, and the sonic vibration module may be disposed at any one of various positions of various types of massage devices.

However, in some cases, a head of the sonic vibration module may not be in contact with a body part of a user. For example, when the massage device is the chair type and the sonic vibration module is disposed at the leg of the massage device, the head of the sonic vibration module may not be in contact with the user when the user is short. In addition, when the massage device is the vehicle seat type and the sonic vibration module is in contact with the seat of the massage device, according to a driving posture of the user, the sonic vibration module may not be in contact with the user, and even when the user does not sit on the massage device, the head of the sonic vibration module may not be in contact with the user.

Meanwhile, the sonic vibration module may use a sound source signal in an audible frequency band, and when a sonic vibration is output, sound may be generated from the sonic vibration module according to the sound source signal.

However, when the head of the sonic vibration module is not in contact with the user, the sonic vibration may also not be transmitted to the user, and in this case, the sound generated by the sonic vibration module may act as noise to the user. In addition, when the head of the sonic vibration module is not in contact with the user, the sonic vibration module may output sonic vibration meaninglessly, and the durability of the sonic vibration module may also be degraded due to output of the sonic vibration module.

To this end, the massage device may determine whether the sonic vibration module is in contact with the user and may control the sonic vibration massage based on a result of the determination. Detailed descriptions will be provided below.

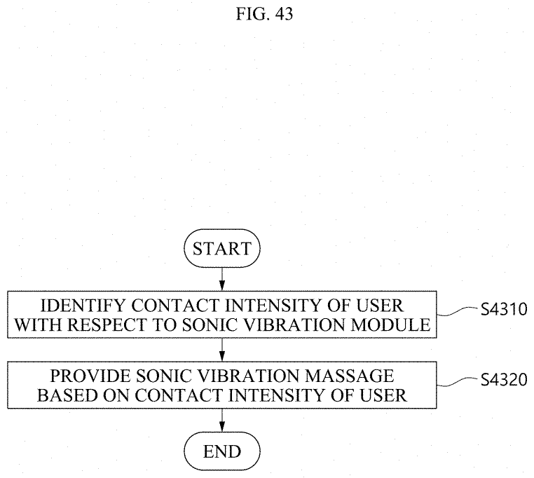

FIG. 43 is an operation flowchart for describing a control method of a massage device according to one embodiment.

Referring to FIG. 43, the control method of the massage device may include identifying a contact intensity of a user with respect to a sonic vibration module (S4310) and providing a sonic vibration massage based on the contact intensity of the user (S4320).

In operation S4310, the massage device may identify the contact intensity of the user with respect to the sonic vibration module using a pressure sensor. The pressure sensor may be provided as various types such as a mechanical type, an electronic type, and a semiconductor type. In addition, the pressure sensor may be provided as a thin film type. For example, the pressure sensor may include a force sensitive resistor (FSR). Of course, in addition, the pressure sensor may include any sensor capable of identifying the contact intensity of the user with respect to the sonic vibration module.

In one embodiment, the pressure sensor may be attached to a head of the sonic vibration module.

In addition, in another embodiment, the pressure sensor may be disposed below the sonic vibration module. For example, when the sonic vibration module is disposed on a seat of the massage device, the pressure sensor may be disposed between the sonic vibration module and the seat. In addition, the pressure sensor may be disposed at any position at which the contact intensity of the user with respect to the sonic vibration module may be identified.

In addition, for the contact intensity of the user with respect to the sonic vibration module, the massage device may identify whether the user is in contact with the sonic vibration module and may identify a contact intensity when the user is in contact with the sonic vibration module.

In one embodiment, when the pressure sensor is disposed at the head of the sonic vibration module, the massage device may identify whether the user is in contact with the sonic vibration module and may identify a contact intensity with respect to the head when the user is in contact with the head of the sonic vibration module.

In addition, in one embodiment, the massage device may acquire information about a time from which the user is in contact with the sonic vibration module and a time for which the user is not in contact with the sonic vibration module.

In addition, in operation S4320, the massage device may provide a sonic vibration massage based on the contact intensity of the user. In this case, when a plurality of sonic vibration modules are disposed in the massage device, a contact intensity of the user with respect to each sonic vibration module may be different. In this case, the massage device may individually control each sonic vibration module to control a sonic vibration massage according to the contact intensity of the user with respect to each sonic vibration module.

In one embodiment, when it is determined that the user is not in contact with the sonic vibration module or the contact intensity of the user with respect to the sonic vibration module is a certain intensity or lower, the massage device may not output sonic vibration using the sonic vibration module. This may be to remove unnecessary noise and prevent the durability of the sonic vibration module from being degraded.

In addition, in another embodiment, when it is determined that the user is not in contact with the sonic vibration module or the contact intensity of the user with respect to the sonic vibration module is the certain intensity or lower, the massage device may control an output intensity of the sonic vibration module to be weak. For example, the massage device may set an amplitude of the sonic vibration module to be smaller than a certain amplitude or may set a vibration frequency of the sonic vibration module to be higher than a certain reference frequency. Alternatively, in some cases, sonic vibration may be output using a prestored sound source signal used when the user is not in contact with the sonic vibration module. This may also be to reduce unnecessary noise and prevent the durability of the sonic vibration module from being degraded.

In addition, in one embodiment, when it is determined that the user is in contact with the sonic vibration module or the contact intensity of the user with respect to the sonic vibration module is greater than or equal to the certain intensity, the massage device may output sonic vibration using the sonic vibration module. In addition, according to embodiments, the massage device may control an output intensity of the sonic vibration module to be strong. As described above, the massage device may set the amplitude of the sonic vibration module to be greater than the certain amplitude or may set the vibration frequency of the sonic vibration module to be lower than the certain reference frequency. Alternatively, in some cases, sonic vibration may be output using a prestored sound source signal used when the user is in contact with the sonic vibration module. This may be to improve an effect of the sonic vibration massage on the user in contact with the sonic vibration module.

In addition, in another embodiment, the massage device may control an output intensity of the sonic vibration module in response to the contact intensity of the user with respect to the sonic vibration module. For example, as the contact intensity of the user with respect to the sonic vibration module becomes higher, the massage device may output sonic vibration having a higher output intensity. This is because, as the contact intensity of the user with respect to the sonic vibration module becomes higher, only when a sonic vibration massage having a higher output intensity is provided, an effect of the sonic vibration massage can be improved.

In addition, in one embodiment, the massage device may control an output intensity of the sonic vibration module based on a time for which the user is not in contact with the sonic vibration module.

For example, when the time for which the user is not in contact with the sonic vibration module is longer than a preset reference time, the massage device may stop output of the sonic vibration module or may control an output intensity of the sonic vibration module to be weak. This is because, when the output of the sonic vibration module is controlled even when the user is not in contact with the sonic vibration module for a while, the user may feel a sense of difference, and an output change within a short time may put a strain on the sonic vibration module.

In addition, in another example, when the user is not in contact with the sonic vibration module, the massage device may control an output intensity of the sonic vibration module to be weak, and when the time for which the user is not in contact with the sonic vibration module is longer than the preset reference time, the massage device may stop output of the sonic vibration module. This is because vibration feedback according to contact or non-contact of the user with the sonic vibration module is immediately reflected, and when the time for which the user is not in contact with the sonic vibration module is longer than the preset reference time, the user may not be willing to receive a sonic vibration massage.

In addition, in one embodiment, the massage device may control an output intensity of the sonic vibration module based on the time for which the user is in contact with the sonic vibration module.

For example, when the time for which the user is in contact with the sonic vibration module is greater than or equal to the preset reference time, the massage device may control the amplitude and/or the vibration frequency of the sonic vibration module. Since the user may feel fatigue when a sonic vibration massage is continuously provided only to a specific body part, this may be to reduce such fatigue by providing the sonic vibration massage at various amplitudes and/or vibration frequencies.

3.5. Provision of Vibration Massage through Interlocking of Plurality of Vibration Modules

In one embodiment, a plurality of sonic vibration modules may be disposed in a massage device, and the massage device may provide a sonic vibration massage using the plurality of sonic vibration modules.

In addition, in one embodiment, the massage device may provide a sonic vibration massage in which the plurality of sonic vibration modules are interlocked with each other. This may be to provide a sonic vibration massage with a sense of unity by synchronizing sonic vibrations output from the plurality of sonic vibration modules.

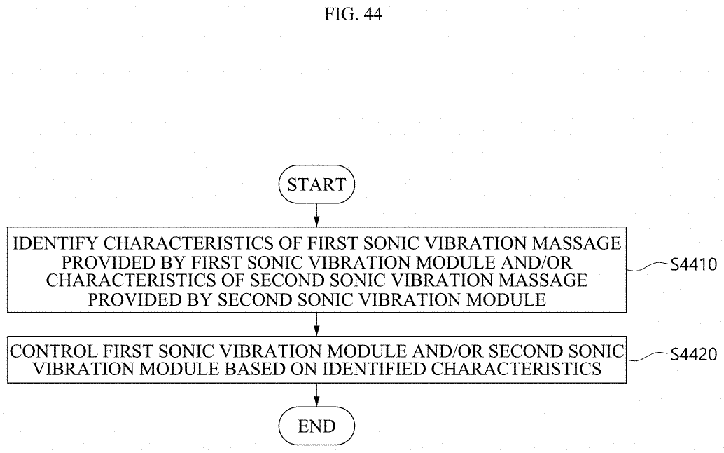

FIG. 44 is an operation flowchart for describing a control method of a massage device according to one embodiment.

Referring to FIG. 44, the control method of the massage device may include identifying the characteristics of a first sonic vibration massage provided from a first sonic vibration module and/or the characteristics of a second sonic vibration massage provided from a second sonic vibration module (S4410) and controlling the first sonic vibration module and/or the second sonic vibration module based on the identified characteristics (S4420).

In operation S4410, the massage device may identify amplitudes, vibration frequencies, output times, and the like of vibrations output from the first sonic vibration module and the second sonic vibration module as the characteristics of a sonic vibration massage. For example, the massage device may identify the characteristics of the sonic vibration massage based on a sound source signal applied to the first sonic vibration module and the second sonic vibration module.

In addition, in one embodiment, the massage device may operate the first sonic vibration module and may not operate the second sonic vibration module. In this case, the massage device may identify the characteristics of the first sonic vibration massage and may not identify the characteristics of the second sonic vibration massage which are not provided.

In operation S4420, the massage device may control the first sonic vibration module and/or the second sonic vibration module based on the characteristics of the sonic vibration massage identified in operation S4410.

In one embodiment, the massage device may control the characteristics of the first sonic vibration massage and the second sonic vibration massage to be the same. For example, the massage device may control the amplitudes, the vibration frequencies, the output times, and the like of the first sonic vibration module and the second sonic vibration module to be the same.

In addition, in another embodiment, the massage device may adjust the characteristics of the second sonic vibration massage in response to the characteristics of the first sonic vibration massage. For example, the massage device may set the amplitude of the second sonic vibration module to be high as the amplitude of the first sonic vibration module become high and may set the vibration frequency of the second sonic vibration module to be high as the vibration frequency of the first sonic vibration module becomes high. In addition, even when the amplitude of the first sonic vibration module is lowered or the vibration frequency thereof is lowered, the massage device may set the amplitude of the second sonic vibration module to be low or may set the vibration frequency thereof to be low.

In addition, in one embodiment, the massage device may adjust the output time of the first sonic vibration module and the output time of the second sonic vibration module. For example, the massage device may adjust the output time of the first sonic vibration module and/or the output time of the second sonic vibration module such that the output of the first sonic vibration module and the output of the second sonic vibration module are alternately provided.

For example, the massage device may adjust the output time of the first sonic vibration module and/or the second sonic vibration module such that the first sonic vibration massage and the second sonic vibration massage are provided according to a certain pattern.

In addition, in one embodiment, the massage device may provide a sonic vibration massage by setting the frequencies of the first sonic vibration module and the second sonic vibration module to be different. This may be to provide a sonic vibration massage with various feelings by outputting sonic vibrations having different frequencies.

For example, the massage device may set the vibration frequency of the second sonic vibration module to be lower than the vibration frequency of the first sonic vibration module. As a specific example, the first sonic vibration module and the second sonic vibration module may be disposed at left and right sides of a massage module. In this case, when the vibration frequency of the second sonic vibration module is set to be lower than the vibration frequency of the first sonic vibration module, it is possible to provide a sonic vibration massage which has a feeling in which vibration moves from one side to the other side. As another example, the first sonic vibration module and the second sonic vibration module may be vertically disposed at the massage module. In this case, even when the vibration frequency of the second sonic vibration module is set to be lower than the vibration frequency of the first sonic vibration module, it is possible to provide a sonic vibration massage which has a feeling in which vibration moves from one side to the other side.

In addition, in another embodiment, the first sonic vibration module and the second sonic vibration module may be disposed at left and right sides of the massage module. In this case, the first sonic vibration module and the second sonic vibration module may move laterally, and accordingly, a distance between the first sonic vibration module and the second sonic vibration module may be decreased and then increased. When the distance between the first sonic vibration module and the second sonic vibration module is within a preset reference distance, the massage device may set the vibration frequency of the second sonic vibration module to be lower than the vibration frequency of the first sonic vibration module. This is because, when the distance between the first sonic vibration module and the second sonic vibration module is decreased, the user may well feel the difference between the first sonic vibration massage and the second sonic vibration massage due to different vibration frequencies.

In addition, in one embodiment, the massage device may provide a sonic vibration massage by independently controlling the plurality of sonic vibration modules.

For example, a body part of the user in contact with each of the sonic vibration modules may be different. By independently controlling the plurality of sonic vibration modules, the massage device may provide a sonic vibration massage suitable for the body part of the user with which each of the plurality of sonic vibration modules is in contact.

Methods according to embodiments may be implemented in the form of program instructions executable through diverse computing means and may be recorded on computer readable media. The computer-readable media may include, independently or in combination, program instructions, data files, data structures, and so on. The program instructions recorded on the media may be specially designed and configured for the embodiments or may be generally known by those skilled in the computer software art. Computer-readable recording media may include magnetic media such as hard disks, floppy disks, and magnetic tapes, optical media such as a compact disc read only memory (CD-ROM) and a digital versatile disc (DVD), magneto-optical media such as floptical disks, and hardware units, such as a read only memory (ROM), a random access memory (RAM), a flash memory, and so on, which are intentionally formed to store and perform program instructions. Program instructions may include high-class language codes executable by computers using interpreters, as well as machine language codes such as those made by compilers. The hardware units may be configured to function as one or more software modules for performing the operations according to the embodiments of the present invention, and vice versa.

While embodiments of the present invention have been shown and described with reference to the accompanying drawings thereof, it will be understood by those skilled in the art that various changes and modifications in form and details may be made therein. For example, desired results may be achieved although the embodiments of the present invention are performed in other sequences different from the descriptions, and/or the elements, such as a system, a structure, a device, a circuit, and so on, are combined or assembled in other ways different from the descriptions, or replaced or substituted with other elements or their equivalents.

What is claimed is:

1. A human body stimulation device for providing a multimodal massage to a user by performing a mechanical massage operation and a sonic vibration massage operation, the human body stimulation device comprising:
a massage member provided in contact with a body part of the user;
a first massage module which includes a motor operatively connected to the massage member to repeatedly move the massage member according to a massage pattern and performs the mechanical massage operation according to the massage pattern using the massage member;
a second massage module which includes a sonic vibration module configured to output sonic vibration corresponding to an audible frequency band and operatively connected to the massage member to perform the sonic vibration massage operation by applying the sonic vibration to the body part; and
a controller configured to apply a first control signal for driving the motor to the motor and a second control signal for driving the sonic vibration module to the sonic vibration module,
wherein the second control signal includes a sound source waveform based on a synchronization pattern related to the movement of the massage member and a vibration pattern according to a frequency included in a range of the audible frequency band.

2. The human body stimulation device of claim 1, wherein positions of the massage member and the sonic vibration module are moved by the motor such that a position movement of the massage member is synchronized with a position movement of the sonic vibration module.

3. The human body stimulation device of claim 2, further comprising a connection part configured to connect the massage member and the sonic vibration module,
wherein, as the connection part is moved by the motor, the positions of the massage member and the sonic vibration module move.

4. The human body stimulation device of claim 2, wherein:
the controller is further configured to apply the first signal to the motor such that the massage member moves according to the massage pattern; and
the synchronization pattern is synchronized with the massage pattern.

5. The human body stimulation device of claim 4, wherein the synchronization pattern is synchronized with at least one of a movement pattern of the massage member along an x-axis, a movement pattern thereof along a y-axis, and a movement pattern thereof along a z-axis with respect to an initial position of the massage member.

6. The human body stimulation device of claim 4, wherein:
the massage pattern includes a plurality of detailed massage patterns according to a first cycle;
the synchronization pattern includes a plurality of detailed synchronization patterns according to a second cycle; and
at least one of start times or end times of the plurality of detailed massage patterns matches at least one of start times or end times of the plurality of detailed synchronization patterns.

7. The human body stimulation device of claim 4, wherein:
the massage pattern includes a plurality of detailed massage patterns according to a first cycle;
the synchronization pattern includes a plurality of detailed synchronization patterns according to a second cycle; and
at least one of start times or end times of the plurality of detailed massage patterns and at least one of start times or end times of the plurality of detailed synchronization patterns are included in a predetermined time period.

8. The human body stimulation device of claim 6, wherein the controller is configured to adjust at least one of the second cycle representing a cycle of the synchronization pattern and a third cycle representing a cycle of the vibration pattern such that a difference value between the second cycle and a lowest common multiple of the second cycle and the third cycle is a predetermined value or lower than the predetermined value.

9. The human body stimulation device of claim 2, wherein, when a position movement speed of the massage member is increased, in response to the position movement speed of the massage member, a frequency of the synchronization pattern is increased, and a frequency of the vibration pattern is maintained.

10. The human body stimulation device of claim 2, wherein, when an intensity of a mechanical massage is increased such that an intensity of a sonic vibration massage is adjusted in response to the intensity of the mechanical massage, the controller increases an amplitude of the sound source waveform or decreases a frequency of the sound source waveform such that the intensity of the sonic vibration massage is increased.

11. The human body stimulation device of claim 3, wherein:
when a contact intensity of the sonic vibration module with respect to the body part of the user is high, the controller controls the position movements of the massage member and the sonic vibration module using the connection part such that the contact intensity of the sonic vibration module with respect to the body part of the user is decreased; and
when an intensity of a mechanical massage is increased such that an intensity of a sonic vibration massage is adjusted in response to the contact intensity of the massage member with respect to the body part of the user, the controller is configured to decrease an amplitude of the sound source waveform such that the intensity of the sonic vibration massage is decreased.

12. The human body stimulation device of claim 2, wherein:
the mechanical massage operation includes a first mechanical massage operation and a second mechanical massage operation;
when the first massage module performs the first mechanical massage operation, a composite signal is generated based on a first synchronization pattern synchronized with the first mechanical massage operation; and
when the first massage module performs the second mechanical massage operation, the composite signal is generated based on a second synchronization pattern synchronized with the second mechanical massage operation.

13. The human body stimulation device of claim 2, wherein:
the mechanical massage operation includes a first mechanical massage operation and a second mechanical massage operation;
when the first massage module performs the first mechanical massage operation, a composite signal is generated based on a first vibration pattern;
when the first massage module performs the second mechanical massage operation, the composite signal is generated based on a second vibration pattern; and
a difference between a frequency of the first vibration pattern and a frequency of the second vibration pattern is a certain frequency or lower.

14. A control method of a human body stimulation device for providing a multimodal massage to a user by performing a mechanical massage operation and a sonic vibration massage operation, the control method comprising:
moving a position of a massage member provided in contact with a body part of the user;
moving a position of a sonic vibration module operatively connected to the massage member; and
applying a sound source signal to the sonic vibration module to control sonic vibration output from the sonic vibration module,
wherein the sound source signal includes a sound source waveform based on a synchronization pattern related to the movement of the massage member and a vibration pattern according to a frequency included in a range of an audible frequency band.

15. A non-transitory computer readable storage medium storing instructions thereon, the instructions when executed by a processor cause the processor to:
move a position of a massage member provided in contact with a body part of a user;
move a position of a sonic vibration module operatively connected to a massage member; and
applying a sound source signal to the sonic vibration module to control sonic vibration output from the sonic vibration module,
wherein the sound source signal includes a sound source waveform based on a synchronization pattern related to the movement of the massage member and a vibration pattern according to a frequency included in a range of an audible frequency band.
